(19) United States
(12) Patent Application Publication
(10) Pub. No.: US 2005/0130613 A1
(43) Pub. Date: Jun. 16, 2005

(54) Program selecting apparatus

(75) Inventors: Masaki Kutsuna, Aichi (JP); Yuichi Matsumoto, Kanagawa (JP); Takashi Yamamoto, Kanagawa (JP); Shigeki Mori, Saitama (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/998,652

(22) Filed: Nov. 30, 2004

(30) Foreign Application Priority Data
Dec. 11, 2003 (JP) 2003-412744
Dec. 11, 2003 (JP) 2003-412746
Nov. 5, 2004 (JP) 2004-322376

(51) Int. Cl. H04B 1/18

(52) U.S. Cl. 455/179.1

(57) ABSTRACT

The present invention provides a program selecting apparatus comprising: a control circuit for outputting information for selecting a predetermined program; a selection circuit for selectively outputting a signal for selecting the predetermined program based on the information; and a transmission circuit for transmitting the information to another program selecting apparatus; wherein the information transmitted to the another program selecting apparatus includes at least information for causing such another program selecting apparatus to select the predetermined program in order that a corresponding reproduction apparatus reproduces the predetermined program, thereby the same program can be viewer simultaneously with separate TV.

### BACKGROUND OF THE INVENTION

1. Field of the Invention

The present invention relates to a TV reception system for causing a coordinated operation of plural TV receivers so as to receive a same program by distant TV receivers, and a TV receiver therefor.

2. Related Background Art

A TV reception system, which causes a coordinated operation of plural TV receivers so as to receive a same program by distant TV receivers, has not been known.

Patent Reference 1: Japanese Patent Application Laid-Open No. 2001-7724.

### SUMMARY OF THE INVENTION

An object of the present invention is to provide a novel structure employing plural program selecting apparatuses.

According to an aspect of the present invention, there is provided a program selecting apparatus including:
a control circuit for outputting information for selecting a predetermined program;
a selection circuit for selectively outputting a signal for selecting the predetermined program based on the information; and
a transmission circuit for transmitting an information to another program selecting apparatus;
wherein the information transmitted to such another program selecting apparatus includes at least information for causing such another program selecting apparatus to select the predetermined program in order that a corresponding reproduction apparatus reproduces the predetermined program.

The control circuit may be an ASIC (application specific integrated circuit) which is a circuit designed exclusively for executing a process for realizing the present invention, or a signal processing circuit for realizing the present invention by executing a program, or a circuit utilizing a device with a reconstructable logic process to be executed (so-called programmable logic device corresponding for example to a field programmable gate array or a complex programmable logic device).

Such program selecting apparatus may be so constructed that the predetermined program is selectable both in the aforementioned program selecting apparatus and in the aforementioned other program selecting apparatus.

Also the control circuit may be so constructed as to output, based on information of programs that can be selected respectively in the aforementioned other program selecting apparatus and in the program selecting apparatus including the control circuit, information for designating a program selectable commonly by the aforementioned other program selecting apparatus and by the program selecting apparatus including the control circuit, as the predetermined program.

Also the control circuit may be so constructed as to output, based on common program selection information indicating information of a program selectable commonly by the aforementioned other program selecting apparatus and by the program selecting apparatus including the control circuit, information for designating a program selectable commonly by the aforementioned other program selecting apparatus and by the program selecting apparatus including the control circuit, as the predetermined program.

The control circuit can generate, based on information of programs selectable respectively in another program selecting apparatus and a program selecting apparatus to which the control circuit belongs, program designating information which is information for designating a predetermined program. As the program designating information, there can be utilized various information, for example information of a channel transmitting such program. Also as a constitution of extracting a commonly selectable program from the information of the programs respectively selectable by this program selecting apparatus and another program selecting apparatus, it is possible to extract commonly selectable programs, to store the extracted information as common program selection information in this control circuit or in another memory device, and to generate information for designating a commonly selectable program, based on such common program selection information. Such common program selection information may be generated in the program selecting apparatus, for example by the aforementioned control circuit, or may be supplied from the exterior of the program selecting apparatus (for example from the aforementioned other program selecting apparatus or from still another apparatus).

Also the selection circuit may be so constructed as a circuit for selectively outputting a signal for reproducing the predetermined program, transmitted by a predetermined channel, from a receivable broadcast signal.

Also the selection circuit may be so constructed as a circuit for selectively outputting a signal for reproducing the predetermined program, among signals stored in a memory apparatus.

In an aspect of the present invention there is provided a program selecting apparatus including:
a control circuit for generating a predetermined control signal, in case a program to be selected according to a program designating signal is not a program selectable by another predetermined program selecting apparatus; and
a circuit for generating, in response to the control signal, a signal for causing a user to notice that the other predetermined program selecting apparatus is unable to receive such program.

In an aspect of the present invention there is provided a program selecting apparatus including:
a selection circuit for receiving a broadcast signal and selecting a predetermined channel; and
a transmission circuit for transmitting information;
wherein the information is information of channels selectable by the selection circuit and/or information on programs receivable by a channel selection in the selection circuit.

The transmission circuit may be constructed as a circuit for transmitting the information to another program selecting apparatus. The transmission of the information to such another program selecting apparatus may be executed through a relaying apparatus or a signal processing apparatus. Therefore, in case such relaying apparatus or signal processing apparatus which relays the information recognizes an apparatus such as a program selecting apparatus requiring such information and a program selecting apparatus which transmits the information, the program selecting apparatus which transmits the information need not designate the apparatus such as the program selecting apparatus requiring the information as a destination of the information, but can address the information to such relaying apparatus or such signal processing apparatus. In such situation, the relaying apparatus or the signal processing apparatus addresses the information to another apparatus such as the program selecting apparatus requiring the information, as a destination. Thus, an expression in the present specification, of information transmission to another program selecting apparatus is not limited to a constitution in which the transmitted information is addressed to such another program selecting apparatus as destination.

In an aspect of the present invention there is provided a program selecting apparatus including:
a control circuit for outputting information for selecting a predetermined program, based on a signal from another program selecting apparatus;
a selection circuit for selectively outputting a signal for reproducing the predetermined program based on the information; and
a transmission circuit for transmitting information for informing the other program selecting apparatus of execution of a selection in the selection circuit based on the signal from the other program selecting apparatus.

In an aspect of the present invention there is provided a program selecting apparatus including:
a control circuit for outputting information for selecting a predetermined program, based on a signal from another program selecting apparatus;
a selection circuit for selectively outputting a signal for reproducing the predetermined program based on the information; and
a transmission circuit for transmitting information for informing the other program selecting apparatus, in case the selection circuit does not execute a selection based on the signal from the other program selecting apparatus, of such non-execution.

In an aspect of the present invention there is provided a program reproducing apparatus including:
a control circuit for outputting information for selecting a predetermined program;
a selection circuit for selectively outputting a signal for reproducing the predetermined program based on the information;
a reproduction apparatus for reproducing the signal outputted by the selection circuit; and
a transmission circuit for transmitting information to another program reproducing apparatus;
wherein the information transmitted to the other program reproducing apparatus at least includes information for causing the other program reproducing apparatus to select the predetermined program in order that a reproducing apparatus included in the other program reproducing apparatus reproduces the predetermined program.

In an aspect of the present invention, there is provided a program reproducing apparatus including:
a selection circuit for receiving a broadcast signal and selecting a predetermined channel;
a reproduction apparatus for reproducing a signal outputted by the selection circuit; and
a transmission circuit for transmitting information;
wherein the information is information of channels selectable by the selection circuit and/or information of programs receivable by the channel selection in the selection circuit.

In an aspect of the present invention there is provided a program reproducing apparatus including:
a control circuit for outputting information for selecting a predetermined program, based on a signal from another program selecting apparatus;
a selection circuit for selectively outputting a signal for reproducing the predetermined program based on the information;
a reproduction apparatus for reproducing the signal outputted by the selection circuit; and
a transmission circuit for transmitting information for informing the other program selecting apparatus of execution of a selection in the selection circuit based on the signal from the other program selecting apparatus.

In an aspect of the present invention there is provided a program reproducing apparatus including:
a control circuit for outputting information for selecting a predetermined program, based on a signal from another program selecting apparatus;
a selection circuit for selectively outputting a signal for reproducing the predetermined program based on the information;
a reproduction apparatus for reproducing the signal outputted by the selection circuit; and
a transmission circuit for transmitting information for informing the other program selecting apparatus, in case the selection circuit does not execute a selection based on the signal from the other program selecting apparatus, of such non-execution.

In an aspect of the present invention there is provided a program for controlling a program selecting apparatus including:
a step of outputting a signal for reproducing a predetermined program to a reproducing apparatus; and
a step of transmitting information for causing another program selecting apparatus to select the predetermined program in order that the other program selecting apparatus can reproduce the predetermined program by a corresponding reproducing apparatus.

In an aspect of the present invention there is provided a program for controlling a program selecting apparatus including:
a step of generating a predetermined control signal, in case a program to be selected according to a program designating signal is not a program selectable by another predetermined program selecting apparatus; and
a step of generating, in response to the control signal, a signal for causing a user to notice that the other predetermined program selecting apparatus is unable to receive such program.

In an aspect of the present invention there is provided a program for controlling a program selecting apparatus including:
a step of receiving a broadcast signal and selecting a predetermined channel; and
a step of transmitting information;
wherein the information is information of channels selectable by the selecting step and/or information on programs receivable by a channel selection in the selection step.

In an aspect of the present invention there is provided a program for controlling a program selecting apparatus including:
a step of outputting information for selecting a predetermined program, based on a signal from another program selecting apparatus;
a step of selectively outputting a signal for reproducing the predetermined program based on the information; and
a step of transmitting information for informing the other program selecting apparatus of execution of a selection based on the signal from the other program selecting apparatus.

In an aspect of the present invention there is provided a program for controlling a program selecting apparatus including:
a step of outputting information for selecting a predetermined program, based on a signal from another program selecting apparatus;
a step of selectively outputting a signal for reproducing the predetermined program based on the information; and
a step of transmitting information for informing the other program selecting apparatus, in case a selection based on the signal from the other program selecting apparatus is not executed, of such non-execution.

### BRIEF DESCRIPTION OF THE DRAWINGS

FIG. 1 is a view showing a structure of a TV receiver system constituting a first embodiment of the present invention;

FIG. 2 is a plan view of remote controllers 22a, 22b;

FIG. 3 is a block diagram showing a schematic constitution of a main body 40 of TV receivers 10a, 10b;

FIG. 4 is a view showing an example of a program information data column stored in a transmitted program information memory 56;

FIG. 5 is a view showing an example of a program information data column stored in a received program information memory 64;

FIG. 6 is a view showing an example of a program information data column stored in a synthesized program information memory 58;

FIG. 7 is comprised of FIGS. 7A and 7B showing charts of a process sequence between TV receivers of an embodiment 1;

FIG. 8 is a view showing an example of display in the embodiment 1;

FIG. 9 is a view showing an example of display in another program viewing in the embodiment 1;

FIG. 10 is comprised of FIGS. 10A and 10B showing flow charts of a process in the embodiment 1 executed by a control portion 74 of a TV receiver 10a when a simultaneous viewing start key 34 is depressed for the first time by a user after the power supply is turned on, or when a timer expiration is informed from a timer 66;

FIG. 11 is a flow chart showing a process in the embodiment 1 executed by a control portion 74 of a TV receiver 10b in response to a reception of a request for a master candidate;

FIG. 12 is a flow chart showing a synthesizing process (S214, S232) to be executed by the control portion 74 in the embodiment 1;

FIG. 13 is a flow chart showing a process in the embodiment 1 executed by the control portion 74 when a simultaneous viewing start key 34 and then a channel up/down key 30, 32 are depressed in at least either of the TV receivers 10a, 10b;

FIG. 14 is a view showing an example in an embodiment 2 of a program information data column stored in a transmitted program information memory 56;

FIG. 15 is a view showing an example in the embodiment 2 of a program information data column stored in a received program information memory 64;

FIG. 16 is a view showing an example in the embodiment 2 of a program information data column stored in a synthesized program information memory 58;

FIG. 17 is a view showing an example of display in the embodiment 2;

FIG. 18 is a view showing an example of display in another program viewing in the embodiment 2;

FIG. 19 is comprised of FIGS. 19A and 19B showing flow charts of a synthesizing process (S214, S232) to be executed by the control portion 74 in the embodiment 2;

FIG. 20 is a flow chart showing a process in the embodiment 2 executed by the control portion 74 when a simultaneous viewing start key 34 and then a channel up/down key 30, 32 are depressed in at least either of the TV receivers 10a, 10b;

FIG. 21 is a view showing an example in an embodiment 3 of a program information data column stored in a transmitted program information memory 56;

FIG. 22 is a view showing an example in the embodiment 3 of a program information data column stored in a received program information memory 64;

FIG. 23 is a view showing an example in the embodiment 3 of a program information data column stored in a synthesized program information memory 58;

FIG. 24 is a view showing an example in the embodiment 3 of a program information data column stored in a synthesized program information memory 58 of a partner TV receiver;

FIG. 25 is comprised of FIGS. 25A and 25B showing charts of a process sequence between TV receivers of the embodiment 3;

FIG. 26 is a view showing an example of display in the embodiment 3;

FIG. 27 is a view showing an example of display in another program viewing in the embodiment 3;

FIG. 28 is a flow chart showing a synthesizing process (S214, S232) to be executed by the control portion 74 in the embodiment 3;

FIG. 29 is a flow chart showing a process in the embodiment 3 executed by the control portion 74 when a simultaneous viewing start key 34 and then a numeral key 36 are depressed in at least either of the TV receivers;

FIG. 30 is a flow chart showing a process in the embodiment 3 executed by the control portion 74 when a channel number is received from a communication portion 62;

FIG. 31 is a view showing a schematic constitution of a TV receiver system of an embodiment 4;

FIG. 32 is a plan view of remote controls 1022a, 1022b;

FIG. 33 is a block diagram showing a schematic constitution of TV receivers 1010a, 1010b;

FIG. 34 is a view showing an example in an embodiment 4 of a program information data column stored in a transmitted program information memory 56;

FIG. 35 is a view showing an example in the embodiment 4 of a program information data column stored in a received program information memory 64;

FIG. 36 is a view showing an example in the embodiment 4 of a program information data column stored in a synthesized program information memory 58;

FIG. 37 is comprised of FIGS. 37A and 37B showing views of a process sequence between TV receivers in the embodiment 4;

FIG. 38 is a view showing an example of display in the embodiment 4;

FIG. 39 is a view showing an example of display in another program viewing in the embodiment 4;

FIG. 40 is comprised of FIGS. 40A and 40B showing flow charts of a process in the embodiment 4 executed by a control portion 1074 of a TV receiver 1010a or 1010b when a simultaneous viewing start key 1034 is depressed for the first time by a user after the power supply is turned on, or when a timer expiration is informed from a timer 1066;

FIG. 41 is a flow chart showing a process in the embodiment 4 executed by a control portion 1074 of a TV receiver 1010a or 1010b in response to a reception of a request for a master candidate;

FIG. 42 is a flow chart showing a synthesis process S1116, S1117 executed by the control portion 1074 in the embodiment 4;

FIG. 43 is a flow chart showing an auto station selecting process of each TV receiver in the embodiment 4, to be started after a time lapse (time) information from a B-timer 1067 and after an increment by a portion in the time axis of a reference in a program information data table of a synthesized program information memory 1058;

FIG. 44 is a view showing an example in an embodiment 5 of a program information data column stored in a transmitted program information memory 1056;

FIG. 45 is a view showing an example in the embodiment 5 of a program information data column stored in a received program information memory 1064;

FIG. 46 is a view showing an example in the embodiment 5 of a program information data column stored in a synthesized program information memory 1058;

FIG. 47 is a view showing an example of display in the embodiment 5;

FIG. 48 is a view showing an example of display in another program viewing in the embodiment 5;

FIG. 49 is a flow chart showing a synthesizing process (S1116, S1118) in the embodiment 5;

FIG. 50 is a flow chart showing an auto station selecting process of TV receivers 1010a, 1010b, to be started after a time lapse (time) information from a B-timer 1067 and after an increment by a portion in the time axis of a reference in a program information data table of a synthesized program information memory 1058;

FIG. 51 is a view showing a constitution of a DTV apparatus to be employed in an embodiment of the present invention;

FIG. 52 is a view showing an entire structure of an embodiment;

FIG. 53 is a block diagram showing a schematic constitution of DTV apparatuses 1000203, 1000207;

FIG. 54 is a view showing user operations between the DTV apparatuses 1000203 and 1000207, and an operation flow of the DTV apparatuses 1000203, 1000207;

FIG. 55 is a flow chart showing operations of a DTV apparatus 10001;

FIG. 56 is a flow chart showing operations of a DTV apparatus 10002;

FIG. 57 is a flow chart showing a coordinated operation flow between the DTV apparatuses 10001, 10002 in a seventh embodiment;

FIG. 58 is a flow chart showing a coordinated operation flow between the DTV apparatuses 10001, 10002 in an eighth embodiment;

FIG. 59 is a flow chart showing a coordinated operation flow between the DTV apparatuses 10001, 10002 in a twelfth embodiment; and

FIG. 60 is a view showing an example of image in the twelfth embodiment.

### DETAILED DESCRIPTION OF THE PREFERRED EMBODIMENTS

In the following, there will be shown a constitution for coordinated reception utilizing plural TV receivers.

More specifically, there will be disclosed a TV receiver for receiving a television broadcasting, including:
communication means which communicates with an external TV receiver;
operation means which executes a station selecting operation for the TV receiver; and
control means which transmits a control command, for executing a station selecting operation same as the station selecting operation by the operation means, to the external TV receiver through the communication means.

There is also disclosed a TV reception system constituted of such TV receiver and an external controlled TV receiver.

There is also disclosed a TV receiver including:
station selecting operation means;
means which receives first program information from a broadcast wave;
means which executes a connection with an external TV receiver;
means which derives second program information from the external TV receiver;
means which transmits the second program information to a third TV receiver;
means which prepares, by comparing the second and third program information, a common viewing program table which is an assembly of program information viewable in common with the external TV receiver;
means which selects a commonly viewable program from the common viewing program table in response to a station selecting input from the station selecting operation means;
means which executes a station selection on such program; and
means for transmitting station selecting control information to the external TV receiver.

There is also disclosed a constitution of such TV receiver, where the means which prepares the common viewing program table is an extraction of matching program information in the program information broadcasted at a same time. There is disclosed, in particular, a constitution where the means which prepares the common viewing program table is an extraction of program information of programs broadcasted at a same time and having a matching channel number, in which the program information is arranged according to common channel numbers. Also there is disclosed a constitution where the means which prepares the common viewing program table is an extraction of program information of programs broadcasted at a same time and having a matching program title, in which the program information is arranged according to channel numbers by own program information and stores channel numbers of second program information. Also there is disclosed a constitution where the means which prepares the common viewing program table is an extraction of program information of programs broadcasted at a same time and having a matching program title, in which the program information is arranged according to channel numbers by program information of a larger (or smaller) region designating information among the first program information and the second program information.

There is also disclosed a constitution of such TV receiver, where the station selecting operation is an up/down successive selection of channel numbers on the common viewing program table, and, in particular, there is also disclosed a constitution where the station selecting control information is up/down direction information for channel numbers. There is also disclosed a constitution where the station selecting control information is a channel number of the external TV receiver.

There is also disclosed a constitution of such TV receiver, where the station selecting operation is a numeral key selecting operation for designating a channel on the common viewing program table. There is also disclosed a constitution where the station selecting control information is a channel number of the external TV receiver.

There is also disclosed a constitution of such TV receiver, having a common viewing operation mode of executing a channel selecting operation based on the common viewing program table, and an operation mode for executing a channel selecting operation based on own program information.

There is also disclosed a constitution of such TV receiver, where the common viewing program table is prepared at a switching to the common viewing operation mode. There is also disclosed a constitution where, in the common viewing operation mode, the common viewing program table is renewed at every predetermined time.

There is also disclosed a TV receiver for receiving a television broadcasting, including:
communication means which communicates with an external TV receiver;
selection means which selects, among plural channels, channels in which programs commonly viewable with the external TV receiver are broadcasted; and
control means which permits a channel switching among the channels selected by the selection means and inhibits a channel switching to a channel other than the selected channels.

There is also disclosed a TV receiver for receiving a television broadcasting, including:
station selecting operation means;
means which receives first program information from a broadcast wave;
means which executes a connection with an external TV receiver;
means which derives second program information from the external TV receiver;
means which transmits the second program information to the second TV receiver;
means which prepares, by comparing the first and second program information, a common viewing program table which is an assembly of program information viewable in common with the external TV receiver;
program selecting means which selects a commonly viewable program from the common viewing program table in response to a station selecting input from the station selecting operation means;
means which selects any one of the programs selected by the program selecting means; and
means for transmitting station selecting control information to the external TV receiver;
wherein, in case a common viewing is terminated, a common viewing is executed by selecting a program from the common viewing program table.

In particular there is disclosed a constitution where the common viewing program table includes common viewing inhibition information. There is also disclosed a constitution where, in the course of a common viewing, the common viewing inhibition information is detected from the common viewing program table. There is also disclosed a constitution where, in case of detection of the common viewing inhibition information, program information for which the common viewing is possible is selected from the common viewing program table.

There is also disclosed a constitution where the selection is to select, in the common viewing program table, program information of a channel number which is next larger (or smaller) than the currently selected channel number.

There is also disclosed a constitution where the selection is made on a program having a broadcast start time equal to a current time.

There is also disclosed a TV reception system in which, in case a program under common viewing is terminated, a first TV receiver which executes the common viewing by selecting a program from the common viewing program table transmits station selecting control information to a second TV receiver.

In the following, the present invention will be clarified in detail by embodiments thereof, with reference to the accompanying drawings.

### Embodiment 1

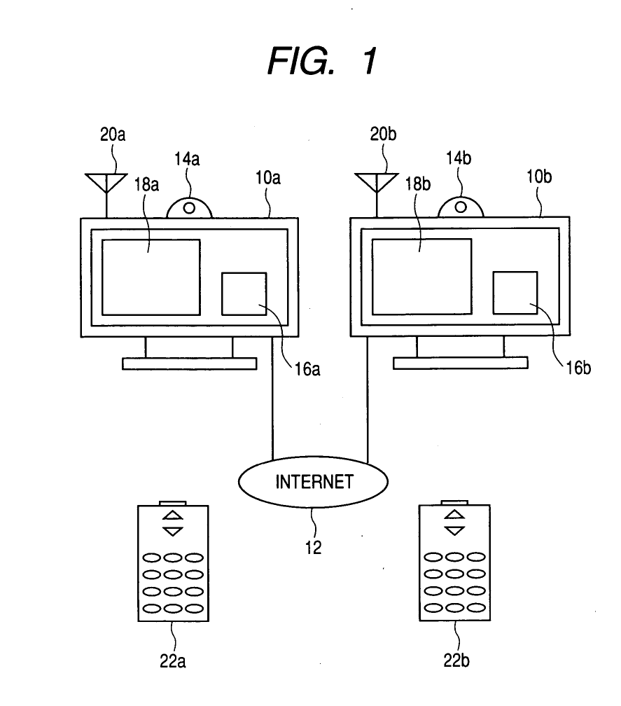

FIG. 1 is a view showing a configuration of a TV receiver system constituting a first embodiment of the present invention. TV receivers 10a, 10b constituting program reproducing apparatuses are mutually connected through an internet 12. There are shown video cameras 14a, 14b for taking images of viewers; sub images 16a, 16b for displaying taken images of partner viewers; viewing images 18a, 18b of received TV programs; antennas 20a, 20b for receiving TV broadcast waves; and remote controls 22a, 22b for switching the viewed TV programs by controlling the TV receivers 10a, 10b.

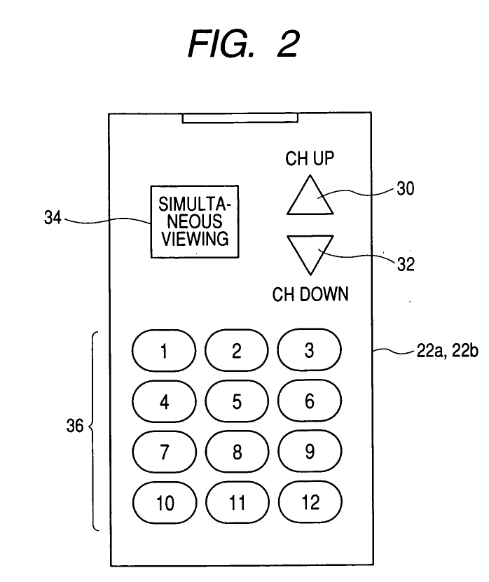

FIG. 2 is a plan view of a remote control 22a or 22b, provided with a channel up key 30, a channel down key 32, a simultaneous viewing start key 34 and numeral keys 36.

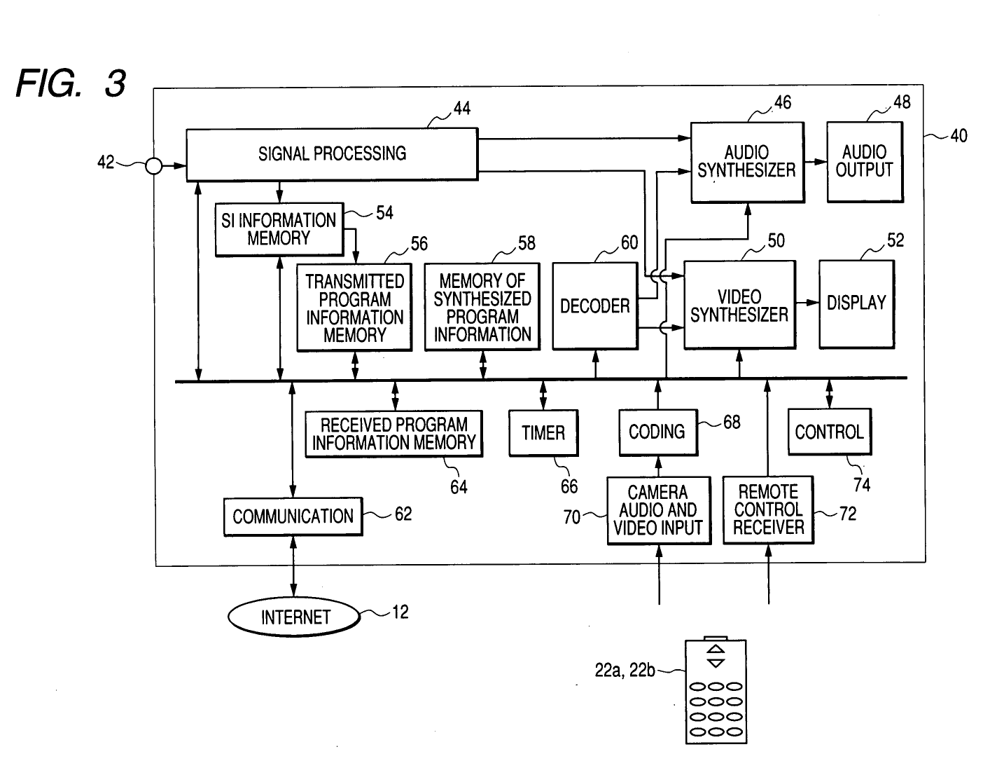

FIG. 3 shows an internal structure of the TV receiver 10a or 10b. A main body 40 of the TV receiver 10a, 10b is provided with an antenna terminal 42, to which the antenna 20a or 20b is connected. A broadcast station outputs a broadcast signal which encodes and multiplexes video information, audio information and SI (service information) (described in “program arrangement information used in digital broadcasting” of ARIB STD-B10). One of the SI is a program arrangement information called EIT (event information table) and describing program information for each channel, and there are described information relating to the program, such as a channel number, a program title and a date and time of broadcasting.

The broadcast signal outputted from the broadcasting station is received by the antenna 20a, 20b and supplied through the antenna terminal 42 to a signal processor 44 constituting a selecting circuit. The signal processor 44 is provided with a tuner for selecting a signal of a predetermined frequency from the input signal, a demultiplexer for separating the signal, selected by the tuner, into audio information, video information, and other control information, and a decoder for decoding each signal from the demultiplexer. The signal processor 44, after decoding the video information and the audio information from the broadcast signal from the antenna terminal 42 under an instruction of a control portion 74, outputs video data and audio data respectively to a video synthesizer 50 and an audio synthesizer 46. The signal processor 44 extracts SI out of the broadcast signal from the antenna terminal 42, and outputs SI from time to time to an SI memory 54. The SI memory 54 stores the SI from the signal processor 44.

The video synthesizer 50 executes a synthesizing process so as to display plural input video information on plural images, and outputs it to a display 52. The audio synthesizer 46 switches or synthesizes plural input audio information for supply to an audio output portion 48.

The display 52, constituted of a display apparatus, displays the input video information as an image. The audio output 48 outputs the input audio information to the exterior.

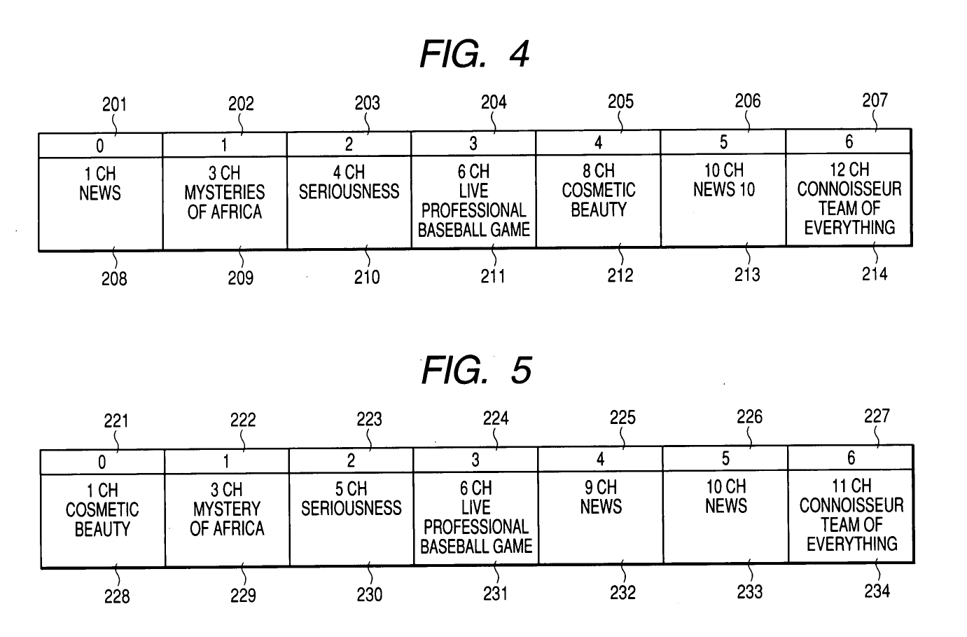

A transmitted program memory 56 stores, under an instruction of the control portion 74 constituted of a control circuit, a program information data column constituted solely of program information (channel number and program title) in the EIT broadcasted at the current time in the SI memory 54. An example of the program information data column is shown in FIG. 4. The program information data column is arranged according the order of channel numbers. The program information data column is transmitted under the instruction of the control portion 74 to a communication portion 62. The control portion 74 for controlling steps to be explained in the following is formed by a memory for storing a program for the following control and a signal processing circuit for executing such program.

A camera video/audio input portion 70 outputs video and audio taken data to an encoder 68. The encoder 68 encodes the input data on real-time basis and outputs encoded data to the communication portion 62.

The communication portion 62 constituting a transmitting circuit and a receiving circuit transmits the encoded camera video/audio information from the encoder 68 through the internet 12 to a partner TV receiver, and outputs the encoded camera video/audio information, received from the partner TV receiver through the internet 12, to the decoder 60.

Also the communication portion 62, under an instruction from the control portion 74, transmits a request for deriving program information to the partner TV receiver through the internet 12, and outputs a program information dedriving request, received from the partner TV receiver through the internet 12, to the control portion 74.

Also the communication portion 62, under an instruction from the control portion 74, transmits a program information data column (FIG. 4), stored in the transmitted program information memory 56, to the partner TV receiver through the internet 12, and outputs a program information data column as shown in FIG. 5, received from the partner TV receiver through the internet 12, to the received program information memory 64.

Also the communication portion 62, under an instruction from the control portion 74, transmits a channel up/down operation notice to the partner TV receiver through the internet 12, and outputs a channel up/down operation notice, received from the partner TV receiver through the internet 12, to the control portion 74.

Also the communication portion 62, under an instruction from the control portion 74, transmits a program information deriving start signal, a synthesizing process start signal etc. to the partner TV receiver through the internet 12, and outputs signals, received from the partner TV receiver through the internet 12, to the control portion 74.

The decoder 60 decodes encoded data of the video/audio information of video camera entered from the communication portion 62 on real-time basis, for supply to the video synthesizer 60.

The received program information memory 64 stores the program information data column entered from the communication portion 62. The program information data column shown in FIG. 5 is constituted solely of program information (channel number and program title), as in the data column stored in the transmitted program information memory 56.

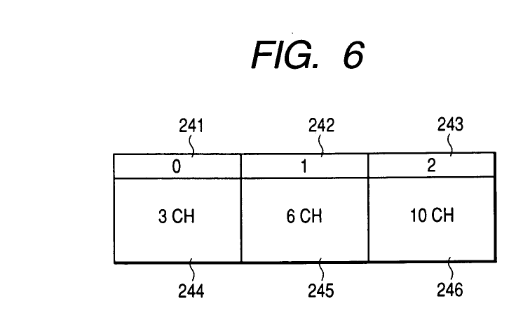

A synthesized program information memory 58 synthesizes, under an instruction from the control portion 74, the program information data column stored in the transmitted program information memory 58 and the program information data column stored in the received program information memory 64 to form and store a program information data column as shown in FIG. 6. Details of the synthesizing process will be explained later.

A timer 66, when a timer value specific to the TV receiver elapses after the start of time measurement, terminates the time measurement and informs the control portion 74 of an end of timer.

A remote control receiver 72, upon receiving a depression signal of the channel up key 30 or the channel down key 32 of the remote controller 22a or 22b, informs the control portion 74 of a channel up/down selecting operation corresponding to such key operation. Also the remote control receiver 72, upon receiving a depression signal of the simultaneous viewing start key 34 for the first time after the power supply is turned on, informs the control portion 74 of a simultaneous viewing start request.

The functions of the control portion 74 will be explained in detail. Upon receiving a simultaneous viewing start request from the remote control reception portion 72 or a timer end notice from the timer 66, the control portion 74 transmits a master candidate request to a partner TV receiver through the communication portion 62. The control portion 74 transmits a program information deriving request to the partner TV receiver, and, in response, obtains a program information data column as shown in FIG. 5 and stores it in the received program information memory 64. Also upon receiving a program information deriving request from the partner TV receiver through the communication portion 62, the control portion 74 extracts, from the SI memory 54, the program information (channel number, start time, duration time and program title) only from the EIT currently broadcasted to prepare a program information data column as shown in FIG. 4, outputs it to the transmitted program information memory 56 and returns it to the partner TV receiver through the communication portion 62. Also the partner TV receiver executes a similar process and returns the program information data column as shown in FIG. 5.

The control portion 74 extracts, from the program information data column of FIG. 4 stored in the transmitted program information memory 56 and the program information data column of FIG. 5 stored in the received program information memory 64, program information data with matching channel number and program title to prepare a program information data column as shown in FIG. 6, then stores it in the synthesized program information memory 68 and executes a switching to a simultaneous viewing mode. An icon or the like may be displayed on the display 52 in order to inform the user of such switching to the simultaneous viewing mode.

The control portion 74, upon receiving a channel up/down selecting operation notice from the remote control receiving portion 72, transmits a channel up/down selecting operation notice to the partner TV receiver through the communication portion 62.

The control portion 74, upon receiving a channel up/down selecting operation notice from the remote control receiving portion 72 or the communication portion 62 in the course of a simultaneous viewing, and in case of a channel up operation notice, controls the station selection of the signal processor 44 by referring to a channel number of program information of an incremented data number in the program information data column in the synthesized program information memory 58. In case of a channel down operation notice, the control portion 74 controls the station selection of the signal processor 44 by referring to a channel number of program information of a decremented data number in the program information data column in the synthesized program information memory 58.

The control portion 74 integrally controls the communication portion 62, the signal processor 44, the SI memory 54, the video synthesizer 50, the audio synthesizer 46, the transmitted program information memory 56, the decoder 60, the received program information memory 64, the synthesized program information memory 58, and the timer 66.

Now reference is made to FIGS. 1, 7, 8 and 9 for explaining a process sequence between the TV receivers and displays on both TV receivers in the present embodiment.

When the user depresses the simultaneous viewing start key 34 of the remote control 22a of the TV receiver 10a for the first time after the power supply is turned on (S101), the TV receiver 10a starts the timer 66 (S102) and at the same time transmits a master candidate request, for becoming a master of the program information process, to the TV receiver 10b (S103). The TV receiver 10b returns an OK response (S104).

Receiving the OK response, the TV receiver 10a sets a master flag, indicating the master, at “1” (S105). In both TV receivers 10a, 10b, an initial state of the master flag is “0”.

In case a user thereafter depresses the simultaneous viewing start key of the TV receiver 10b (S106), the TV receiver 10b likewise starts the timer 66 (S107) and transmits a master candidate request (S108). The TV receiver 10a returns an NG response since its master flag is already at “1” (S109).

The TV receiver 10a, having received the OK response in S104, transmits a program information deriving request to the TV receiver 10b (S110). The TV receiver 10b constructs a program information data column as shown in FIG. 5 from the SI information stored in the SI memory 54 and returns it to the TV receiver 10a (S111).

Then the TV receiver 10a informs the TV receiver 10b of a program information deriving start signal requesting a transmission of a program information deriving request (S112). In response to this signal, the TV receiver 10b transmits a program information deriving request to the TV receiver 10a (S113), and the TV receiver 10a similarly constructs a program information data column and transmits it to the TV receiver 10b (S114).

Then the TV receiver 10a transmits a synthesizing process start signal to the TV receiver 10b (S115) and starts a synthesizing process (S116), thereby assuming a simultaneous viewing mode. Also the TV receiver 10b receiving the synthesizing process start signal starts a synthesizing process (S118) thereby assuming a simultaneous viewing mode.

In the synthesizing process (S116) in the TV receiver 10a, a search is made, on 0-th data (channel 1, News) in the program information data column of FIG. 4 stored in the transmitted program information memory 56, for data with matching channel number and program title in the program information data column of FIG. 5 stored in the received program information memory 64. In the absence of data with matching channel number and program title, then a similar search is made on 1st data (channel 3, Mystery of Africa) in the program information data column of FIG. 4 stored in the transmitted program information memory 56 for data with matching channel number and program title.

In the example shown in FIG. 3, data 333 (channel 3, Mystery of Africa) shows matching, so that a channel number “3” is stored in the synthesized program information memory 58. Thereafter, a similar process is executed to extract data 109 with matching channel number and program title (channel 6, Live Pro Baseball Game and channel 10, News) to prepare a program information data column as shown in FIG. 6, which is arranged in an increasing order of the channel numbers, and which is stored in the synthesized program information memory 58. In the present embodiment, the program information data column is constructed in the increasing order of the channel numbers, but the construction may be made in another order.

The TV receiver 10b also executes a similar synthesizing process (S118) to prepare a program information data column which has a content same as that of the program information data column stored in the synthesized program information memory 58 of the TV receiver 10a, and which is stored in the synthesized program information memory 58 of the TV receiver 10b. In this state, the transmitted program information memory 56 of the TV receiver 10a stores the program information data column as shown in FIG. 4, and the received program information memory 64 stores the program information data column as shown in FIG. 5.

Then the TV receiver 10a shifts the master flag to “0” in order to indicate an abandonment of the master for the program information process (S117).

Then, when the user actuates the channel up key in the remote control 22a of the TV receiver 10a (S119), the TV receiver 10a transmits a channel up selecting operation notice to the TV receiver 10b (S120). Then the TV receiver 10a changes a referenced position of the program information data column stored in the synthesized program information memory 58 from 0th data “channel 3” 241 to 1st data “channel 6” 242 and the signal processor 44 selects the channel number “channel 6” stored in the referenced 1st data (S121), thereby displaying a broadcast program on a TV program viewing area 18a. In the present embodiment, the initial reference is made to the 0th program information data as explained above, but other data may also be selected for reference.

Also the TV receiver 10b, receiving the channel up selecting operation notice through the communication portion 62, similarly changes a referenced position of the program information data column stored in the synthesized program information memory 58 from 0th data “channel 3” 241 to 1st data “channel 6” 242 and the signal processor 44 selects the channel number “channel 6” stored in the referenced 1st data (S122), thereby displaying a broadcast program on a TV program viewing area 18b.

As a result of these operations, the TV program viewing areas 18a, 18b of both TV receivers 10a, 10b display a program of channel 6 “Live Pro Baseball Game” as shown in FIG. 8.

When the user actuates the channel down key in the remote control 22b of the TV receiver 10b (S123), the TV receiver 10b transmits a channel down selecting operation notice to the TV receiver 10a (Sl24). Then the TV receiver 10b changes a referenced position of the program information data column stored in the synthesized program information memory 58 from 1st data “channel 6” 242 to 0th data “channel 3” 241 and the signal processor 44 selects the channel number “channel 3” stored in the referenced 0th data (S125), thereby displaying a broadcast program of the channel 3 on the TV program viewing area 18b.

Also the TV receiver 10a, receiving the channel down selecting operation notice through the communication portion 62, similarly changes a referenced position of the program information data column stored in the synthesized program information memory 58 from 1st data “channel 6” 242 to 0th data “channel 3” 241 and the signal processor 44 selects the channel number “channel 3” stored in the referenced 0th data (S126), thereby displaying a broadcast program of channel 3 on the TV program viewing area 18a.

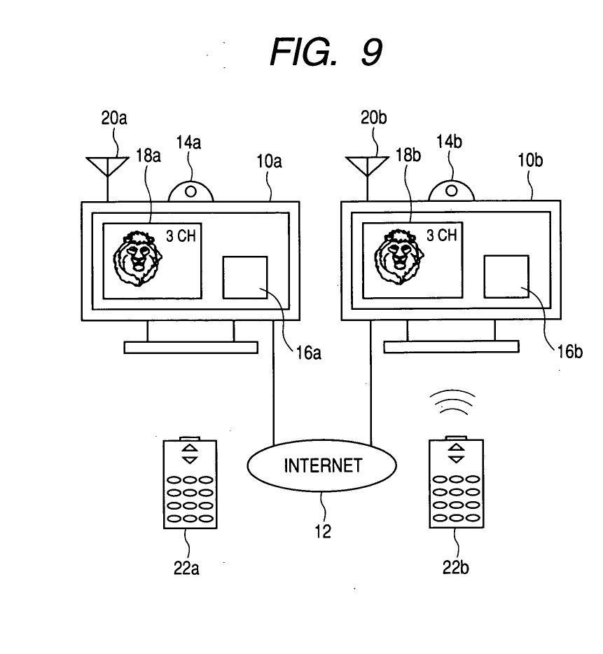

As a result of these operations, the TV program viewing areas 18a, 18b of both TV receivers 10a, 10b display a program of channel 3 “Mystery of Africa” as shown in FIG. 9.

Thereafter, upon receiving a timer end notice from the timer 66 (S127), the TV receiver 10a again starts the timer 66 (S128), then again transmits a master candidate request for becoming the master in the program information process to the partner TV receiver 10b (S129) and thereafter repeats a similar procedure (S130-S139). The TV receivers 10a and 10b may have mutually different timer values.

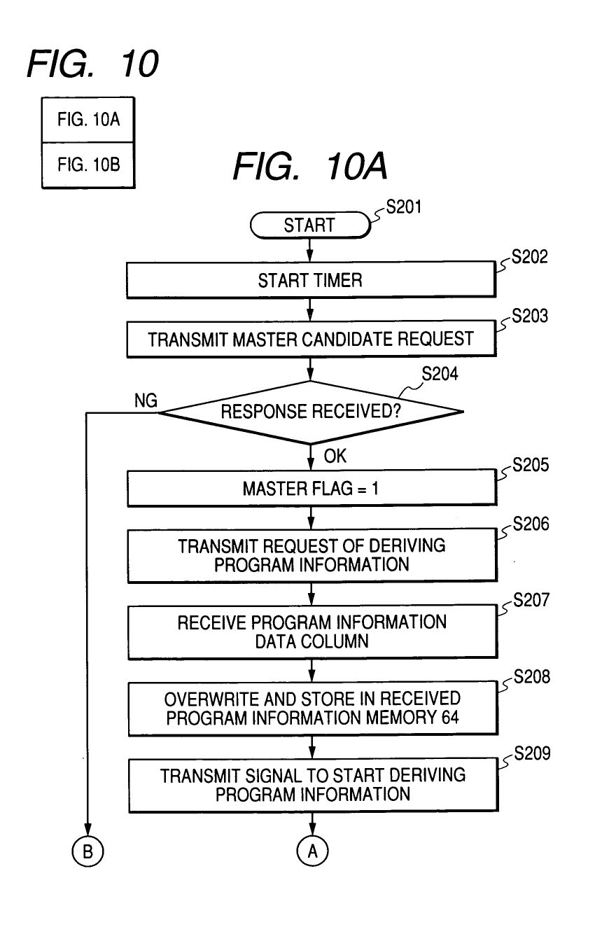

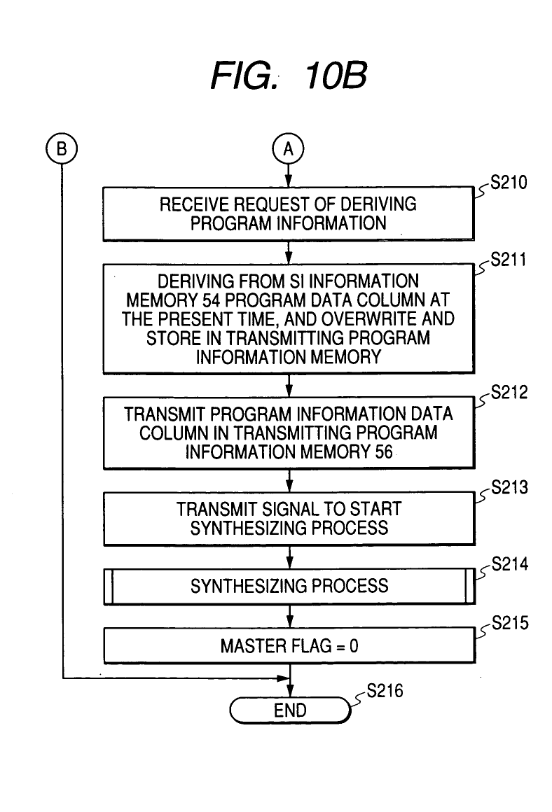

FIGS. 10A and 10B are flow charts showing a process of the control portion 74 of the TV receiver 10a in case the user depresses the simultaneous viewing start key 34 for the first time after the power supply is turned on or a timer end notice is received from the timer 66.

In response to a simultaneous viewing start request from the remote control receiving portion 72 or a timer end notice from the timer 66, the TV receiver 10a starts a time measurement by the timer 66 (S202) and transmits a master candidate request to the TV receiver 10b (S203). Thereafter it receives a response from the TV receiver 10b (S204). In case of an NG response, the sequence is terminated (S216). In case of an OK response, the TV receiver 10a sets the master flag at “1” (S205) and transmits a program information deriving request to the TV receiver 10b (S206). Upon receiving a program information data column from the TV receiver 10b (S207), the TV receiver 10a overwrites the received program information memory 64 with such program information data column (S208).

Then the TV receiver 10a transmits a program information deriving start signal to the TV receiver 10b (S209). Upon receiving a program information deriving request from the TV receiver 10b (S210), the TV receiver 10a extracts a program information data column currently broadcasted from the SI memory 54, and overwrites the transmitted program information memory 56 (S211). The TV receiver 10a transmits the program information data column stored in the transmitted program information memory 56 to the TV receiver 10b (S212). Then the TV receiver 10a transmits a synthesizing process start signal to the TV receiver 10b (S213) and initiates a synthesizing process to be explained in a following flow chart (S214). Thereafter the TV receiver 10a returns the master flag to “0” and terminates the process (S215).

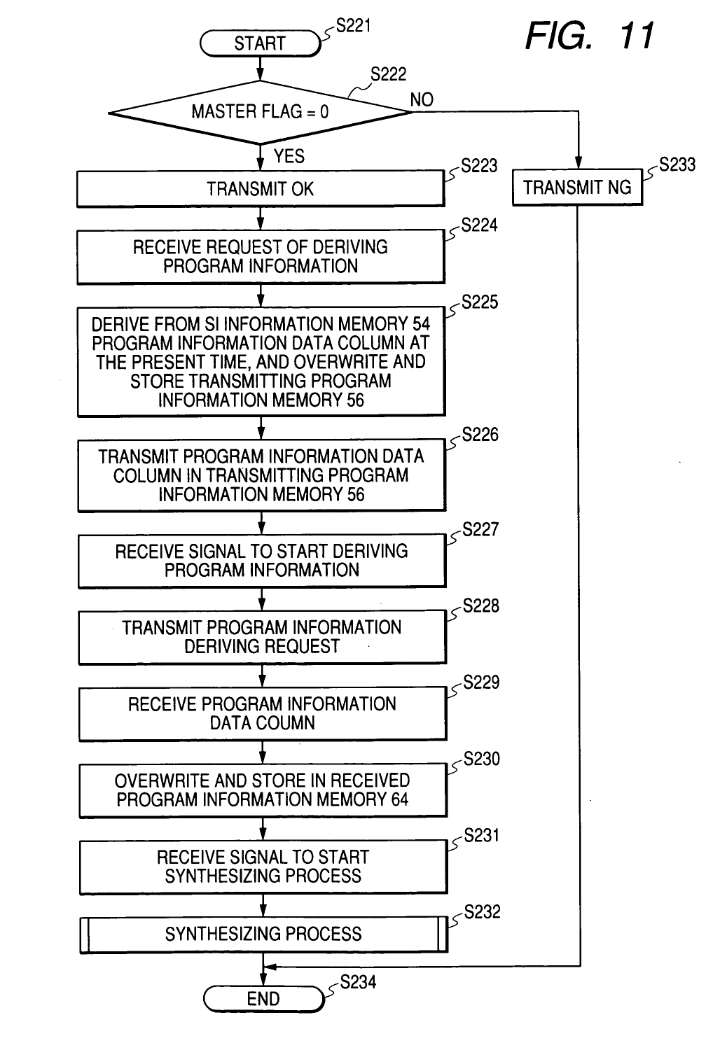

FIG. 11 is a flow chart showing a process executed by the control portion 74 of the TV receiver 10b after receiving the master candidate request.

The TV receiver 10b, after receiving the master candidate request from the partner TV receiver 10b, discriminates whether the master flag is “0” (S222). If false, namely if the master flag is “1”, an NG response is returned (S233) and the process is terminated. If true, namely if the master flag is “0”, an OK response is returned (S223).

Then, upon receiving a program information deriving request from the partner TV receiver 10a (S224), the TV receiver 10b extracts a program information data column currently broadcasted from the SI memory 54, and overwrites the transmitted program information memory 56 (S225). The TV receiver 10b transmits the program information data column stored in the transmitted program information memory 56 to the partner TV receiver 10a (S226).

Upon receiving a program information deriving start signal from the partner TV receiver 10a (S227), the TV receiver 10b transmits a program information deriving request to the partner TV receiver 10a (S228). Thereafter it receives a program information data column from the partner TV receiver 10a (S229) and overwrites the received program information memory 64 (S230).

When a synthesizing process start signal is received from the partner TV receiver 10a (S231), the TV receiver 10b initiates a synthesizing process to be explained in a following flow chart (S232) and terminates the process (S234).

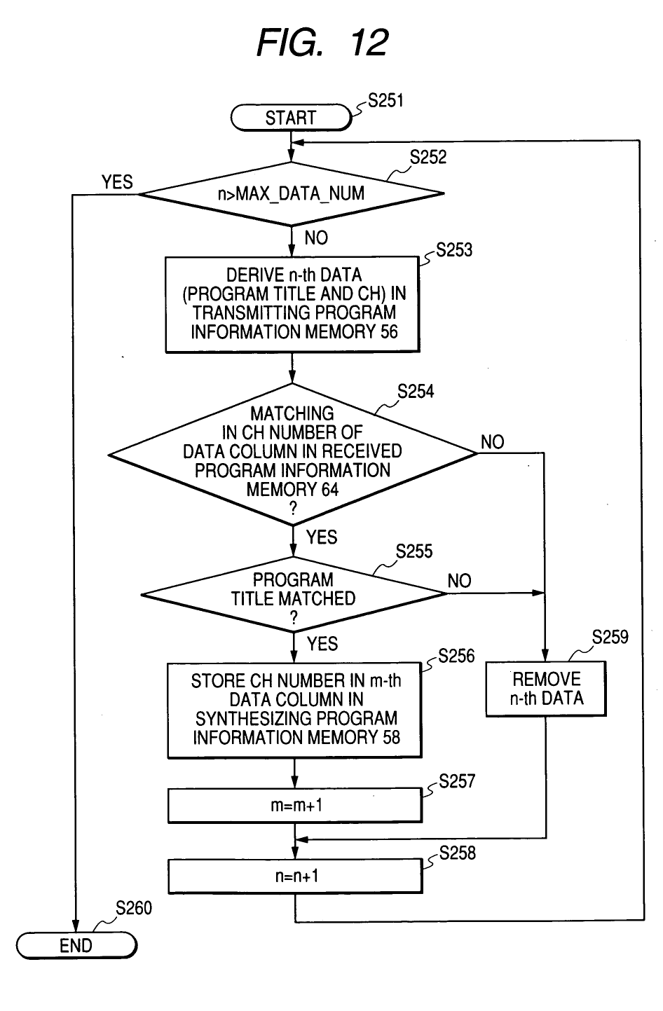

FIG. 12 is a flow chart showing a synthesizing process (S214, S232) executed by the control portion 74. A data column variable n has an initial value “0”. MAX_DATA_NUM indicates a maximum data number of the program information data column in the transmitted program information memory 56.

There is made a discrimination whether the data column variable n is larger than MAX_DATA_NUM (S252), and, if true, the process is terminated (S260). In case of false, namely in case n is equal to or smaller than MAX_DATA_NUM (S252), a channel number and a program title are extracted from an n-th program information data in the program information data column of the transmitted program information memory 56 (S253).

Then there is discriminated whether program information data of a matching channel number are present in the program information data column in the received program information memory 64 (S254), and, if false, namely in case of absence of matching data, the program information data extracted in the step S253 are discarded (S259) and the sequence skips to a step S258. If true, namely in the presence of matching data, there is discriminated whether the program titles in both program information data mutually match (S255). If false, namely in case of absence of matching data, the program information data extracted in the step S253 are discarded (S259) and the sequence skips to a step S258. If true, namely in case of matching, the channel number extracted in the step S253 is stored in an m-th position of the program information data column in the synthesized program information memory 58 (S256), then m is incremented (S257) and the variable n of the program information data column is incremented (S258). Thereafter the sequence returns to the step S252 to repeat the process. The variable m has an initial value “0”.

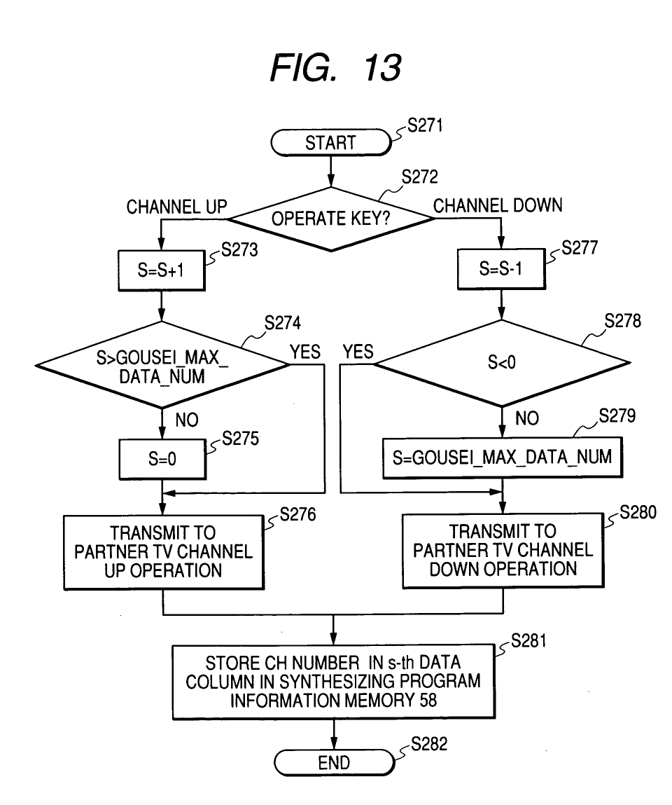

FIG. 13 is a flow chart showing a process executed by the control portion 74 when the simultaneous viewing start key 34 and then the channel up/down key 30 or 32 are depressed in at least either of the TV receivers 10a, 10b.

At first there is discriminated which of the channel up/down keys 30, 32 was depressed (S272).

In case of the channel up key 30, a data column variable s is incremented (S273). There is discriminated whether the data column variable s is larger than GOUSEI_MAX_DATA_NUM (S274), and, if true, “0” is substituted in the data column variable s (S275). If false, the sequence skips to a step S276. The data column variable s has an initial value “0” when the power supply is turned on, but is not initialized thereafter. GOUSEI_MAX_DATA_NUM indicates a maximum data number of the program information data column in the synthesized program information memory 58.

Then a channel up operation notice is transmitted to the partner TV receiver (S276). A station selection is executed based on a channel number stored in s-th data of the program information data column in the synthesized program information memory 58 (S281) and the process is terminated (S282).

In case the channel down key 32 was depressed (S272), the data column variable s is decremented (S277). There is discriminated whether the data column variable s has a negative value (S278), and, if true, GOUSEI_MAX_DATA_NUM is substituted in the data column variable s (S279). If false, the sequence skips to a step S280.

Then a channel down operation notice is transmitted to the partner TV receiver (S280). A station selection is executed based on a channel number stored in s-th data of the program information data column in the synthesized program information memory 58 (S281) and the process is terminated (S282).

The above-described process allows, by a channel selecting operation in either remote control, to switch to and view a same broadcast program in both TV receivers. Thus, even in areas with different combinations of broadcast programs, it is possible to view a same broadcast program without an operation of searching a same program viewable to the users and a remote control operation of selecting such program.

### Embodiment 2

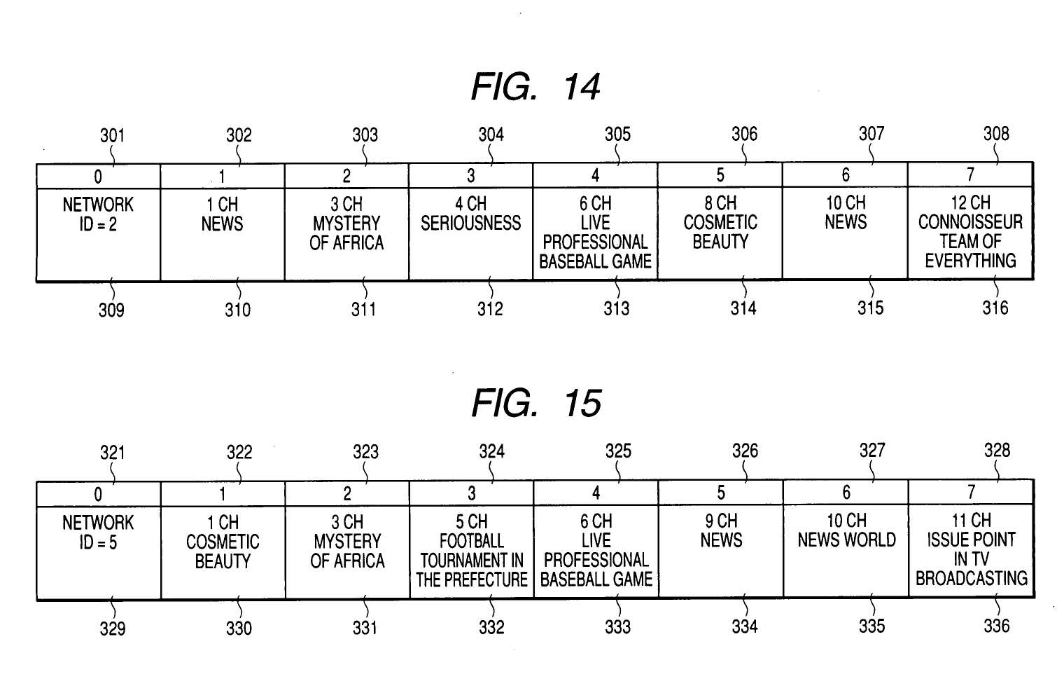

The program information data column may be changed as shown in FIGS. 14, 15 and 16.

As shown in FIG. 14, a network ID is added to the program information data column stored in the SI memory 54. The network ID is described in an information table, called an NIT (network information table) as one of the SI information and indicating the service construction of the broadcast network. The program information data column stores the network ID 329 in a 0th column and stores channel numbers and program titles in the following columns.

The received program information memory 64 stores a program information data column as shown in FIG. 15, entered from the communication portion 62. The program information data column has a same order of construction as the data column in the transmitted program information memory 56.

Now there will be explained the functions of the control portion 74 in case the network ID is added to the program information data column.

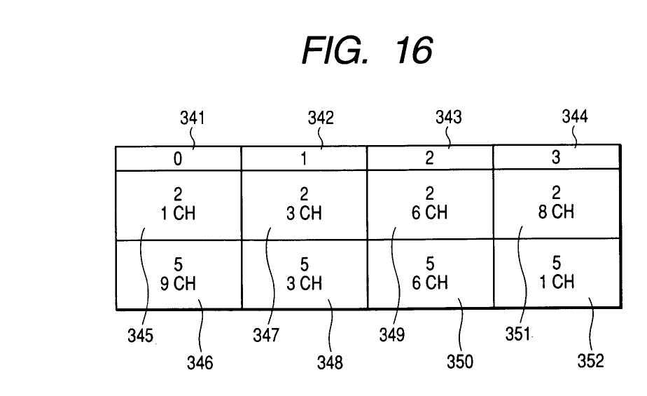

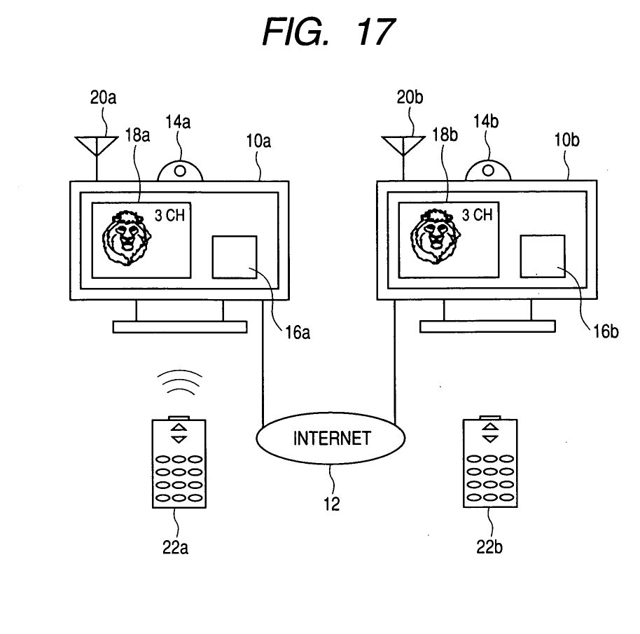

The control portion 74 extracts program information data of matching program title from the program information data columns of the transmitted program information memory 56 and the received program information memory 64, thus prepares a program information data column storing a network ID and a channel number for each program title as shown in FIG. 16 and stores it in the synthesized program information memory 58.

Also the control portion 74, upon receiving a channel up/down selecting operation notice from the remote control receiving portion 72 or the communication portion 62, and in case of a channel up selecting operation notice, executes a search for a channel number corresponding to the network ID in the program information data column stored in the transmitted program information memory 56, from the program information of an incremented data number in the program information data column in the synthesized program information memory 58, and the signal processor 44 selects a station of the detected channel number. Also in case of a channel down selecting operation notice, a search is executed for a channel number corresponding to the network ID in the program information data column stored in the transmitted program information memory 56, from the program information of a decremented data number in the program information data column in the synthesized program information memory 58, and the signal processor 44 selects a station of the detected channel number.

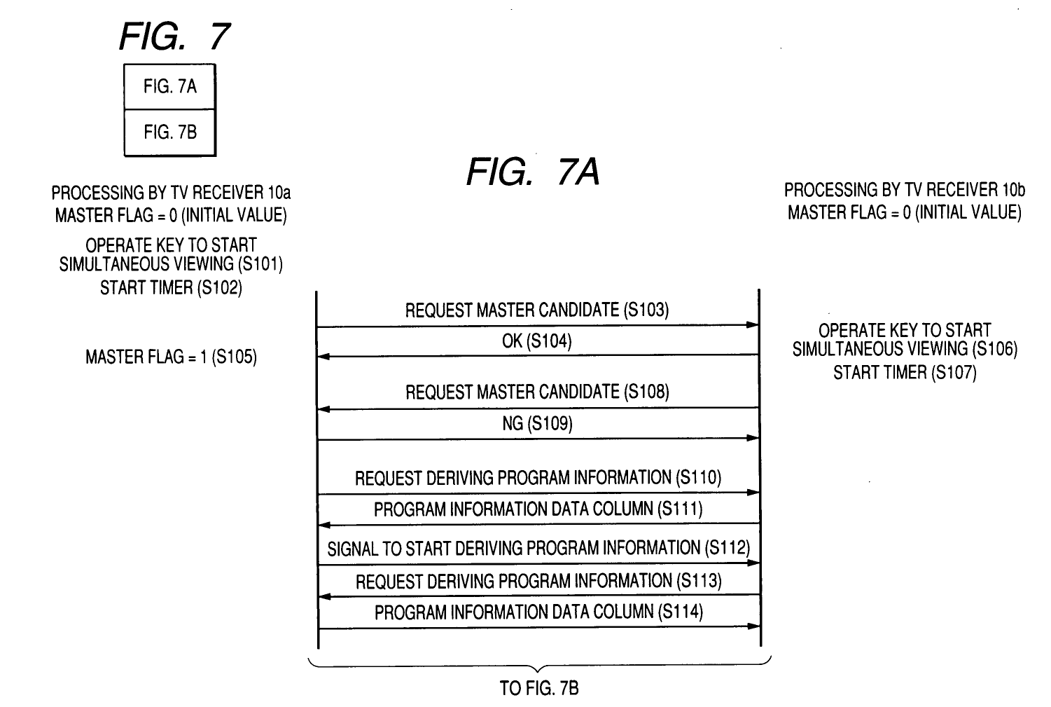

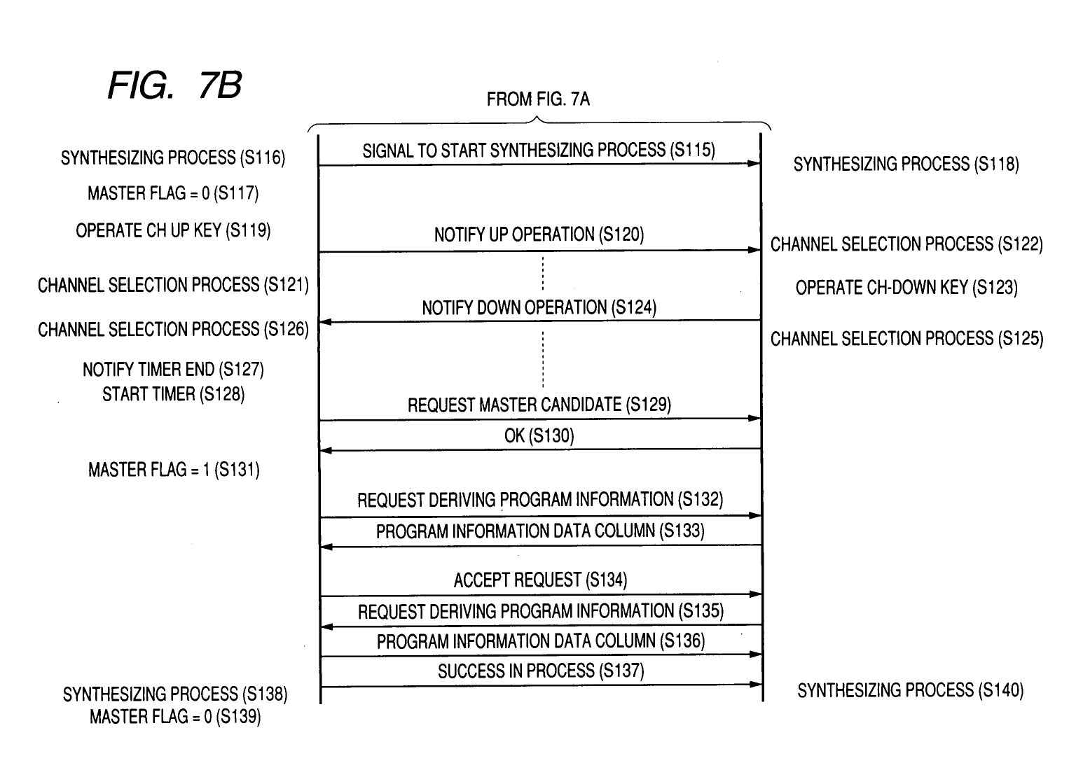

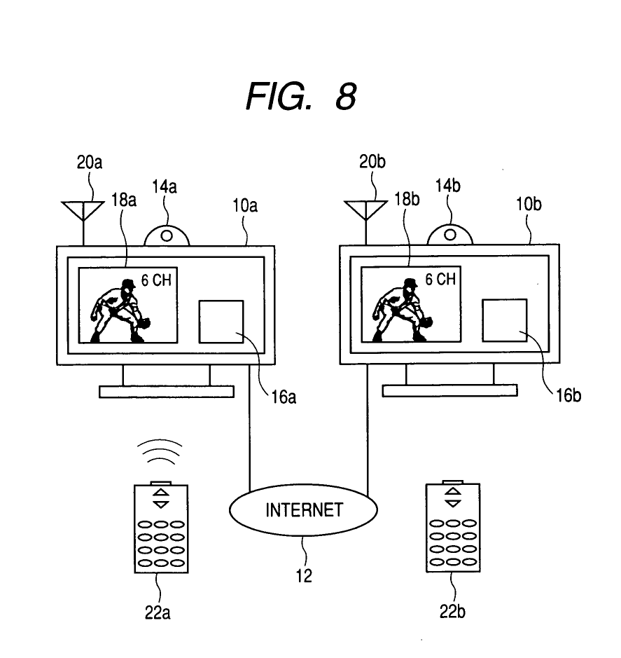

Now reference is made to FIGS. 7, 17 and 18 for explaining a process sequence between the TV receivers 10a, 10b and displays on both TV receivers 10a, 10b in the embodiment 2.

In a synthesizing process (S116) of the TV receiver 10a, at first in the program information data column stored in the transmitted program information memory 56 (FIG. 14) and the program information data column stored in the received program information memory 64 (FIG. 15), the network IDs “2” and “5” constituting the 0th data are compared, and the program information data column in the transmitted program information memory 56 are referenced in the increasing order of the ID number. In the present embodiment, the 1st data (channel 1, News) 310 are referenced, and data of a matching program title (channel 9, News) 334 are extracted from the program information data column (FIG. 15) in the received program information memory 64. Then, as shown in FIG. 16, the smaller network ID “2” in the comparison, a channel number “channel 1” 345 corresponding to such network ID, the larger network ID “5” in the comparison, and a channel number “channel 9” 346 corresponding to such network ID are stored in 0th data 341 of the synthesized program information memory 58.

Thereafter, programs “Mystery of Africa”, “Live Pro Baseball Game” and “Cosmetic Beauty” are extracted in a similar process, and a data column is constructed and stored in the synthesized program information memory 58 as shown in columns 342, 343, 344 in FIG. 16.

A synthesizing process (S118) is similarly executed in the TV receiver 10b, whereby a program information data column same as that in the synthesized program information memory 58 of the TV receiver 10a is stored in the synthesized program information memory 58 of the TV receiver 10b.

When the user actuates the channel up key in the remote control 22a of the TV receiver 10a (S119), the TV receiver 10a transmits a channel up selecting operation notice to the TV receiver 10b (S120). Then the TV receiver 10a changes a referenced position of the program information data column in the synthesized program information memory 58 from 0th data (network ID=2, channel 1; network ID=5, channel 9) 341 to 1st data (network ID=2, channel 3; network ID=5, channel 3) 342.

In the TV receiver 10a, based on the referenced data 342, the signal processor 44 selects a channel number “channel 3” corresponding to the network ID “2” of the TV receiver 10a (S121), thereby displaying a broadcast program on the TV program viewing area 18a. The network ID of the TV receiver 10a is 0th data value in the program information data column (FIG. 14) in the transmitted program information memory 56. In the present embodiment, the reference start data (initial value) of the program information data column of the synthesized program information memory 56 are selected as 0th data as explained above, but it is also possible select other data.

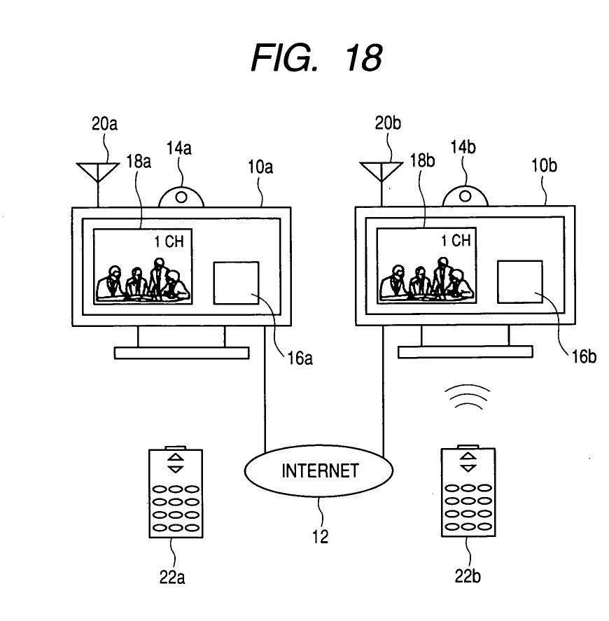

Upon receiving a channel up selecting operation notice through the communication portion 62, the TV receiver 10b changes a referenced position of the program information data column in the synthesized program information memory 58 from 0th data (network ID=2, channel 1; network ID=5, channel 9) 341 to 1st data (network ID=2, channel 3; network ID=5, channel 3) 342. In the TV receiver 10b, based on the referenced data 342, the signal processor 44 selects a channel number “channel 3” corresponding to the network ID “5” of the TV receiver 10b (S122), thereby displaying a broadcast program on the TV program viewing area 18b. In this state, the TV broadcast program viewing areas 18a, 18b of both TV receivers 10a, 10b display the program of channel 2 (Mystery of Africa), as shown in FIG. 17.

When the user actuates the channel down key in the remote control 22b of the TV receiver 10b (S123), the TV receiver 10b transmits a channel down selecting operation notice to the TV receiver 10a (S124). Then the TV receiver 10b changes a referenced position of the program information data column in the synthesized program information memory 58 from 1st data (network ID=2, channel 3; network ID=5, channel 3) 342 to 0th data (network ID=2, channel 1; network ID=5, channel 9) 341. Then, in the TV receiver 10b, based on the referenced data 341, the signal processor 44 selects a channel number “channel 9” corresponding to the network ID “5” of the TV receiver 10b (S125), thereby displaying a broadcast program of channel 9 on the TV program viewing area 18b.

Upon receiving a channel down selecting operation notice through the communication portion 62, the TV receiver 10a changes a referenced position of the program information data column in the synthesized program information memory 58 from (network ID=2, channel 3; network ID=5, channel 3) 342 to (network ID=2, channel 1; network ID=5, channel 9) 341. In the TV receiver 10a, based on the referenced data 341, the signal processor 44 selects a channel number “channel 1” corresponding to the network ID “2” of the TV receiver 10a (S125), thereby displaying a broadcast program of the channel 1 on the TV program viewing area 18a.

As a result of such process, the TV program viewing area 18a of the TV receiver 10a displays “News” of the channel 1, while the TV program viewing area 18b of the TV receiver 10b displays “News” of the channel 9, as shown in FIG. 18.

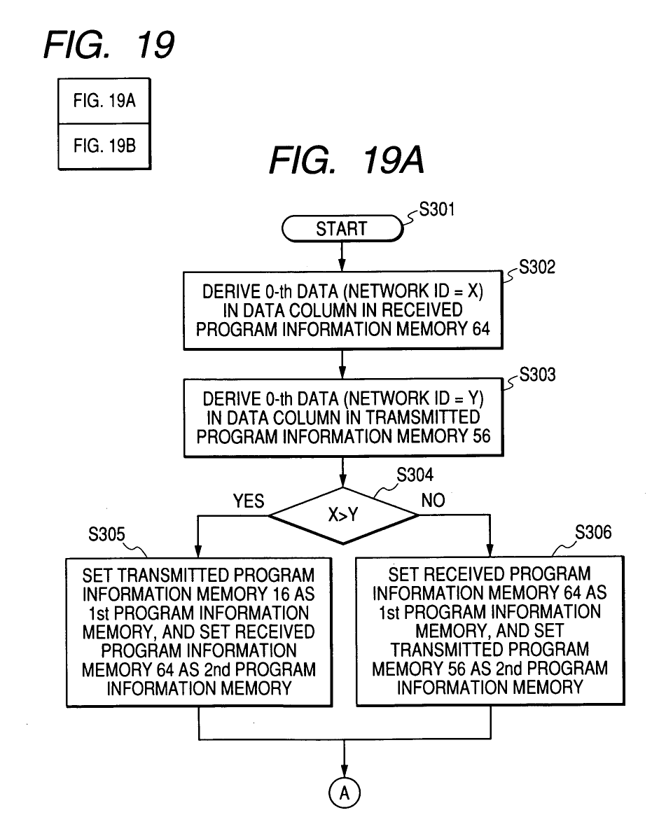

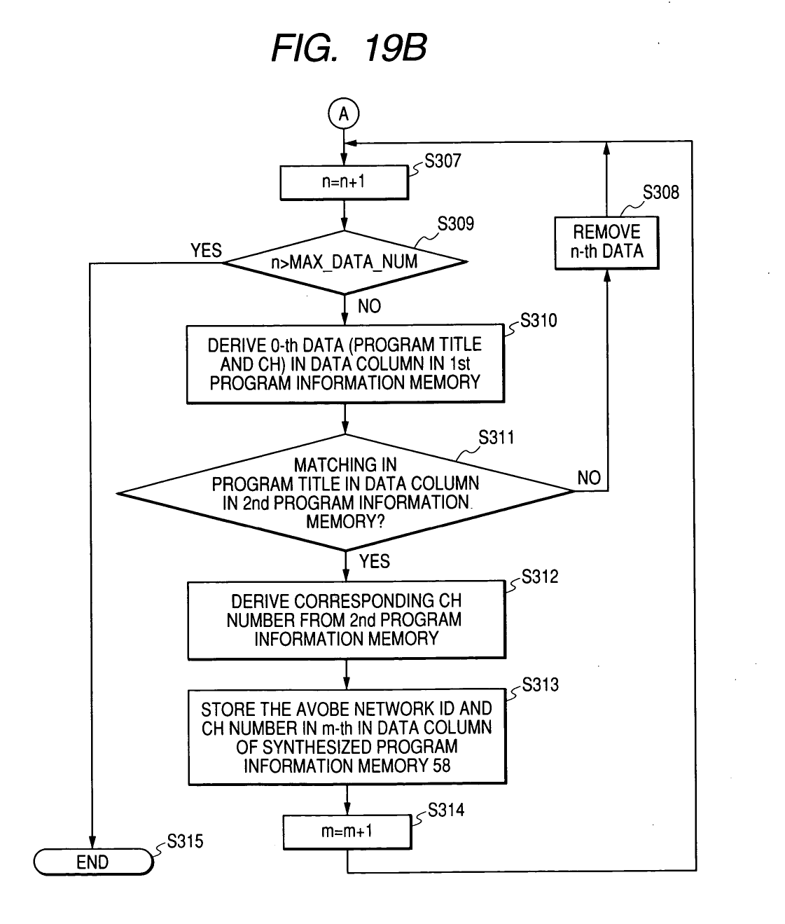

FIGS. 19A and 19B are flow charts showing a synthesizing process (S214, S232) by the control portion 74, in which MAX_DATA_NUM indicates a maximum data number of the program information data column in the transmitted program information memory 56.

A network ID=X is extracted from 0th data of the received program information memory 64 (S302), and a network ID=Y is extracted from 0th data of the received program information memory 56 (S303). There is discriminated whether X>Y (S304), and, if true, the transmitted program information memory 56 is selected as a first program information memory, and the received program information memory 64 is selected as a second program information memory (S305). Also in case the discrimination in the step S304 is false, the received program information memory 64 is selected as a first program information memory, and the transmitted program information memory 56 is selected as a second program information memory (S306).

Then the data column variable n, having an initial value “0”, is incremented (S307). There is discriminated whether the data column variable n is larger than MAX_DATA_NUM (S308), and, if true, the process is terminated (S315). If false, namely in case n is equal to or less than MAX_DATA_NUM, a program title, a channel number and a network ID are taken out from the n-th program information data of the program information data column of the first program information memory (S309).

Then the program information data column of the second program information memory is sorted to look for program information data of a matching program title (S310). In the absence of matching, the program information data extracted in the step S309 are discarded (S311), and the sequence returns to the step S307 to repeat the process. In the presence of matching, a network ID and a channel number are extracted from such matching program data of the second program information memory (S312), and the program title extracted in the steps S309, S312, the network ID from the first program information memory, the channel number from the first program information memory, the network ID from the second program information memory, and the channel number from the second program information memory are stored in an m-th column of the program information data column of the synthesized program information memory 58 (S313). Then m is incremented (S314), and the sequence returns to the step S307 to repeat the process. The variable m has an initial value “0”.

In case the channel up/down key 30 or 32 is depressed, there is discriminated which of the channel up/down keys 30, 32 was depressed (S272). In case of the channel up key 30, a data column variable s is incremented (S273). There is discriminated whether the data column variable s is larger than GOUSEI_MAX_DATA_NUM (S274), and, if true, the data column variable s is returned to “0” (S275). If false, the sequence skips to a step S276. The data column variable s has an initial value “0” when the power supply is turned on, but is not initialized thereafter. GOUSEI_MAX_DATA_NUM indicates a maximum data number of the program information data column in the synthesized program information memory 58.

Then a channel up operation notice is transmitted to the partner TV receiver (S276). A station selection is executed based on a channel number stored in s-th data of the program information data column in the synthesized program information memory 58 (S281) and the process is terminated (S282).

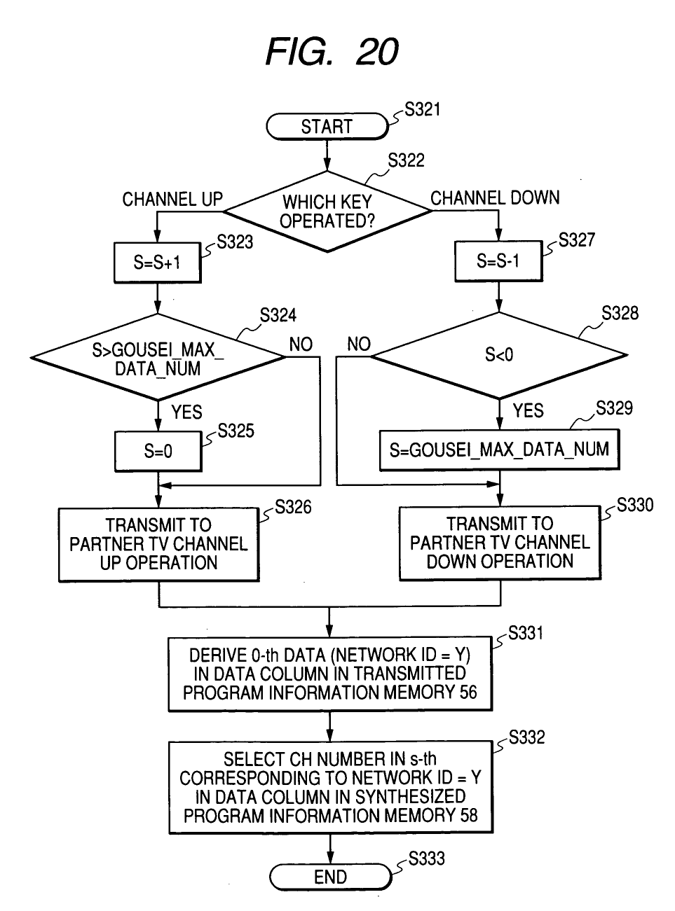

FIG. 20 is a flow chart showing a process executed by the control portion 74 when the simultaneous viewing start key 34 and then the channel up/down key 30 or 32 are depressed in at least either of the TV receivers.

When the channel up/down key 30, 32 is depressed, at first there is discriminated which of the channel up/down keys 30, 32 was depressed (S322). In case of the channel up key 30, a data column variable s is incremented (S323). There is discriminated whether the data column variable s is larger than GOUSEI_MAX_DATA_NUM (S324), and, if true, “0” is substituted in the data column variable s (S325). If false, the sequence skips to a step S326.

The data column variable s has an initial value “0” when the power supply is turned on, but is not initialized thereafter. GOUSEI_MAX_DATA_NUM indicates a maximum data number of the program information data column in the synthesized program information memory 58.

Then a channel up operation notice is transmitted to the partner TV receiver (S326). A network ID=Y is extracted from 0th data of the transmitted program information memory 56 (S331), and a channel number corresponding to network ID=Y is referenced by the s-th data of the program information data column stored in the synthesized program information memory 58 to execute a station selection based on such channel number (S332) whereupon the process is terminated (S333).

In case the channel down key 32 was depressed (S322), the data column variable s is decremented (S327). There is discriminated whether the data column variable s has a negative value (S328), and, if true, GOUSEI_MAX_DATA_NUM is substituted in the data column variable s (S329). A channel down operation notice is transmitted to the partner TV receiver (S330). Thereafter the steps S331, S332 are executed and the sequence is terminated (S333).

The above-described process allows, by a channel selecting operation in either remote control, to switch to and view a same broadcast program in both TV receivers. Thus, even in areas with different combinations of broadcast programs, it is possible to view a same broadcast program without an operation of searching a same program viewable to the users and a remote control operation of selecting such program.

In addition, even in case a broadcast program has different channel numbers in different areas, it is possible to switch to and view the same broadcast program.

### Embodiment 3

Now there will be explained an embodiment 3 of the present invention, which, in case of a station unselectable state, synthesizes and displays a dialog indicating a station unselectable state in an input video information. Other basic constitution and functions are same as in Embodiment 1.

A video synthesizer 50, under an instruction of the control portion 74, synthesizes a dialog “station selection not possible” in input video information and outputs it to the display 52.

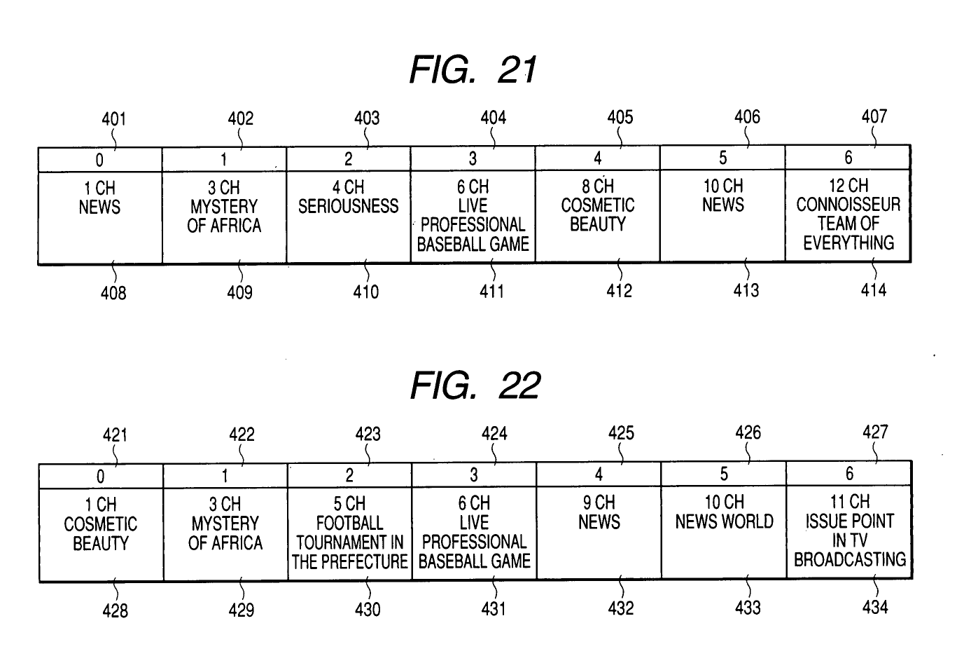

In this embodiment, the transmitted program information memory 56 stores a program information data column as shown in FIG. 21, and the received program information memory 64 stores a program information data column as shown in FIG. 22.

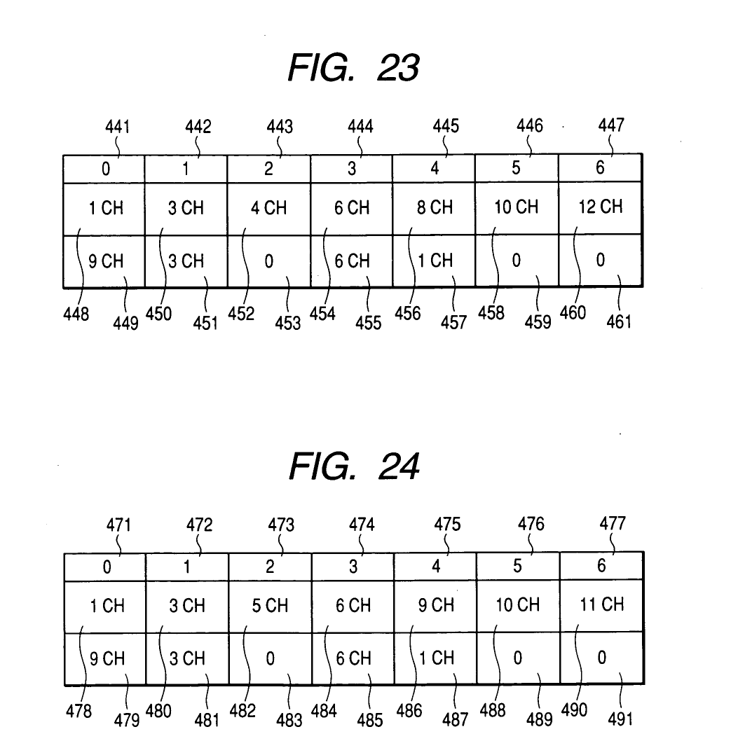

The control portion 74 searches the program information data column stored in the transmitted program information memory 56 and the program information data column stored in the received program information memory 64. In case of a matching of the program title, channel numbers are extracted from the program information data columns stored in the transmitted program information memory 56 and in the received program information memory 64, and are respectively in an own channel number column and a partner channel number column. In case of absence of matching, a channel number from the program information data column of the transmitted program information memory 56 is stored in the own channel number column, while “0” indicating “station unselectable” is stored in the partner channel number column to prepare a program information data column as shown in FIG. 23, which is stored in the synthesized program information memory 58.

Also the control portion 74, upon receiving a station selecting operation notice by the numeral keys 36 from the remote control receiving portion 72, searches a number, matching the number entered by the numeral keys 36, from the own channel number column in the data column (FIG. 23) of the synthesized program information memory 58. In case of a matching, a partner channel number is extracted from the partner channel number column of such data and is transmitted through the communication portion 62 to the partner TV receiver. Then the signal processor 44 is so controlled as to select the channel instructed by the numeral keys. The control portion 74, upon receiving a channel number from the communication portion 62, controls the signal processor 44 to select such channel number.

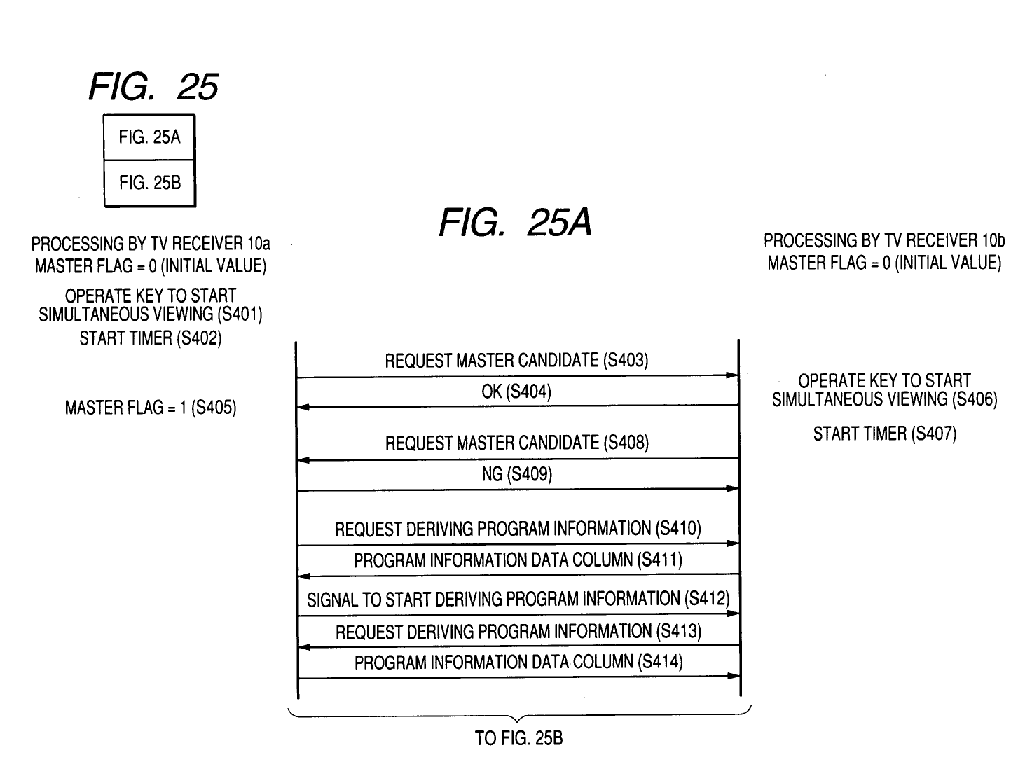

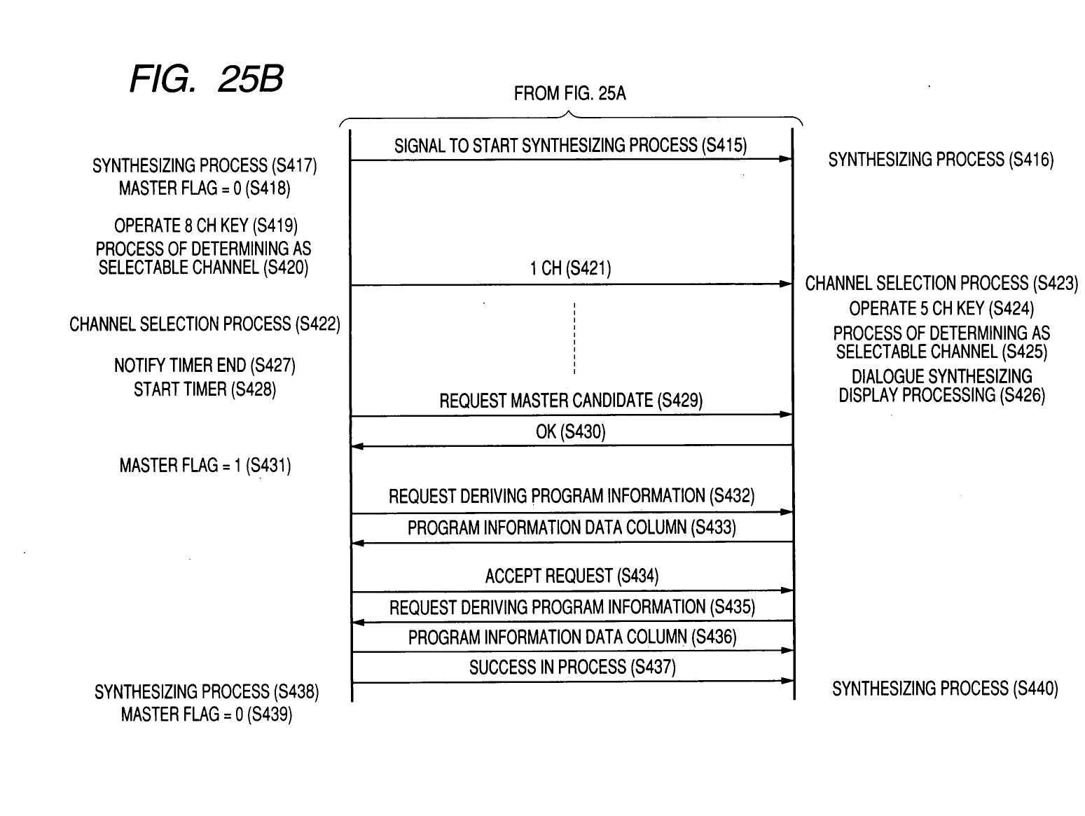

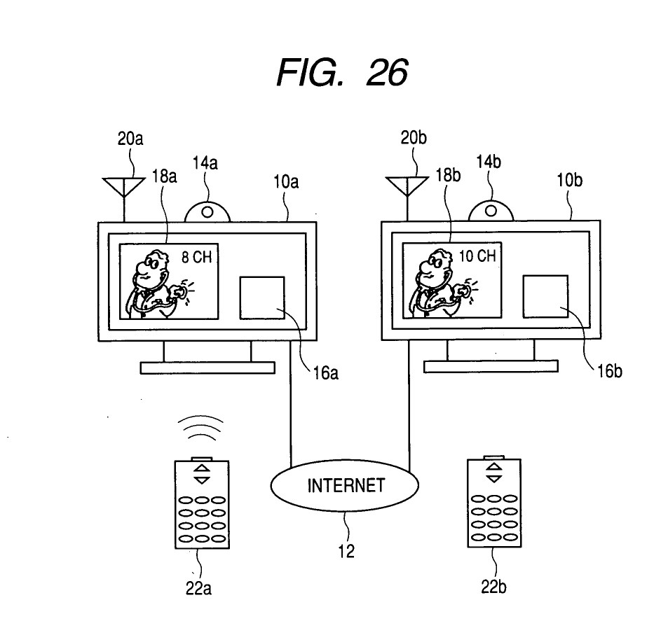

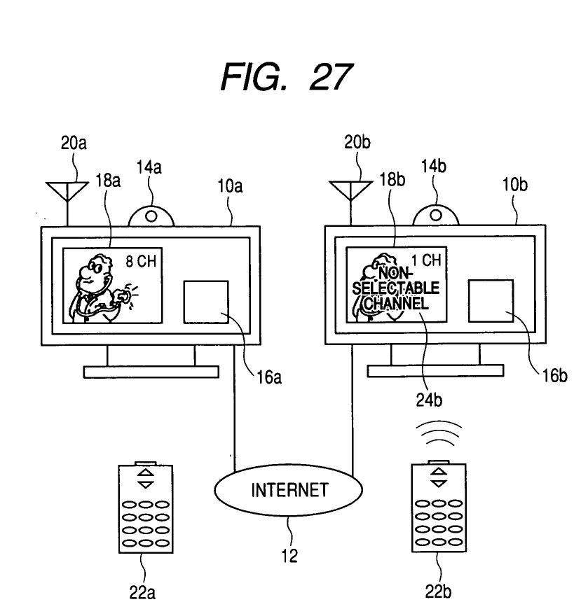

Now reference is made to FIGS. 25, 26 and 27 for explaining a process sequence between the TV receivers and displays on both TV receivers in the embodiment 3.

In a synthesizing process (S417) of the TV receiver 10a, at first 0th data (channel 1, News) 401 in the program information data column (FIG. 21) of the transmitted program information memory 56 is referenced to extract data of matching program title (channel 9, News) from the program information data column (FIG. 22) in the received program information memory 64. Then, as the 0th data 441 of the data column (FIG. 23) in the synthesized program information memory 48, “channel 1” is stored in the own channel number column 448 and “channel 9” is stored in the partner channel number column 449.

Then the 1st data (channel 3, Mystery of Africa) 402 of the program information data column (FIG. 21) in the transmitted program information memory 56 are referenced to extract data of a matching program title (channel 3, Mystery of Africa) 422 from the program information data column (FIG. 22) of the received program information memory 64. Then, as the 1st data 442 of the data column (FIG. 23) in the synthesized program information memory 48, “channel 3” is stored in the own channel number column 450 and “channel 3” is stored in the partner channel number column 451.

Then the 2nd data (channel 4, Seriousness) 403 of the program information data column (FIG. 21) in the transmitted program information memory 56 are referenced, and in case of absence of data of a matching program title in the program information data column (FIG. 22) of the received program information memory 64, as the 2nd data 443 of the data column (FIG. 23) in the synthesized program information memory 48, “channel 4” is stored in the own channel number column 452 and “0” indicating “station unselectable” is stored in the partner channel number column 453.

Thereafter, a similar process is conducted. As a result, a program information data column as shown in FIG. 23 is prepared and stored in the synthesized program information memory 58.

A synthesizing process (S416) of the TV receiver 10b is basically similar to that explained above. The TV receiver 10b prepares a program information data column shown in FIG. 24 and different from the program information data column in the synthesized program information memory 58 of the TV receiver 10b and stores in the synthesized program information memory 58.

Now, let us consider a case where the user actuates a key “8” of the numeral keys 38 in the remote control 22a of the TV receiver 10a (S419). The TV receiver 10a, based on the program information data column (FIG. 23) of the synthesized program information memory 58, refers to 4th data 445 in which the own channel number column indicates the channel 8. As the corresponding partner channel number column 457 is not “0”, the TV receiver 10a judges that the station is selectable (S420) and transmits the content “channel 1” of the partner change number column 457 to the TV receiver 10b (S421). Then the signal processor 44 is caused to select a channel corresponding the value “channel 8” of the own channel number column 456 (S422).

The TV receiver 10b, receiving the channel number “channel 1” through the communication portion 62, causes the signal processor 44 to select such channel “channel 1” (S423). In this state, the TV broadcast program display area 18a of the TV receiver 10a displays a program “Cosmetic Beauty” of a channel 8, and the TV broadcast program display area 18b of the TV receiver 10b displays a program “Cosmetic Beauty” of a channel 1, as shown in FIG. 26.

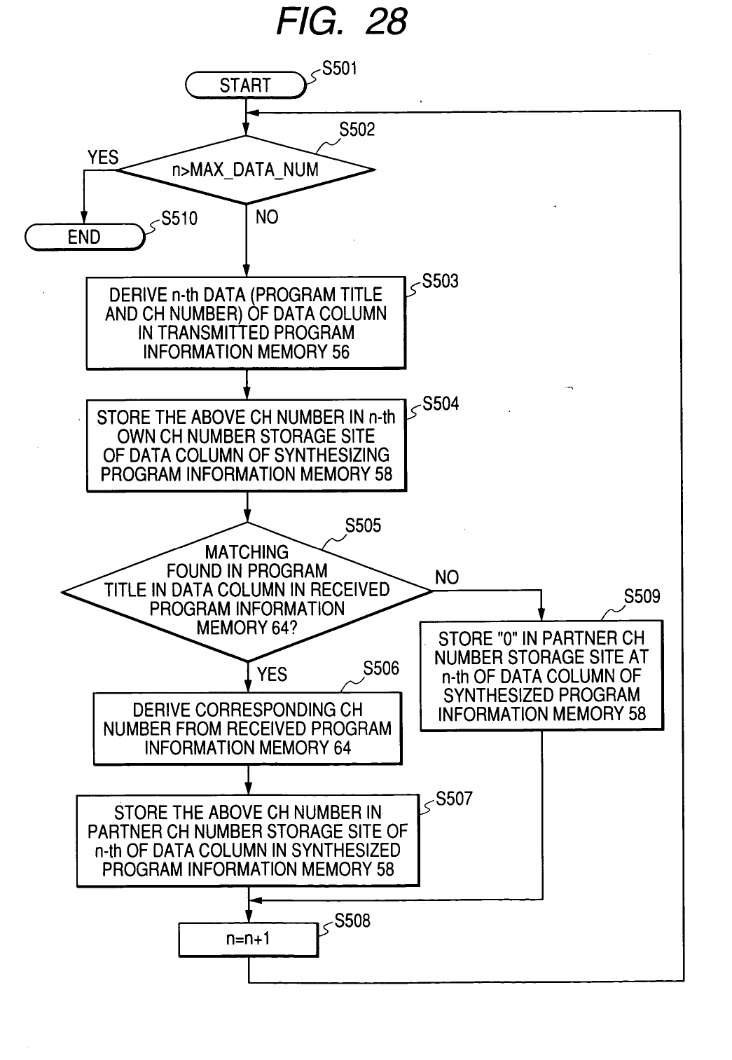

Then, let us consider a case where the user actuates a key “5” of the numeral keys 38 in the remote control 506 of the TV receiver B504 (S424). The TV receiver 10b, based on the program information data column (FIG. 24) of the synthesized program information memory 58, refers to 2nd data 473 in which the own channel number column indicates the channel 5. As the partner channel number column 483 corresponding to the data 473 is “0”, the TV receiver 10b judges that the station is unselectable (S425), thus not executing a station selecting operation, and outputs a control signal indicating an unselectable station (signal instructing the video synthesizer to display a dialog presenting information “station unselectable”). Based on such control signal, the video synthesizer 50 executes a process (S426) of synthesizing and displaying a dialog “station unselectable”. Thus the TV broadcast program viewing area 18b of the TV receiver 10b displays a dialog station unselectable” 24b as shown in FIG. 28. The process of the steps S401-S415 and S427-S439 is similar to that in the embodiment 1. Also, instead of the configuration of informing the user of a program not selectable in the partner receiver (a program for which the common selection is not possible) by displaying an alarm image such as a dialog “not selectable”, there can also be adopted a configuration of executing such information by an audio signal such as an alarm sound or by an alarm lamp.

The TV receiver 10b, receiving the channel number “channel 1” through the communication portion 62, causes the signal processor 44 to select such channel “channel 1” (S423). In this state, the TV broadcast program display area 18a of the TV receiver 10a displays a program “Cosmetic Beauty” of a channel 8, and the TV broadcast program display area 18b of the TV receiver 10b displays a program “Cosmetic Beauty” of a channel 1, as shown in FIG. 26.

FIG. 28 is a flow chart showing a synthesizing process S214, S232 executed by the control portion 74. A data column variable n has an initial value “0”. MAX_DATA_NUM indicates a maximum data number of the program information data column in the transmitted program information memory 56.

There is made a discrimination whether the data column variable n is larger than MAX_DATA_NUM (S502), and, if true, the process is terminated (S510). In case of false, namely in case n is equal to or smaller than MAX_DATA_NUM, a channel number and a program title are extracted from n-th data in the program information data column of the transmitted program information memory 56 (S503).

The channel number extracted in the step S503 is stored in an n-th own channel number column of the program information data column of the synthesized program information memory 58 (S504). Then the program information data column of the received program information memory 64 is sorted to look for data of a matching program title extracted in the step S503 (S505). In the presence of matching data, a channel number is extracted from the matching data of the received program information memory 64 (S506), and is stored in an n-th partner channel number column of the program information data column of the synthesized program information memory 58 (S507).

Then the data column variable n is incremented (S508), and the sequence returns to the step S502 to thereafter repeat a similar process.

In the absence of matching in the step S505, “0” indicating “station unselectable” is stored in an n-th partner channel number column of the program information data column of the synthesized program information memory 58 (S509), and the sequence skip to a step S508. The process thereafter is as explained above.

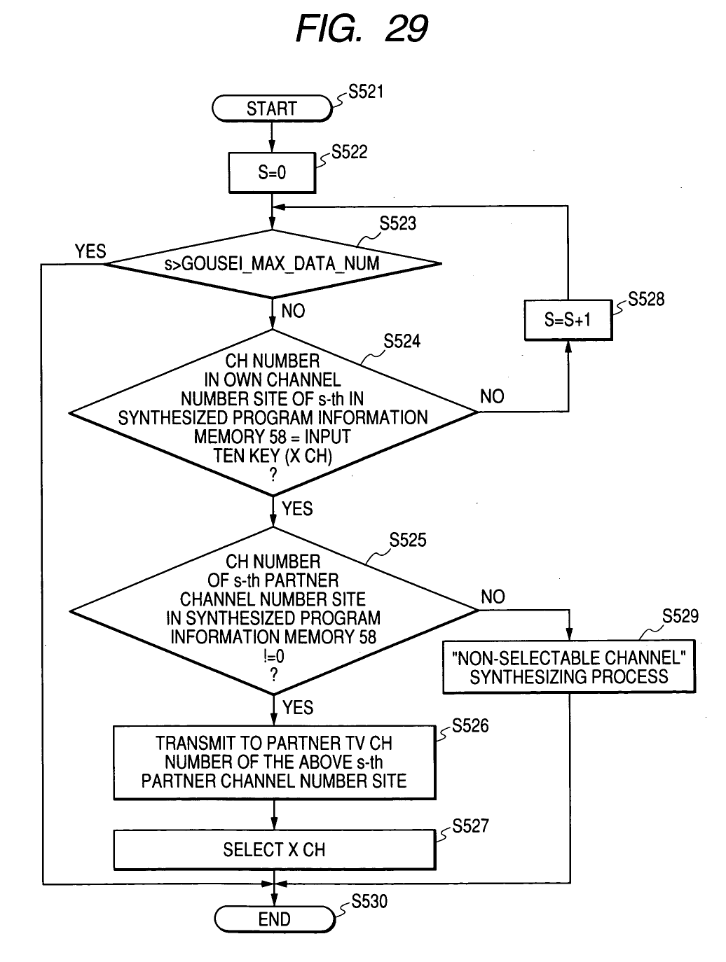

FIG. 29 is a flow chart showing a process executed by the control portion 74 in case the simultaneous viewing start key 34 and then a numeral key 36 are depressed in at least either of the TV receivers.

After a numeral key for a channel X is depressed, the data column variable s is initialized to “0” (S522). There is discriminated whether the data column variable s is larger than GOUSEI_MAX_DATA_NUM (S523), and, if true, the process is terminated (S530). If false, namely in case s is equal to or less than GOUSEI_MAX_DATA_NUM, there is discriminated whether a channel number, stored in an s-th own channel number column of the program information data column of the synthesized program information memory 58 is equal to X (S524).

In case the channel number is not equal to X, the data column variable s is incremented (S528) and sequence returns to the step S523. If equal, there is discriminated whether the channel number stored in the s-th partner channel number column of the program information data column of the synthesized program information memory 58 is “0” indicating “station unselectable” (S525). If not “0”, the channel number stored in the s-th partner channel number column is transmitted through the communication portion 62 to the partner TV receiver (S526). Then the channel X is selected (S527) and the process is terminated (S530).

Also in case the step S525 identifies that the channel number stored in the s-th partner channel number column of the program information data column of the synthesized program information memory 58 is “0”, a dialog “station unselectable” is synthesized and displayed (S529) and the process is terminated (S530).

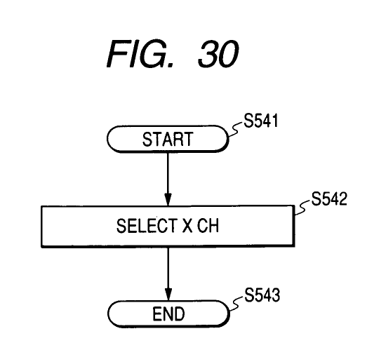

FIG. 30 is a flow chart showing a process executed by the control portion 74 upon receiving a channel number from the communication portion 62. In response to a reception of a channel number X from the communication portion 62, a channel X is selected (S542) and the process is terminated (S543).

The above-described process allows, by a channel selecting operation in either remote control, to switch to and view a same broadcast program in two TV receivers. Thus, even in areas with different combinations of broadcast programs, it is possible to view a same broadcast program without an operation of searching a same program viewable to the users and a remote control operation of selecting such program.

In addition, even in case a broadcast program has different channel numbers in different areas, it is possible to switch to and view the same broadcast program.

Furthermore, it is possible, by a station selecting operation with the numeral keys of the remote control, to switch to and view a same broadcast program according to the broadcast channels of its own area, without any unusual feeling.

### Embodiment 4

In the following an embodiment 4 of the present invention will be explained.

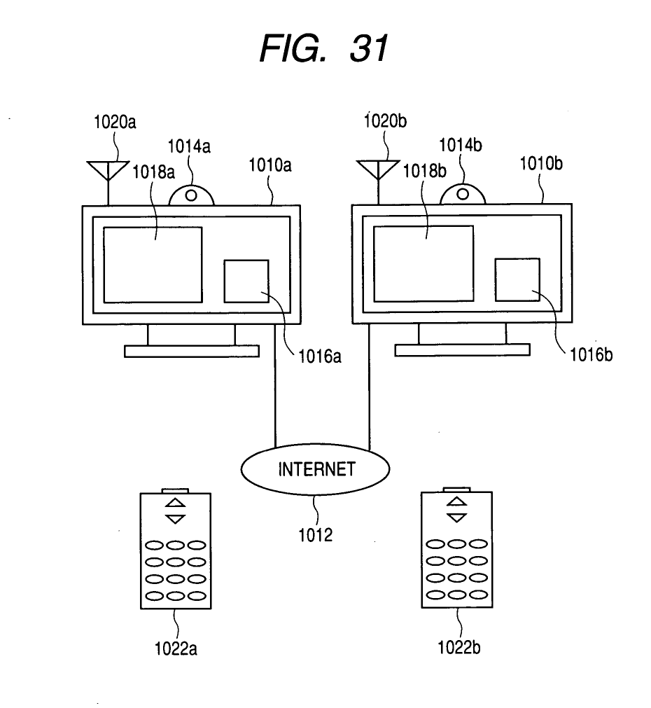

FIG. 31 is a view showing a configuration of a TV receiver system constituting a fourth embodiment of the present invention. TV receivers 1010a, 1010b are mutually connected through an internet 1012. There are shown video cameras 1014a, 1014b for taking images of viewers; sub images 1016a, 1016b for displaying taken images of partner viewers; viewing areas 1018a, 1018b of received TV programs; antennas 1020a, 1020b for receiving TV broadcast waves; and remote controls 1022a, 1022b for switching the viewed TV programs by controlling the TV receivers 1010a, 1010b.

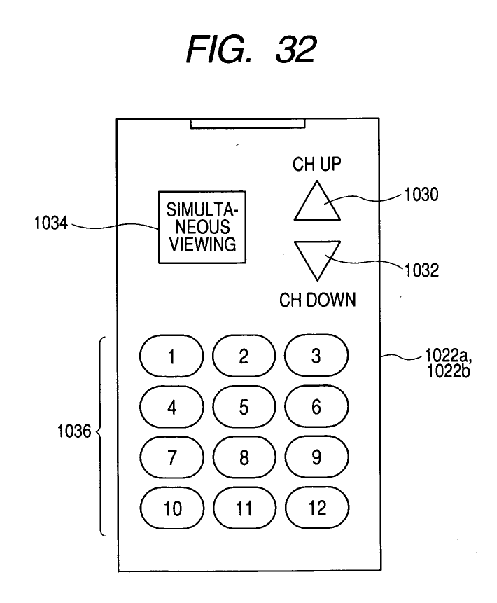

FIG. 32 is a plan view of a remote control 1022a or 1022b, provided with a channel up key 1030, a channel down key 1032, a simultaneous viewing start key 1034 and numeral keys 1036.

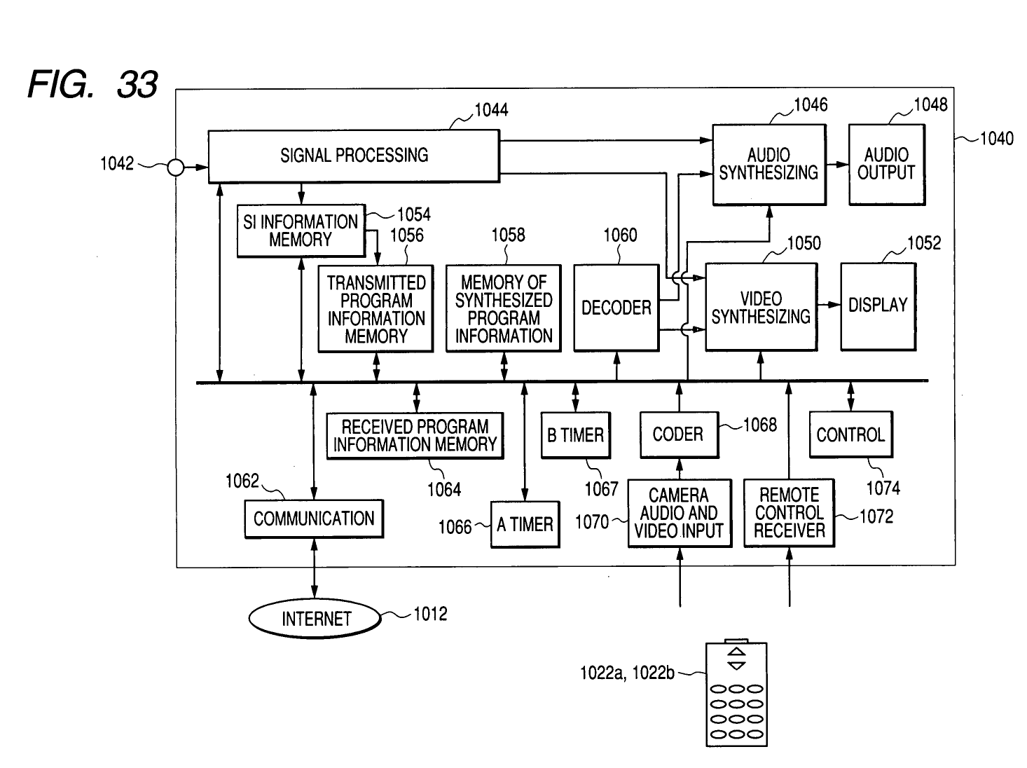

FIG. 33 shows an internal structure of the TV receiver 1010a or 1010b. A main body 1040 of the TV receiver 1010a, or 1010b is provided with an antenna terminal 1042, to which the antenna 1020a or 1020b is connected. A broadcast station outputs a broadcast signal which encodes and multiplexes video information, audio information and SI (service information) (described in “program arrangement information used in digital broadcasting” of ARIB STD-B10). One of the SI is a program arrangement information called EIT (event information table) and describing program information for each channel, and there are described information relating to the program, such as a channel number, a program title and a date and time of broadcasting.

The broadcast signal outputted from the broadcasting station is received by the antenna 1020a, 1020b and supplied through the antenna terminal 1042 to a signal processor 1044. The signal processor 1044, after decoding the video information and the audio information from the broadcast signal supplied from the antenna terminal 1042 under an instruction of a control portion 1074, outputs video data and audio data respectively to a video synthesizer 1050 and an audio synthesizer 1046. The signal processor 1044 extracts SI information out of the broadcast signal from the antenna terminal 1042, and outputs SI from time to time to an SI memory 1054. The SI memory 1054 stores the SI information from the signal processor 1044.

The video synthesizer 1050 executes a synthesizing process so as to display plural input video information on plural images, and outputs it to a display 1052. The audio synthesizer 1046 switches or synthesizes plural input audio information for supply to an audio output portion 1048.

The display 1052 displays the input video information as an image. The audio output 1048 outputs the input audio information to the exterior.

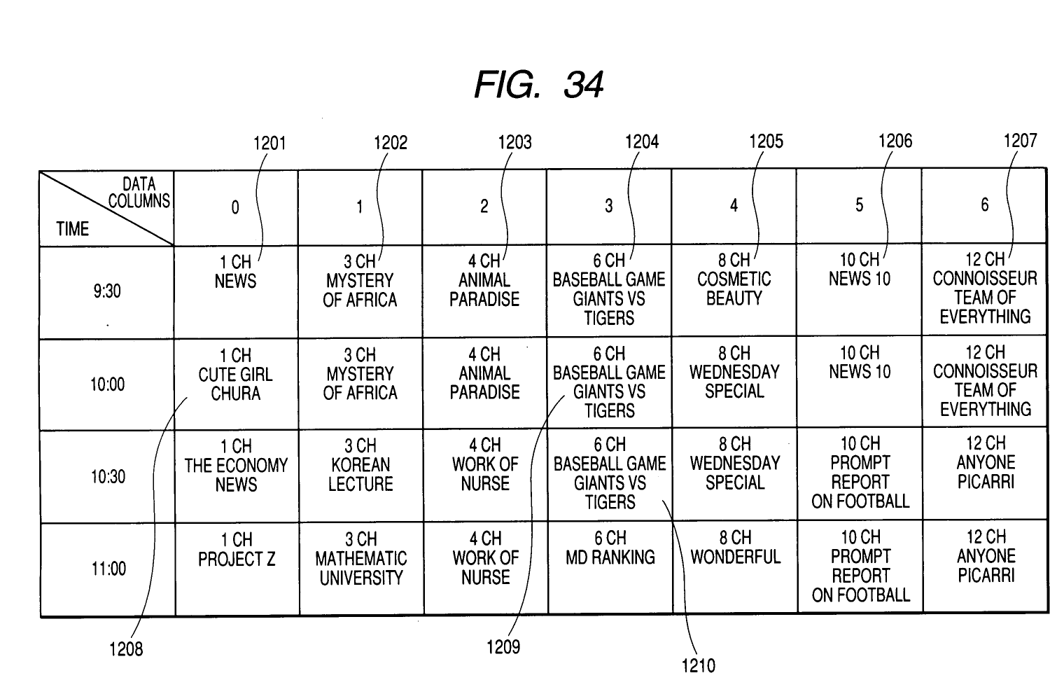

A transmitted program memory 1056 stores, under an instruction of the control portion 1074, program information (channel number and program title) of the EIT stored in the SI memory 1054, as a program information data table in a matrix of a (data column, time) form according to the time and date of broadcasting. An example of the program information data table is shown in FIG. 34. The program information data table is transmitted to the communication portion 1062, under an instruction of the control portion 1074.

A camera video/audio input portion 1070 outputs video and audio taken data to an encoder 1068. The encoder 1068 encodes the input data on real-time basis and outputs encoded data to the communication portion 1062.

The communication portion 1062 transmits the encoded camera video/audio information from the encoder 1068 through the internet 1012 to a partner TV receiver, and outputs the encoded camera video/audio information, received from the partner TV receiver through the internet 1012, to the decoder 1060.

Also the communication portion 1062, under an instruction from the control portion 1074, transmits a request for deriving program information to the partner TV receiver through the internet 1012, and outputs a program information deriving request, received from the partner TV receiver through the internet 1012, to the control portion 1074.

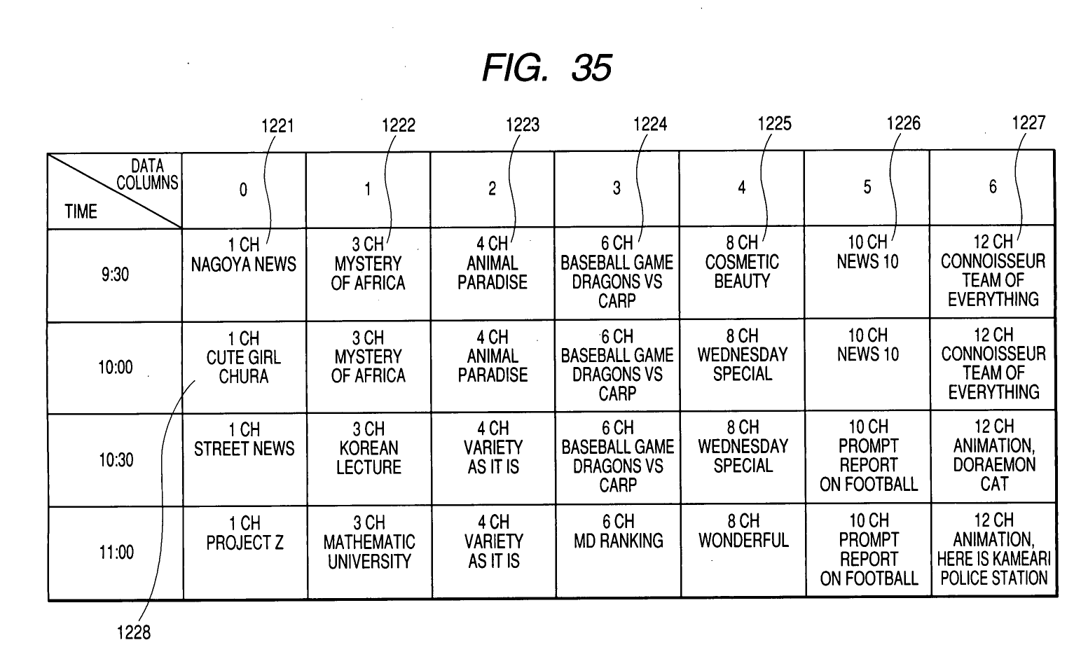

Also the communication portion 1062, under an instruction from the control portion 1074, transmits a program information data table (FIG. 34), stored in the transmitted program information memory 1056, to the partner TV receiver through the internet 1012, and outputs a program information data table as shown in FIG. 35, received from the partner TV receiver through the internet 1012, to the received program information memory 1064.

Also the communication portion 1062, under an instruction from the control portion 1074, transmits a program information deriving start signal and a synthesizing process start signal to the partner TV receiver through the internet 1012, and outputs signals, received from the partner TV receiver through the internet 1012, to the control portion 1074.

The decoder 1060 decodes encoded data of the video/audio information of video camera entered from the communication portion 1062 on real-time basis, for supply to the video synthesizer 1060.

The received program information memory 1064 stores the program information data table entered from the communication portion 1062. The program information data table has, as shown in FIG. 35 and as in the data table stored in the transmitted program information memory 1056, a structure in which the channel number and the program title are arrange in a (data column, time) coordinate system.

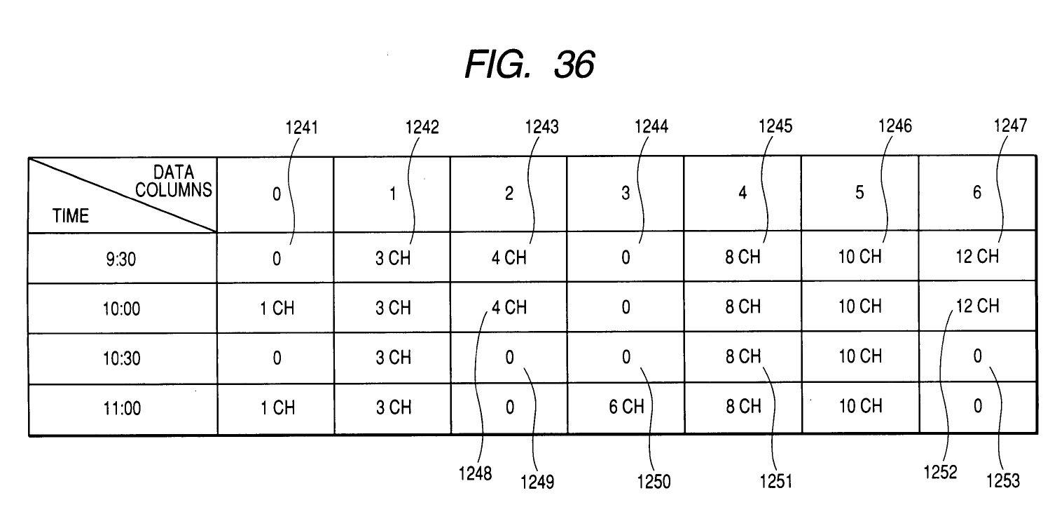

A synthesized program information memory 1058 synthesizes, under an instruction from the control portion 1074, the program information data table stored in the transmitted program information memory 1058 and the program information data table stored in the received program information memory 1064 to form and store a program information data table as shown in FIG. 36. Details of the synthesizing process will be explained later.

An A-timer 1066 is used for starting a synthesizing process, and, when a timer value specific to the TV receiver elapses after the start of time measurement, terminates the time measurement and informs the control portion 1074 of a timer end.

A B-timer 1067 is used in an auto station selecting process. The B-timer 1067 incorporates a clock, and informs the control portion 1074 of a time lapse and its time (hour and minute) at every 30 minutes which are equal to a unit of time axis of the program information data table. The auto station selecting process will be explained later.

A remote control receiver 1072, upon receiving a depression signal of the simultaneous viewing start key 1034 for the first time after the power supply is turned on, informs the control portion 1074 of a simultaneous viewing start request.

The functions of the control portion 1074 will be explained in detail. Upon receiving a simultaneous viewing start request from the remote control reception portion 1072 or a timer end notice from the A-timer 1066, the control portion 1074 transmits a master candidate request to a partner TV receiver through the communication portion 1062. The control portion 1074 transmits a program information deriving request to the partner TV receiver, and, in response, obtains a program information data table as shown in FIG. 35 and stores it in the received program information memory 1064. Also upon receiving a program information deriving request from the partner TV receiver through the communication portion 1062, the control portion 1074 prepares, from the SI memory 1054, a program information data table as shown in FIG. 34 in which the channel number and the program title in the EIT are arranged in a (table column, time) matrix, outputs it to the transmitted program information memory 1056 and returns it to the partner TV receiver through the communication portion 1062. Also the partner TV receiver executes a similar process and returns the program information data table as shown in FIG. 35.

In the program information data table, the channel numbers are arranged in an increasing order along a data column axis, and the broadcast times are arrange in an increasing order along a time axis. In case a program is in excess of 30 minutes as in data 1204, 1209, 1210 in FIG. 34, such program is arranged as plural data corresponding to the broadcast time. The present embodiment employs a unit of 30 minutes, but another unit may also be adopted.

The control portion 1074 extracts, from the program information data table of FIG. 34 stored in the transmitted program information memory 1056 and the program information data table of FIG. 35 stored in the received program information memory 1064, program information data with matching channel number and program title to prepare a program information data table as shown in FIG. 36, and stores it in the synthesized program information memory 1058.

The control portion 1074 integrally controls the communication portion 1062, the signal processor 1044, the SI memory 1054, the video synthesizer 1050, the audio synthesizer 1046, the transmitted program information memory 1056, the decoder 1060, the received program information memory 1064, the synthesized program information memory 1058, and the A-timer 1066.

Now reference is made to FIGS. 34 to 37 for explaining a process sequence between the TV receivers 1010a and 1010b in the fourth embodiment.

When the user depresses the simultaneous viewing start key 1034 of the remote control 1022a of the TV receiver 1010a for the first time after the power supply is turned on (S1101), the TV receiver 1010a starts the timer 1066 (S1102) and at the same time transmits a master candidate request, for becoming a master of the program information process, to the TV receiver 1010b (S1103). The TV receiver 1010b returns an OK response (S104_2). Receiving the OK response, the TV receiver 1010a sets a master flag, indicating the master, at “1” (S105_2). In both TV receivers 1010a, 1010b, an initial state of the master flag is “0”.

In case a user thereafter depresses the simultaneous viewing start key 1034 of the TV receiver 1010b (S1106), the TV receiver 1010b likewise starts the timer 1066 (S1107) and transmits a master candidate request (S1108). The TV receiver 1010a returns an NG response since its master flag is already at “1” (S1109).

The TV receiver 1010a, having received the OK response in S1104, transmits a program information deriving request to the TV receiver 1010b (S1110). The TV receiver 1010b constructs a program information data table as shown in FIG. 35 from the SI information stored in the SI memory 1054 and returns it to the TV receiver 1010a (S1111).

Then the TV receiver 1010a informs the TV receiver 1010b of a program information deriving start signal requesting a transmission of a program information deriving request (S1112). In response to this signal, the TV receiver 1010b transmits a program information deriving request to the TV receiver 1010a (S1113), and the TV receiver 1010a similarly constructs a program information data table and transmits it to the TV receiver 1010b (S1114).

Then the TV receiver 1010a transmits a synthesizing process start signal to the TV receiver 1010b (S1115) and starts a synthesizing process (S1116). Also the TV receiver 1010b receiving the synthesizing process start signal starts a synthesizing process (S1118).

In the synthesizing process (S1116) in the TV receiver 1010a, for example at a current time of 9:40, a reference is made, on a program information data table of the transmitted program information memory 1056 as shown in FIG. 34, on the data “channel 1, News” 1201 at a coordinate (0, 9:30) to investigate whether data with matching channel number and program title are present at a coordinate (x, 9:30) in the program information data table of FIG. 35 stored in the received program information memory 1064. In case of absence of data with matching channel number and program title, “0” is substituted in data 1241 at a coordinate (0, 9:30) in the program information data table in the synthesized program information memory 1058, as shown in FIG. 36.

Then a similar sorting is executed by referring to the data (channel 3, Mystery of Africa) 1202 at a coordinate (1, 9:30) which is incremented by a unit along the data column axis in the program information data table (FIG. 34) in the transmitted program information memory 1056, whereby data (channel 3, Mystery of Africa) 1222 at a coordinate (1, 9:30) with matching channel number and program title are extracted from the program information data table of FIG. 35, and a channel number “channel 3” is substituted in data 1242 at the coordinate (1, 9:30) in the program information data table of the synthesized program information memory 1058.

Thereafter a similar process is executed. As a result, channel numbers are stored for the data with matching channel number and program title, namely data (channel 4, Animal Paradise), (channel 8, Cosmetic Bearty), (channel 10, News 10) and (channel 12, Connoisseur Team of Everything) in the cells 1243-1247 of the program information data table (FIG. 36) of the synthesized program information memory 1058, and “0” is stored for the unmatching data.

Then a similar process is repeated by referring to the data (channel 1, Cute Girl Chura) 1208 at a coordinate (1, 10:00) which is incremented by a unit along the time axis in the program information data table (FIG. 34) in the transmitted program information memory 1056, and a channel number for matching data or “0” for unmatching data are stored in the program information data table (FIG. 36) in the synthesized program information memory 1058. In this manner the program information data table (FIG. 36) is completed.

Though the program information data tables shown in FIGS. 34, 35 and 36 only indicate a time axis from 9:30 to 11:00, but data outside this range can naturally be also included. In the present embodiment, the program information data table is constructed in an increasing order of the channel number along the data column axis, but it may also be constructed with another order.

A synthesizing process (S1118) is similarly executed in the TV receiver 1010b, whereby a program information data table as shown in FIG. 36 and same as that in the synthesized program information memory 1058 of the TV receiver 1010a is stored in the synthesized program information memory 1058 of the TV receiver 1010b. The transmitted program information memory 1056 of the TV receiver 1010b stores the program information data table shown in FIG. 34, and the received program information memory 1064 stores the program information data table shown in FIG. 35.

Then the TV receiver 1010a shifts the master flag to “0” (S1117) in order to indicate that the master for the program information process is abandoned.

Thereafter, upon receiving a timer end notice from the A-timer 1066 (S1119), the TV receiver 1010a again starts the A-timer 1066 (S1120), then transmits a master candidate request for becoming the master to the partner TV receiver 1010b (S1121) and thereafter repeats a similar procedure (S1122-S1132). The TV receivers 1010a and 1010b may have mutually different timer values.

Now there will be explained, with reference to FIGS. 36, 38 and 39, an auto station selecting process of the TV receivers 1010a, 1010b when the same program viewed in both the TV receivers 1010a, 1010b reaches a broadcast end time. Such auto station selecting process becomes executable after the aforementioned synthesizing process.

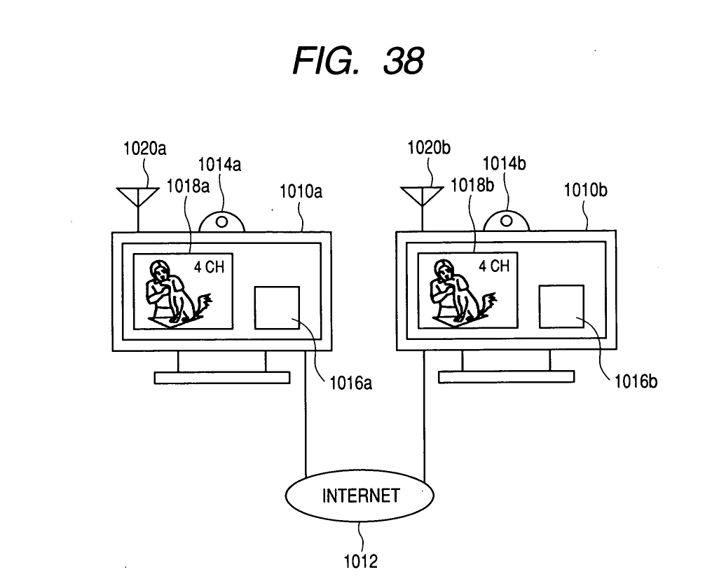

Let us assume a situation where, at a current time 9:40, the viewers of the TV receivers 1010a, 1010b view “channel 4, Animal Paradise”, and the TV broadcast viewing areas 1018a, 1018b display the program “Animal Paradise” as shown in FIG. 38. In this state, the TV receivers 1010a, 1010b refer to data 1243 at the coordinate (2, 9:30) in the program information data table (FIG. 36) of the synthesized program information memory 1058.

Thereafter, when a time 10:00 is informed from the B-timer 1067, reference is made to data 1248 at a coordinate (2, 10:00). Also when a time 10:30 is informed from the B-timer 1067, reference is made to data 1249 at a coordinate (2, 10:30).

Data 1249 store “0” indicating that at least either of the channel number and the program title does not match between the TV receivers 1010a and 1010b. In such case, an increment is made by a unit along the data column axis to refer to data 1250 at a coordinate (4, 10:30). As the data 1250 similarly store “0”, an increment is made again by a unit along the data column axis to refer to data 1251 at a coordinate (5, 10:30). As the data 1251 does not store “0” but a channel number “channel 8”, and, in this case, the signal processor 1044 selects the channel number “8”.

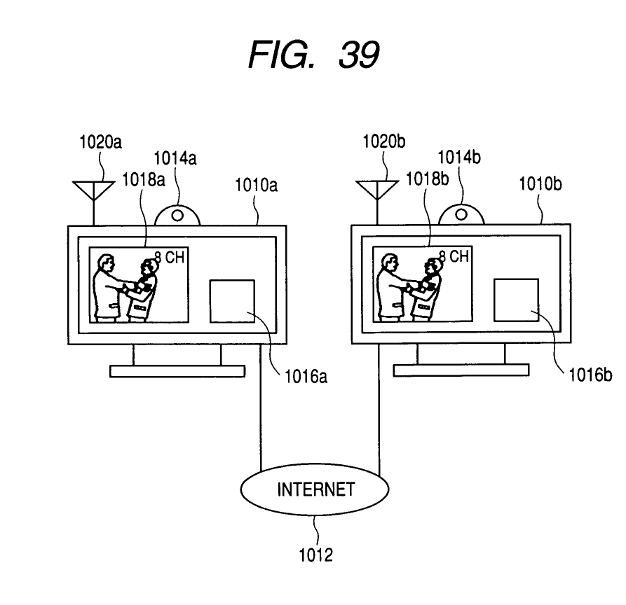

Through the aforementioned process, the TV receivers 1010a, 1010b select and display a same program “Wednesday Special” of the channel 8 on the TV broadcast program viewing areas 1018a, 1018b as shown in FIG. 39.

At a current time 10:10 when the viewers of the TV receivers 1010a, 1010b view “channel 12, Connoisseur Team on Everything”, reference is made to data 1252 at a coordinate (6, 10:00) of the synthesized program information memory 1058, and, when a time 10:30 is informed thereafter from the B-timer 1067, an increment is made by a unit along the time axis as explained above to refer to data 1253 at a coordinate (6, 10:30).

Since data 1253 store “0” indicating that at least either of the channel number and the program title does not match between the TV receivers 1010a and 1010b, also since the data column number has reached a maximum value, reference is made to data 1254 at a coordinate (0, 10:30) at the data column number 0. Thereafter a similar process as explained above is executed.

It is also possible, prior to the station selection, to execute a process of extracting the information of all the programs allowing simultaneous viewing at the current time from the program information data table in the synthesized program information memory 1058 and outputting a list allowing to view such program information to the display 1052.

In the foregoing it is assumed that both the TV receivers 1010a and 1010b execute the automatic station selection, but there can also be adopted a configuration where one only of the TV receivers executes the automatic station selection and transmits selection information to the connected other TV receiver which executes a station selecting process according to the received selection information.

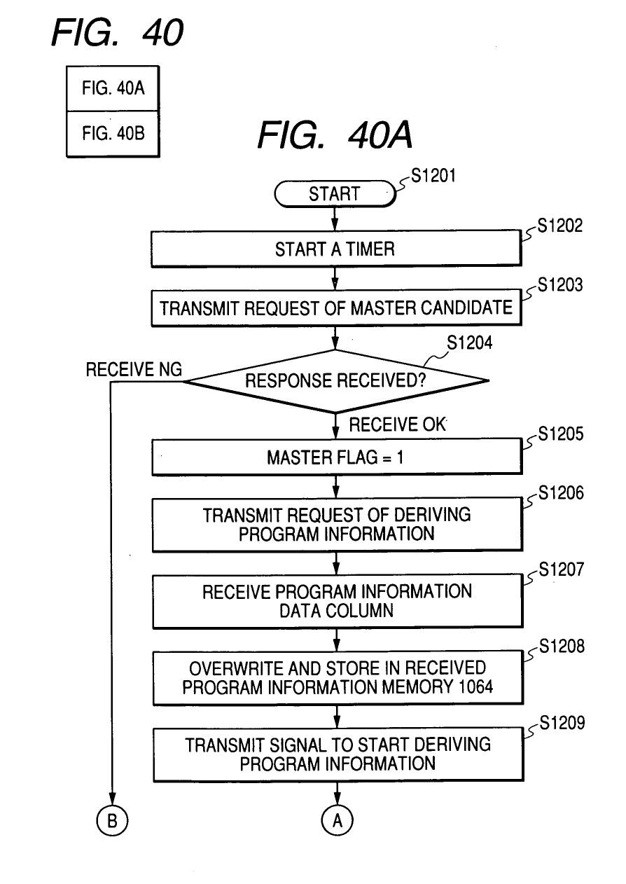

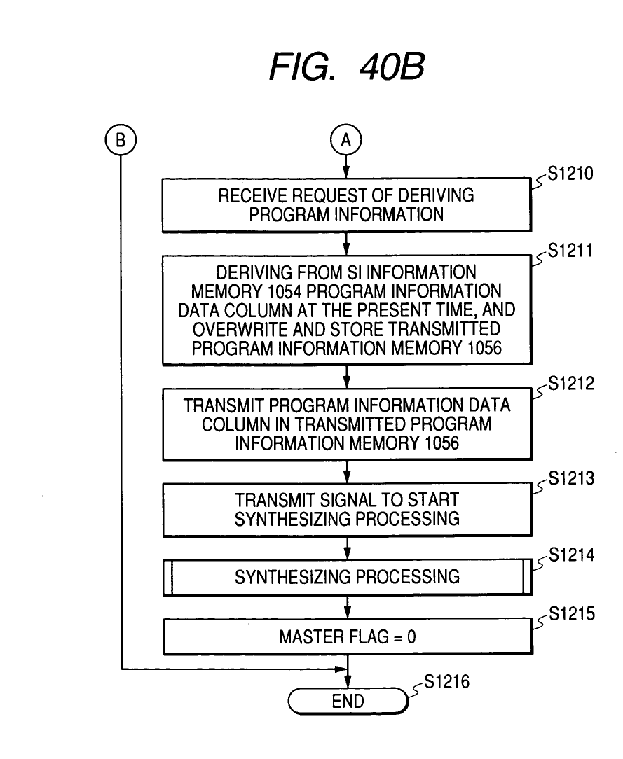

FIGS. 40A and 40B are flow charts showing a process of the control portion 1074 of the TV receivers 1010a, 1010b in case the user depresses the simultaneous viewing start key 1034 for the first time after the power supply is turned on or a timer end notice is received from the timer 1066.

In response to a simultaneous viewing start request from the remote control receiving portion 1072 or a timer end notice from the timer 1066, the TV receiver 1010a starts a time measurement by the timer 1066 (S1202) and transmits a master candidate request to the partner TV receiver (S1203). Thereafter it receives a response from the partner TV receiver (S1204). In case of an NG response, the sequence is terminated (S1216). In case of an OK response, the TV receiver 1010a sets the master flag at “1” (S205) and transmits a program information deriving request to the partner TV receiver (S1206). Upon receiving a program information data table from the partner TV receiver (S1207), the TV receiver 1010a overwrites the received program information memory 1064 with such program information data table (S1208).

Then the TV receiver 1010a transmits a program information deriving start signal to the TV receiver 1010b (S1209). Upon receiving a program information deriving request from the partner TV receiver 1010b (S1210), the TV receiver 1010a extracts a program information data table currently broadcasted from the SI memory 1054, and overwrites the transmitted program information memory 1056 (S1211).

The TV receiver 1010a transmits the program information data stable stored in the transmitted program information memory 1056 to the TV receiver 1010b (S1212). Then the TV receiver 1010a transmits a synthesizing process start signal to the partner TV receiver 1010b (S1213) and initiates a synthesizing process to be explained later (S1214). Thereafter the TV receiver 1010a returns the master flag to “0” and terminates the process (S1215).

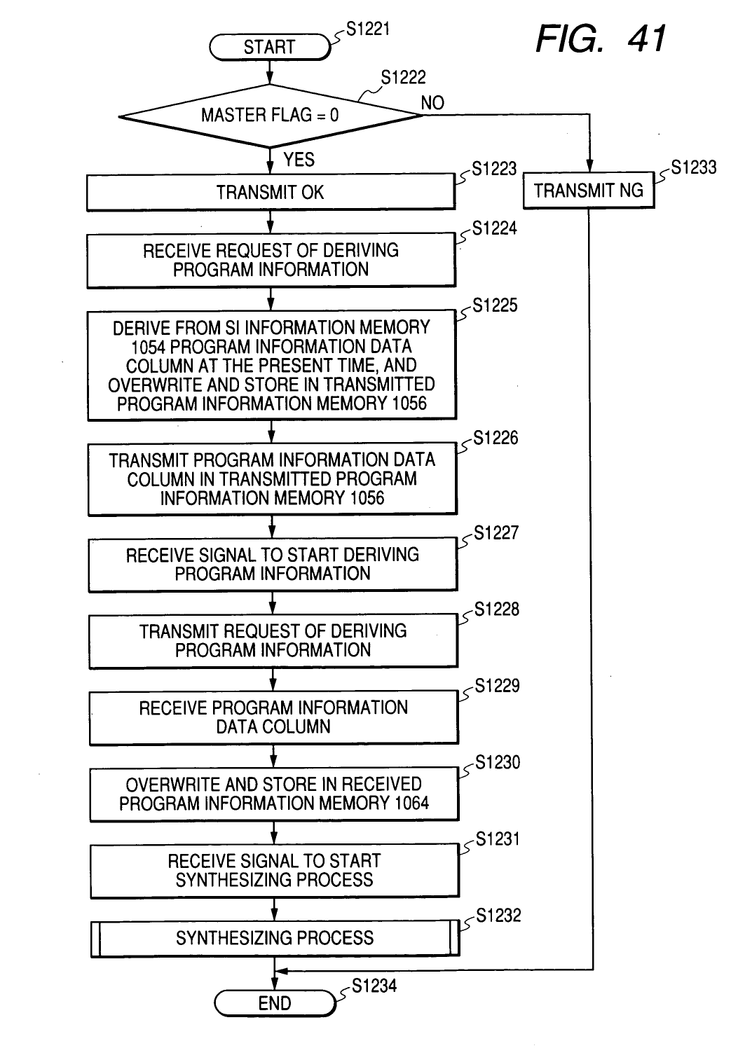

FIG. 41 is a flow chart showing a process executed by the control portion 1074 of the TV receivers 1010a, 1010b after receiving the master candidate request.

After receiving the master candidate request from the partner TV receiver, there is discriminated whether the master flag is “0” (S1222). If false, namely if the master flag is “1”, an NG response is returned (S1233) and the process is terminated. If true, namely if the master flag is “0”, an OK response is returned (S1223).

Then, upon receiving a program information deriving request from the partner TV receiver (S1224), the TV receiver extracts a program information data table currently broadcasted from the SI memory 1054, and overwrites the transmitted program information memory 1056 (S1225). Then the TV receiver transmits the program information data table stored in the transmitted program information memory 1056 to the partner TV receiver (S1226).

Upon receiving a program information deriving start signal from the partner TV receiver (S1227), the TV receiver transmits a program information deriving request to the partner TV receiver (S1228). Thereafter it receives a program information data table from the partner TV receiver (S1229) and overwrites the received program information memory 1064 (S1230).

When a synthesizing process start signal is received from the partner TV receiver (S1231), a synthesizing process to be explained in steps S1116 and S1118 is initiated (S1232) whereupon the process is terminated (S1234).

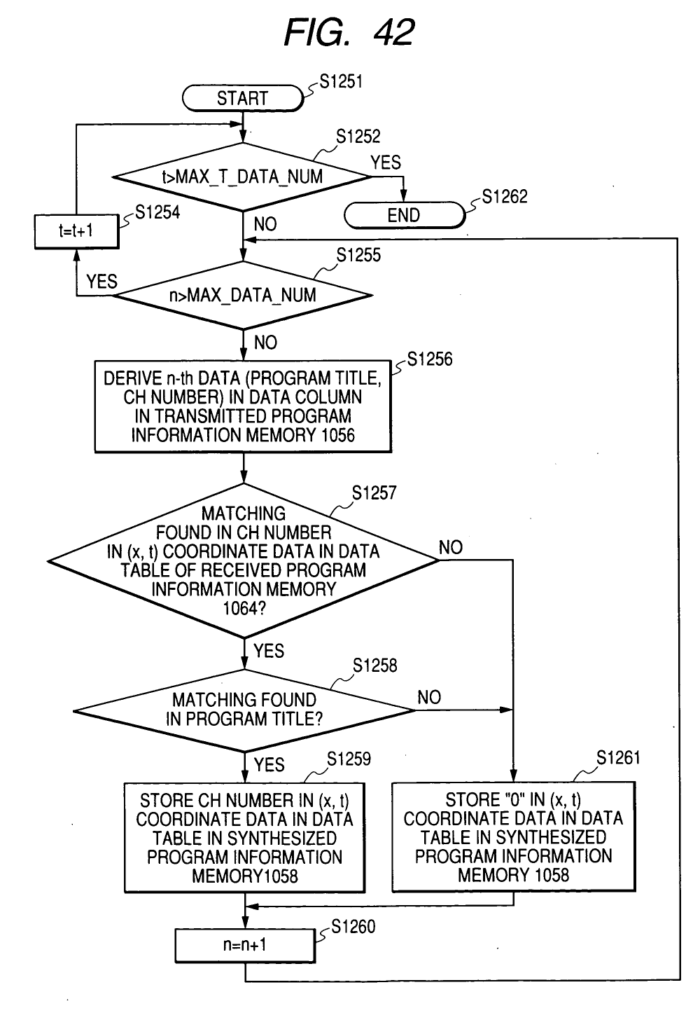

FIG. 42 is a flow chart showing a synthesizing process S1116, S1118 executed by the control portion 1074.

There is discriminated whether a time variable t, having an initial value “0”, is larger than MAX_T_DATA_NUM which is a maximum data column number, in the time axis, of the program information data table in the transmitted program information memory 1056 (S1252). The data numbers of the program information data table along the time axis are assumed to be assigned from 0. If false, namely in case t is equal to or smaller than MAX_T_DATA_NUM, there is discriminated whether a data column variable n, having an initial value “0”, is larger than MAX_DATA_NUM which is a maximum data column number, along the data column axis (S1255). If true, the time variable t is incremented (S1254) and the sequence returns to the step S1252. If false, namely in case n is equal to or smaller than MAX_DATA_NUM, a channel number and a program title are extracted from data at a coordinate (n, t) in the program information data table of the transmitted program information memory 1056 (S1256).

Then data at the coordinate (x, t) of the program information data table in the received program information memory 1064 are sorted and there is discriminated whether program information data of a matching channel number are present (S1257). “x” is an arbitrary number. If false, namely in case of absence of matching data, “0” is stored in the data at the coordinate (n, t) of the program information data table in the synthesized program information memory 1058 (S1261), whereupon the sequence skips to a step S1260.

If true in the step S1257, namely in case of the presence of matching data, there is discriminated whether the program titles in the data at both coordinates (n, t) mutually match (S1258). If false, namely in case of absence of matching data, “0” is stored in the data at the coordinate (n, t) of the program information data table in the synthesized program information memory 1058 (S1261), whereupon the sequence skips to a step S1260.

If true in the step S1258, namely in case of matching in the program title, the channel number extracted in the step S1256 is stored in the data of the coordinate (n, t) of the program information data table in the synthesized program information memory 1058 (S1259), then the data column variable n is incremented (S1260) and the sequence returns to the step S1255 to repeat the aforementioned process.

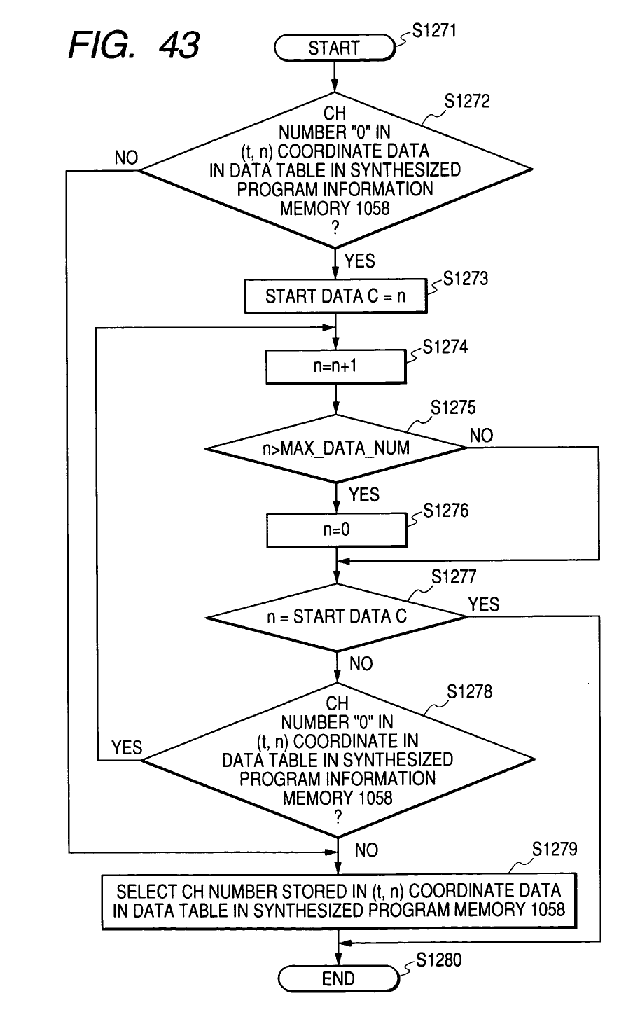

FIG. 43 is a flow chart showing an auto station selecting process of the TV receivers to be started, after receiving a time lapse (time) notice from the B-timer 1067, and after an increment, by a unit along the time axis, of the referenced point in the program information data table in the synthesized program information memory 1058.

There is discriminated whether the referenced data at a coordinate (n, t) of the program information data table in the synthesized program information memory 1058 is “0” (S1272). If false, the process skips to a step S1280. If true, a currently referenced value of the data column variable n is memorized as starting data C (S1273), then n is incremented (S1274), and there is discriminated whether n is larger than a maximum data column number MAX_DATA_NUM along the data column axis (S1275). If false, the process skips to a step S1277. If true, “0” is substituted in n (S1276), and there is discriminated whether n is equal to the starting data C (S1277). If true, the process is terminated (S1280), and, if false, there is discriminated whether the data at a coordinate (n, t) of the program information data table in the synthesized program information memory 1058 is “0” (S1278). If true, the sequence returns to the n incrementing step (S1274), but, if false, a channel number stored in the data at the coordinate (n, t) of the program information data table is selected (S1279), whereupon the process is terminated (S1280).

Through the aforementioned process, the TV receivers 1010a, 1010b can detect that, after a TV program commonly viewed is terminated, they can no longer view a common TV program in the same channel. It is made possible to look for another TV program that can be commonly viewed by both and to automatically switch to such TV program. Thus, when a commonly viewed TV program is terminated and a common viewing becomes no longer possible between areas different for example in the channel number of the program as in a ground wave broadcasting, it is possible to avoid the trouble in the viewers of manually searching another commonly viewable program.

### Embodiment 5

In the following, an embodiment 5 of the invention will be explained. The embodiment 5 is a modification of the embodiment 4, and is same in portions, that are not explained, to the embodiment 4.

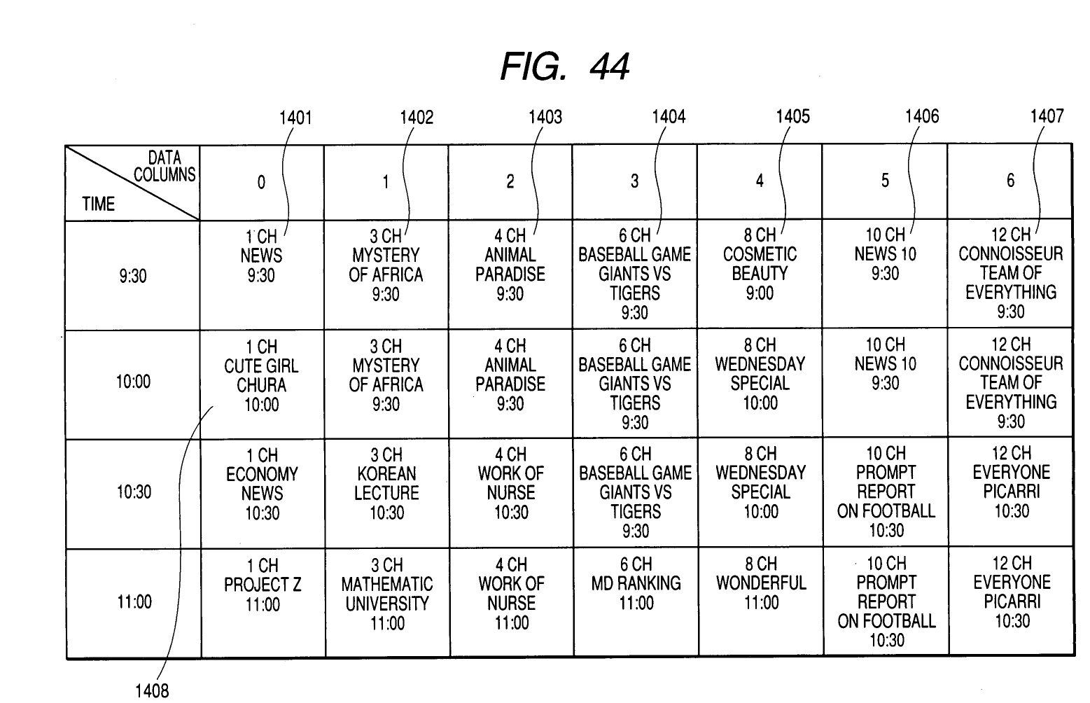

The transmitted program memory 1056 stores, under an instruction of the control portion 1074, a program information data table in a matrix of a (data column, time) form in which the channel number and the program title in the EIT stored in the SI memory 1054 are arranged according to the time and date of broadcasting. An example of the program information data table is shown in FIG. 44.

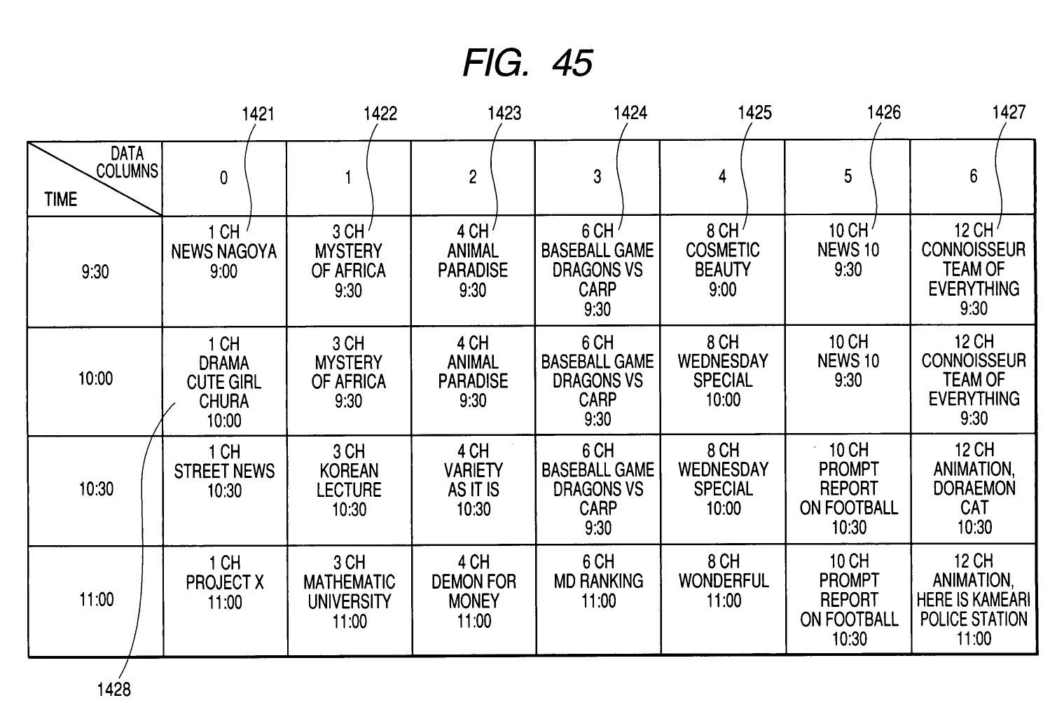

The received program information memory 1064 stores the program information data table as shown in FIG. 45, entered from the communication portion 1062. The program information data table has a same structure as the data table in the transmitted program information memory 1056.

Upon receiving a program information deriving request from the partner TV receiver through the communication portion 1062, the control portion 1074 prepares a program information data table from the current time as shown in FIG. 44 by reading a channel number, a program title and a broadcasting start time in the EIT from the SI information memory 1054 and arranging them in a (table column, time) matrix, and stores the data table in the transmitted program information memory 1056. The control portion 1074 also returns such program information data table to the partner TV receiver through the communication portion 1062.

Also the partner TV receiver executes a similar process and transmits the program information data table as shown in FIG. 45. The program information data table received from the partner TV receiver is stored in the transmitted program information memory 1064.

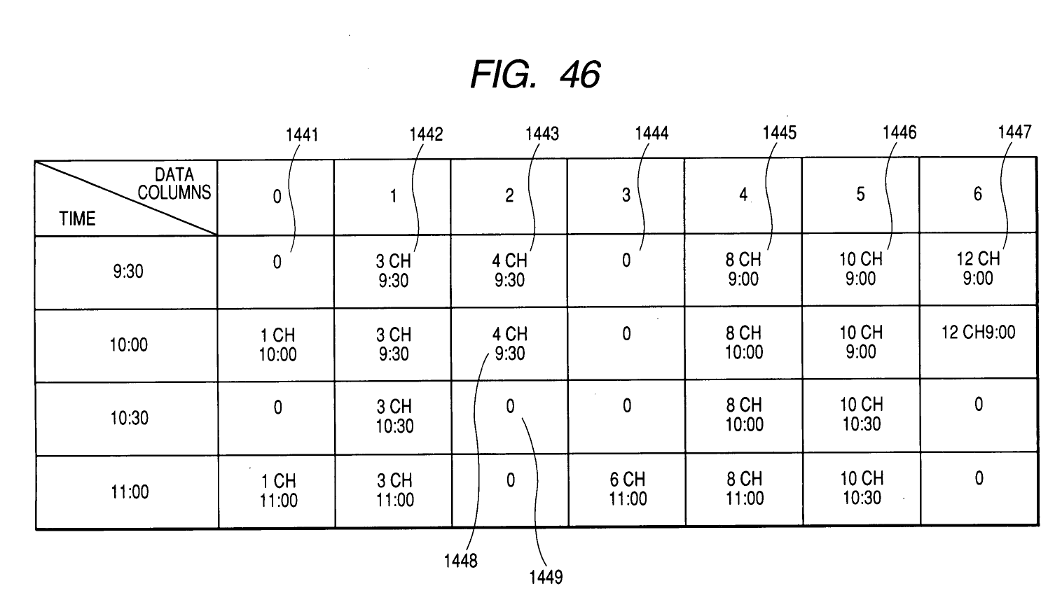

The control portion 1074 extracts, from the program information data table of FIG. 44 stored in the transmitted program information memory 56_2 and the program information data table of FIG. 45 stored in the received program information memory 1064, program information data with matching channel number, program title and broadcasting start time at a same time axis to prepare a program information data table constituted of the channel number and the broadcasting start time as shown in FIG. 46, and stores it in the synthesized program information memory 1058.

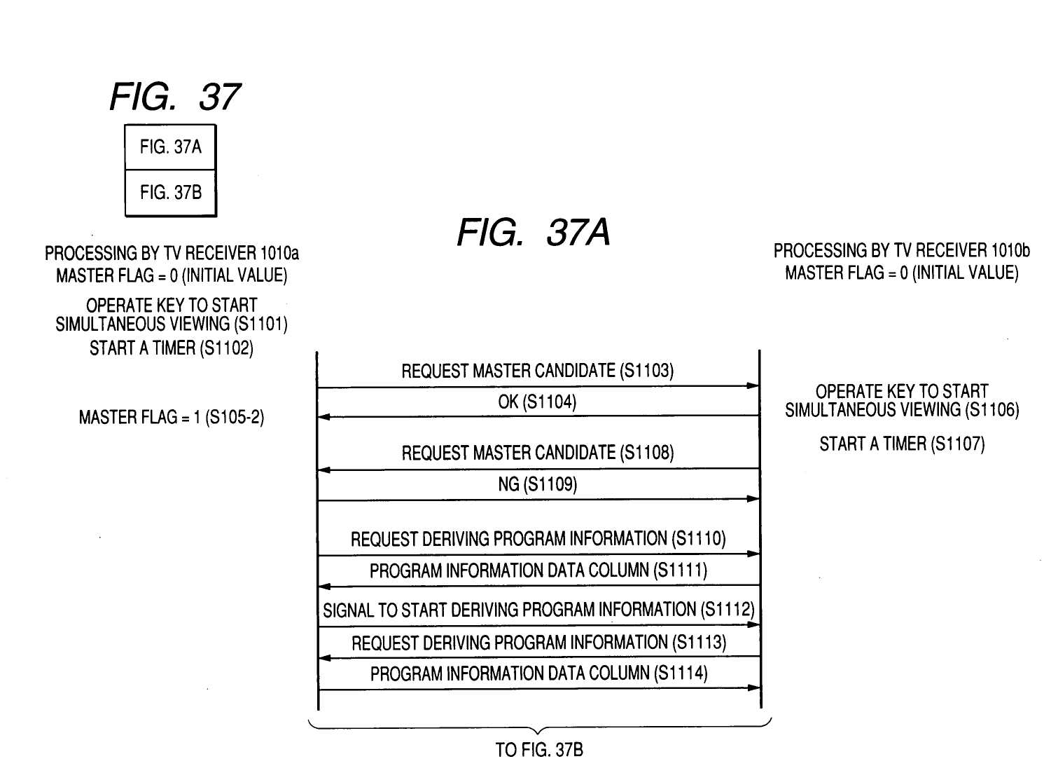

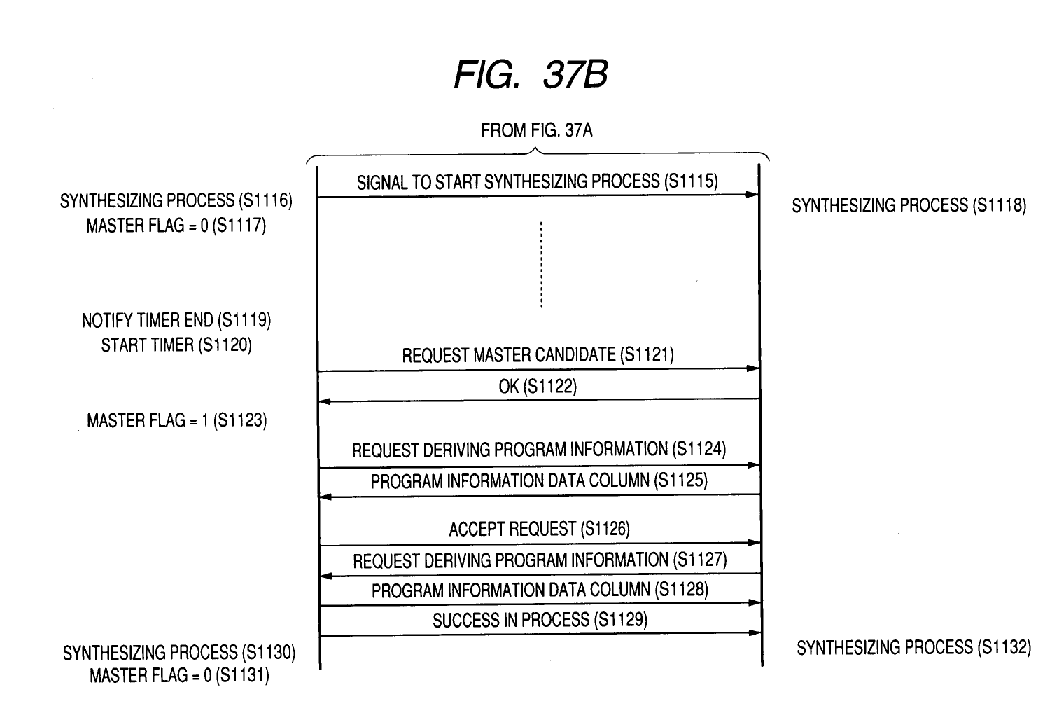

Now there will be explained, with reference to FIGS. 37, 44, 45 and 46, a synthesizing process of the TV receivers 1010a, 1010b.

In the synthesizing process (S1116) in the TV receiver 1010a, for example at a current time of 9:40, a reference is made, on a program information data table (FIG. 44) of the transmitted program information memory 1056, to the data “channel 1, News, 9:30” 1401 at a coordinate (0, 9:30) to investigate whether data with matching channel number, program title and broadcasting start time are present at a coordinate (x, 9:30) in the program information data table (FIG. 45) stored in the received program information memory 1064. In case of absence of data with matching channel number, program title and broadcasting start time, “0” is substituted in data 1441 at a coordinate (0, 9:30) in the program information data table (FIG. 46) in the synthesized program information memory 1058.

Then a similar sorting is executed by referring to the data (channel 3, Mystery of Africa, 9:30 Z) 1402 at a coordinate (1, 9:30) which is incremented by a unit along the data column axis in the program information data table (FIG. 44) in the transmitted program information memory 1056, whereby data (channel 3, Mystery of Africa, 9:30) 1422 at a coordinate (1, 9:30) with matching channel number, program title and broadcasting start time are detected in the program information data table (FIG. 45), and a channel number and a broadcasting start time (channel 3, 9:30) are substituted in data 1442 at the coordinate (1, 9:30) in the program information data table of the synthesized program information memory 1058.

Thereafter a similar process is executed. As a result, channel numbers and broadcasting start times are stored for the data with matching channel number, program title and broadcasting start time, namely data (channel 4, Animal Paradise, 9:30), (channel 8, Cosmetic Bearty, 9:30), (channel 10, News 10, 9:30) and (channel 12, Connoisseur Team of Everything, 9:30) in the cells 1443-1447 of the program information data table (FIG. 46) in the synthesized program information memory 1058, and “0” is stored for the unmatching data.

Thereafter a similar process is repeated by referring to the data 1408 at a coordinate (1, 10:00) which is incremented by a unit along the time axis of the program information data table (FIG. 44) in the transmitted program information memory 1056. A channel number and a broadcasting start time for matching data or “0” for unmatching data are stored in the program information data table (FIG. 46) in the synthesized program information memory 1058. In this manner the program information data table (FIG. 46) is completed.

Though the program information data tables shown in FIGS. 44, 45 and 46 only indicate a time axis from 9:30 to 11:00, but it will be obvious that times outside this range are generally included. In FIGS. 44-46, the program information data table is constructed in an increasing order of the channel number along the data column axis, but it may also be constructed with another order.

A synthesizing process (S1118) in the TV receiver 1010b is also similar, whereby a program information data table of a content same as that in the program information data table of the TV receiver 1010a is formed and is stored in the synthesized program information memory 1058 of the TV receiver 1010b. In this state, the transmitted program information memory 1056 of the TV receiver 1010b stores the program information data table shown in FIG. 44, and the received program information memory 1064 stores the program information data table shown in FIG. 45.

Now there will be explained, with reference to FIGS. 46, 47 and 48, an auto station selecting process of the TV receivers 1010a, 1010b when the same program viewed in both the TV receivers 1010a, 1010b reaches a broadcast end time. Such auto station selecting process becomes executable after the aforementioned synthesizing process.

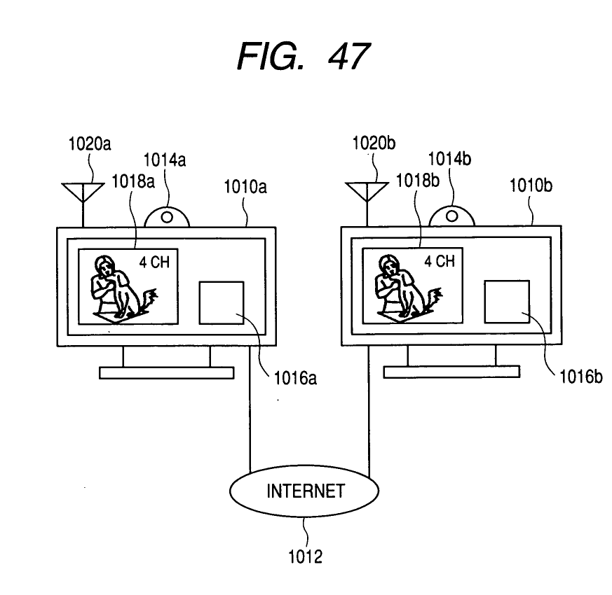

Let us assume a situation where, at a current time 9:40, the viewers of the TV receivers 1010a, 1010b view “channel 4, Animal Paradise”, and the TV broadcast viewing areas 1018a, 1018b display the program “Animal Paradises” as shown in FIG. 47. In this state, the TV receivers 1010a, 1010b refer to data 1443 at the coordinate (2, 9:30) in the program information data table (FIG. 46) of the synthesized program information memory 1058.

Thereafter, when a time 10:00 is informed from the B-timer 1067, the control portion 1074 executes an increment of the referenced data by a unit along the time axis and refers to data 1448 at a coordinate (2, 10:00).

Also when a time 10:30 is informed from the B-timer 1067, the control portion 1074 executes an increment of the referenced data by a unit along the time axis and refers to data 1449 at a coordinate (2, 10:30). Data 1449 store “0” indicating that at least either of the channel number and the program title does not match between the TV receivers 1010a and 1010b. In such case, an increment is made by a unit along the data column axis to refer to data 1450 at a coordinate (3, 10:30). As the data 1450 similarly store “0”, an increment is made again by a unit along the data column axis to refer to data 1451 at a coordinate (4, 10:30).

The data 1451 does not store “0” but a channel number “channel 8”. In such case, there is investigated whether the time 10:30 received from the B-timer 1067 is equal to the broadcasting start time. As the data 1451 store a broadcasting start time “10:00”, an increment by a unit is made again along the data column axis to refer to data 1452 at a coordinate (5, 10:30). The data 1452 store a non-zero channel number “channel 10” and also a broadcasting start time “10:30” same as the time 10:30 received from the B-timer 1067. Thus the signal processor 1044 selects the channel number “10”.

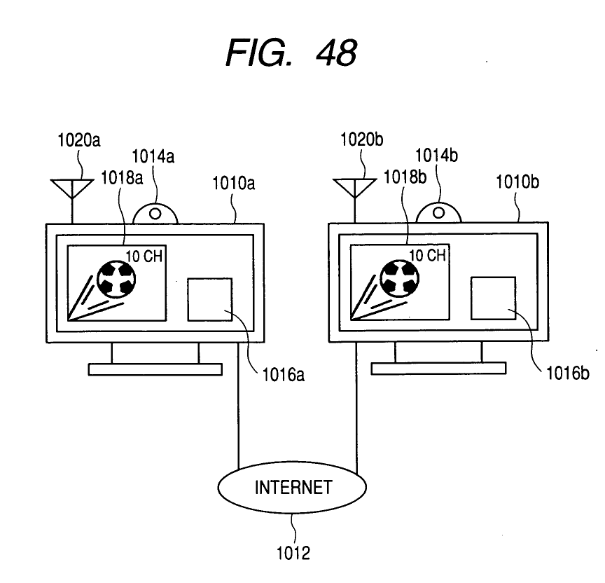

Through the aforementioned process, the TV receivers 1010a, 1010b select and display a program “Prompt Report on Football” of the channel 10 on the TV broadcast program viewing areas 1018a, 1018b as shown in FIG. 48.

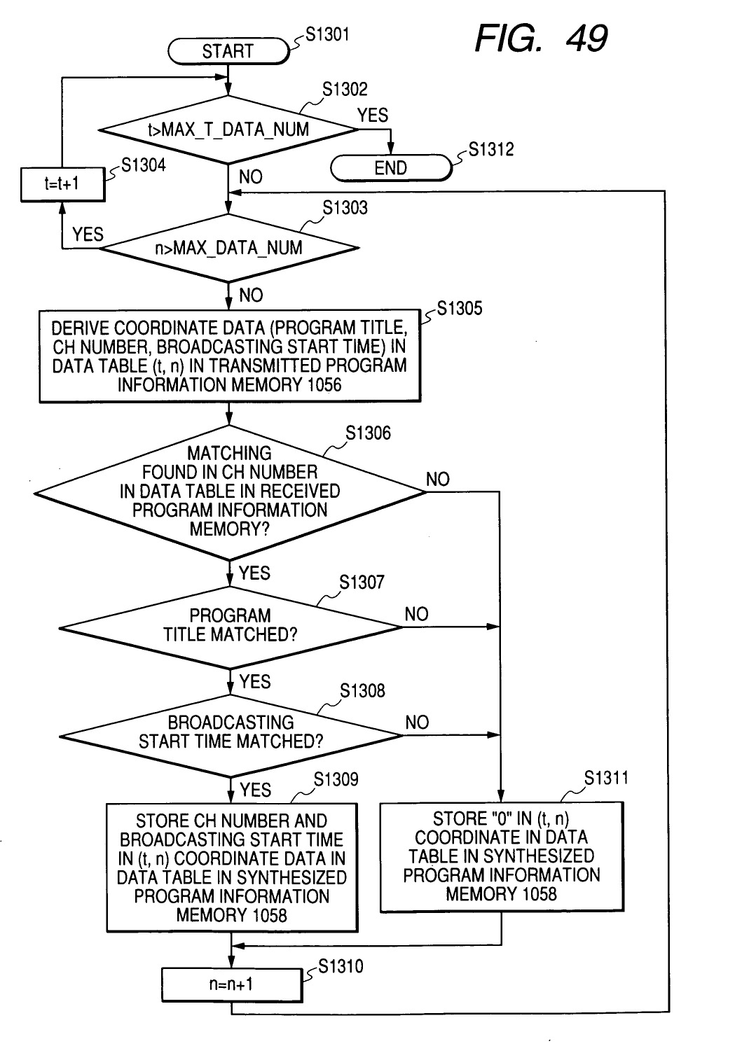

FIG. 49 is a flow chart showing a synthesizing process (S1116, S1118) executed by the control portion 1074.

There is discriminated whether a time variable t, having an initial value “0”, is larger than MAX_T_DATA_NUM which is a maximum data column number, in the time axis, of the program information data table in the transmitted program information memory 1056 (S1302). If true, the sequence is terminated (S1312). The data numbers of the program information data table along the time axis are assumed to be assigned from 0. If false, namely in case t is equal to or smaller than MAX_T_DATA_NUM, there is discriminated whether a data column variable n, having an initial value “0”, is larger than MAX_DATA_NUM which is a maximum data column number, along the data column axis (S1303). If true, the time variable t is incremented (S1304) and the sequence returns to the step S1302. If false, namely in case n is equal to or smaller than MAX_DATA_NUM, a channel number, a program title and a broadcasting start time are extracted from data at a coordinate (n, t) of the program information data table in the transmitted program information memory 1056 (S1305).

Then data at the coordinate (x, t) of the program information data table in the received program information memory 1064 are sorted and program information data of a matching channel number are searched (S1306). “x” is an arbitrary number. If false, namely in case of absence of matching data, “0” is stored in the channel number of the data at the coordinate (n, t) of the program information data table in the synthesized program information memory 1058 (S1311), whereupon the sequence skips to a step S1310.

If true in the step S1306, namely in case of the presence of matching data, there is discriminated whether the program titles in the data at both coordinates (n, t) mutually match (S1307). If false, namely in case the program titles do not match, “0” is stored in the channel number of the data at the coordinate (n, t) of the program information data table in the synthesized program information memory 1058 (S1311), whereupon the sequence skips to a step S1310.

If true in the step S1307, namely in case of matching in the program title, there is discriminated whether the broadcasting start times in the data at both coordinates (n, t) mutually match (S1308). If false, namely in case the broadcasting start times do not match, “0” is stored in the channel number of the data at the coordinate (n, t) of the program information data table in the synthesized program information memory 1058 (S1311), whereupon the sequence skips to a step S1310.

If true in the step S1308, namely in case of matching in the broadcasting start time, the channel number and the broadcasting start time extracted in the step S1305 are stored in the data of the coordinate (n, t) of the program information data table in the synthesized program information memory 1058 (S1309), then the data column variable n is incremented (S1310) and the sequence returns to the step S1303 to repeat the aforementioned process.

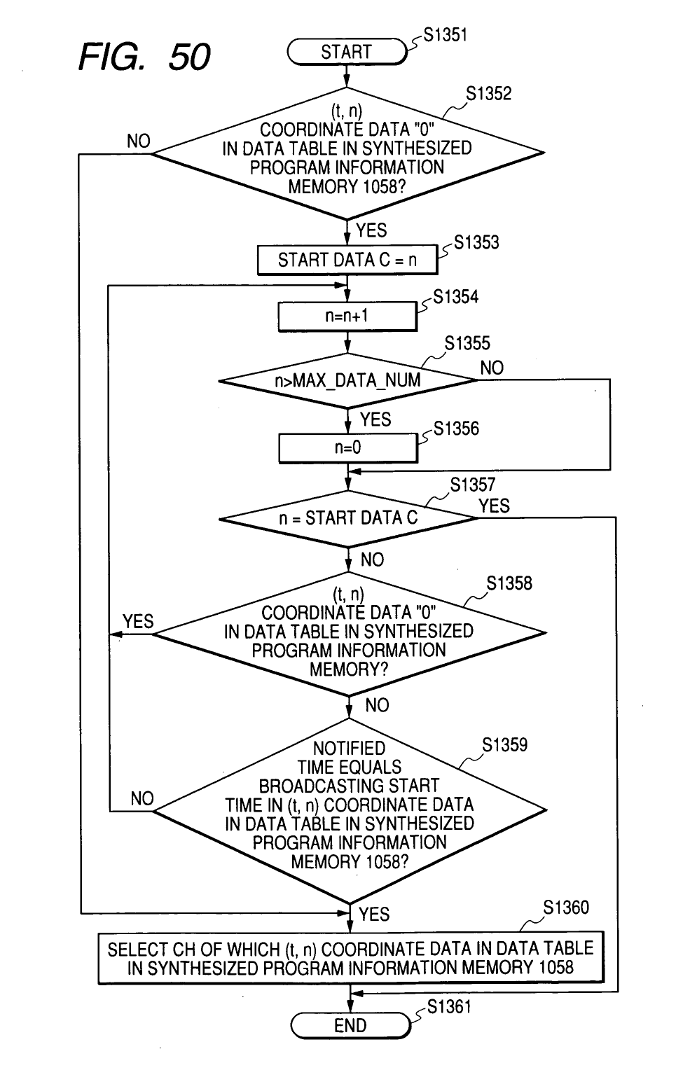

FIG. 50 is a flow chart showing an auto station selecting process of the TV receivers 1010a, 1010b to be started, after receiving a time lapse (time) notice from the B-timer 1067, and after an increment, by a unit along the time axis, of the referenced point of the program information data table in the synthesized program information memory 1058.

There is discriminated whether the referenced data at a coordinate (n, t) of the program information data table in the synthesized program information memory 1058 is “0” (S1352). If false, the process skips to a step S1360. If true, a currently referenced value of the data column variable n is memorized as starting data C (S1353), and n is incremented (S1354).

Then there is discriminated whether n is larger than a maximum data column number MAX_DATA_NUM along the data column axis (S1355). If false, the process skips to a step S1357. If true, “0” is substituted in n (S1356), and there is discriminated whether n is equal to the starting data C (S1357). If true, the process is terminated (S1361), and, if false, there is discriminated whether the data at a coordinate (n, t) of the program information data table in the synthesized program information memory 1058 is “0” (S1358).

If true in the step S1358, the sequence returns to the n incrementing step (S1354), but, if false, there is discriminated whether the broadcasting start time in the data at a coordinate (n, t) of the program information data table in the synthesized program information memory 1058 is equal to the time informed from the B-timer 1067 (S1359). If false, the sequence returns to the n incrementing step (S1354), but, if true, a channel number stored in the data at the coordinate (n, t) of the program information data table is selected (S1360), whereupon the process is terminated (S1361).

The TV receivers 1010a, 1010b can detect that, after a TV program commonly viewed is terminated, they can no longer view a common TV program in the same channel. It is made possible to look for another TV program that can be commonly viewed by both and to automatically switch to such TV program. Thus, when a commonly viewed TV program is terminated and a common viewing becomes no longer possible between areas different for example in the channel number of the program as in a ground wave broadcasting, it is possible to avoid the trouble in the viewers of manually searching another commonly viewable program.

In addition, the automatic station switching can be executed not in the course of a program broadcasting but at the start of a program, thereby providing the viewers with a more comfortable audio-visual environment.

In the foregoing embodiments, programs that can be selected by a tuner have been explained as the programs that can be viewed commonly, but the present invention is not limited to such embodiments. More specifically, it is also possible to accumulate video stream data and audio stream data of plural programs in a memory apparatus such as a hard disk and to execute a selection on such stored programs. In such case, commonly selectable programs can be judged by respectively sending information of the programs stored in a memory apparatus corresponding to each of both receivers to the other receiver. Also in such case, instead of channel designation, there can be designated data for reproducing a program such as an address in the memory apparatus. It is also possible to make selection on both the programs selectable with the tuner and the programs stored in the memory apparatus.

Also in the foregoing embodiments, there has been explained a constitution in which a commonly selectable program is confirmed utilizing program information, but, in case a same program can be reproduced by selecting a same channel or mutually corresponding channels in both receivers, for example when both receivers are present in a same region or when both receivers receive signals from a same cable television station, it is not necessary to discriminate whether a common selection is possible by referring to the program information and a mere transmission of the channel information to the other receiver enables the both receivers to respectively select a common program. However, even in such case, there may arise a situation where a specified channel can be received by a receiver but cannot be received by the other, depending upon a reception state of the broadcast signal or upon a tuner performance. In such case, it is possible to mutually transmit information of channels receivable by each receiver and make a selection on the commonly receivable channels.

Also the term channel used herein needs only be individually identifiable, and is not limited to a channel identified by a carrier frequency used therein.

In the following, there will be explained an embodiment capable of coordinated reproduction in more preferably manner.

The embodiment has a following constitution.

More specifically, it is a coordinated TV system for coordinating a first TV receiver and a second TV receiver connected through a network, characterized in that:
the first TV receiver is provided with means which transmits a control signal, caused by an operation of a viewer of the first TV receiver, to the second TV receiver, and means which executes a control according to a predetermined notice from the second TV receiver and in response to an operation of the viewer of the first TV receiver;
the second TV receiver is provided with means which receives the control signal from the first TV receiver, means which gives an advance notice of a control according to the control signal to an operator of the second TV receiver, means which executes, according to the control signal, a specified control corresponding to the control signal, and means which transmits, as the predetermined notice to the first TV receiver, a notice completion notice that informs the first TV receiver of a fact that the control signal has been informed to the operator of the second TV receiver.

As an example, the second TV receiver may be further provided with means which receives an approval by the operator of the second TV receiver prior to the execution of the specified control corresponding to the control signal, and means which, in response to the receipt of the approval, causes an immediate execution of the specified control corresponding to the control signal and the notice of the receipt of the control signal to the operator of the second TV receiver.

Also, the second TV receiver may be further provided with means which receives a refusal by the operator of the second TV receiver prior to the execution of the specified control corresponding to the control signal, and means which, in response to the receipt of the refusal, cancels the specified control corresponding to the control signal and informs the operator of the second program information of such cancellation; and
the first TV receiver may be provided with means which, upon receiving a notice for the cancellation of the specified control corresponding to the control signal from the second TV receiver, informs the operator of the first TV receiver with such cancellation.

There is also disclosed a constitution in which each of the first and second TV receivers displays an icon for information notice on a display image.

There is also disclosed a constitution in which:
each of the first and second TV receivers is capable of a bi-directional communication with an accompanying remote control apparatus;
the remote control apparatus includes light-emission means for a predetermined operation button; and
the light-emission means is used for the advance notice.

The remote control apparatus may also be provided with vibrator means which can be utilized as notice means to the viewer.

There are also disclosed a constitution where an operation button for generating a control signal for a specified control is positioned in a peripheral part of a front face of a camera apparatus to be utilized in a TV telephone function, and a constitution where an operation button for generating a control signal for a specified control is positioned on a transparent touch panel, provided within a photographing range in front of the camera apparatus to be utilized in a TV telephone function.

There is also disclosed a constitution where such specified control may be a channel switching control.

There is also disclosed a constitution where, at the reception of the control signal, a broadcast program after a channel switching based on the control signal is displayed, prior to the execution of the control, in a separate image area.

In the following a more detailed explanation will be given.

### Embodiment 6

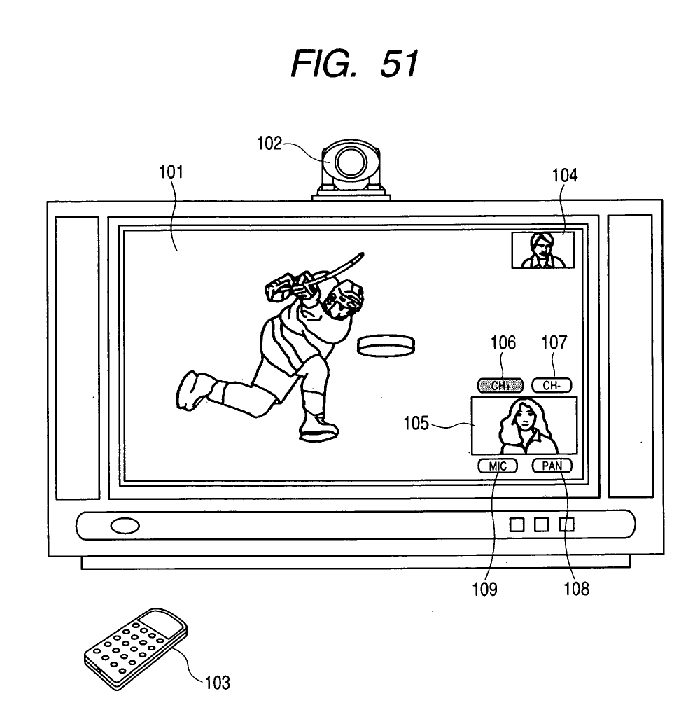

FIG. 51 is a view showing a configuration of a DTV apparatus to be employed in an embodiment of the present invention. There are illustrated a monitor image 1000101 of the DTV apparatus, a camera apparatus 1000102, a remote control apparatus 1000103, an own image displaying sub image area 1000104 for displaying a confirming image for an own camera apparatus in a TV telephone function, a partner image displaying sub image area 1000105 for displaying an image of a partner in the TV telephone function, and icons 1000106-1000109 for displaying advance notices for partner operations in the TV telephone function, in which 1000106 is an advance notice icon for a channel up operation, 1000107 is an advance notice icon for a channel down operation, 1000108 is an advance notice icon for a camera panning operation, and 1000109 is an advance notice icon for a microphone switching operation.

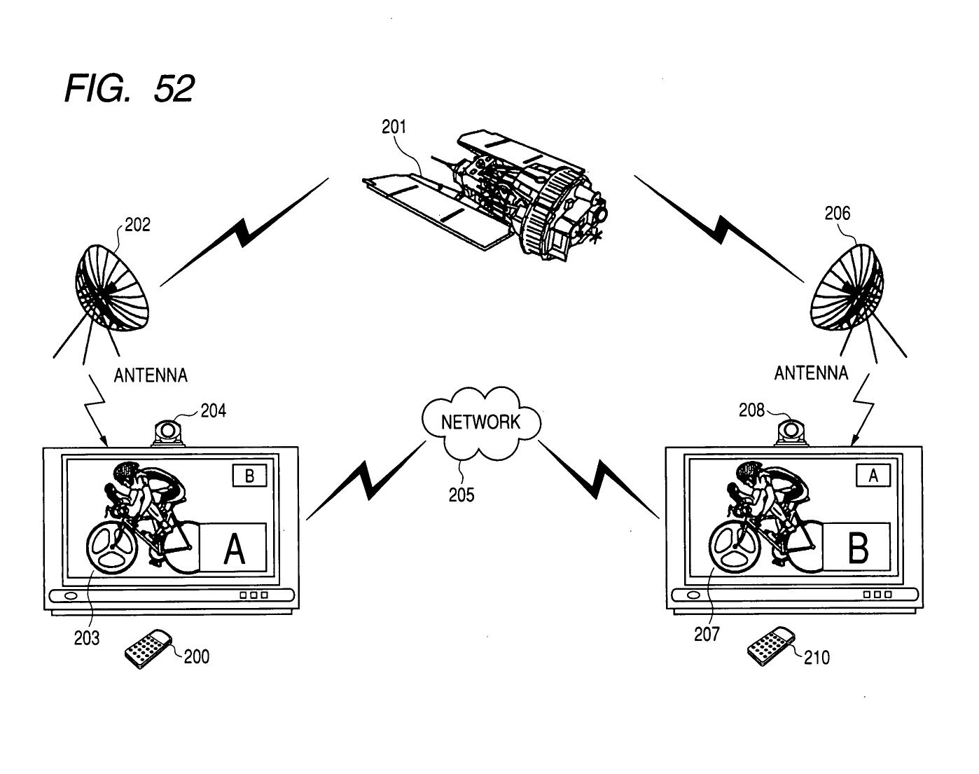

FIG. 52 is a view showing the entire configuration of the present embodiment, showing a system in which DTV apparatuses in distant locations are connected by a network and simultaneously view a same program under a communication by a TV telephone function. There are shown a broadcasting satellite 1000201, parabola antennas 1000202, 1000206 for broadcast reception, DTV apparatuses 1000203, 1000207, camera apparatuses 1000204, 1000208, remote control apparatus 1000209, 1000210, and a network 1000205 for transmitting video/audio/control signals between the DTV apparatuses 1000203 and 1000207.

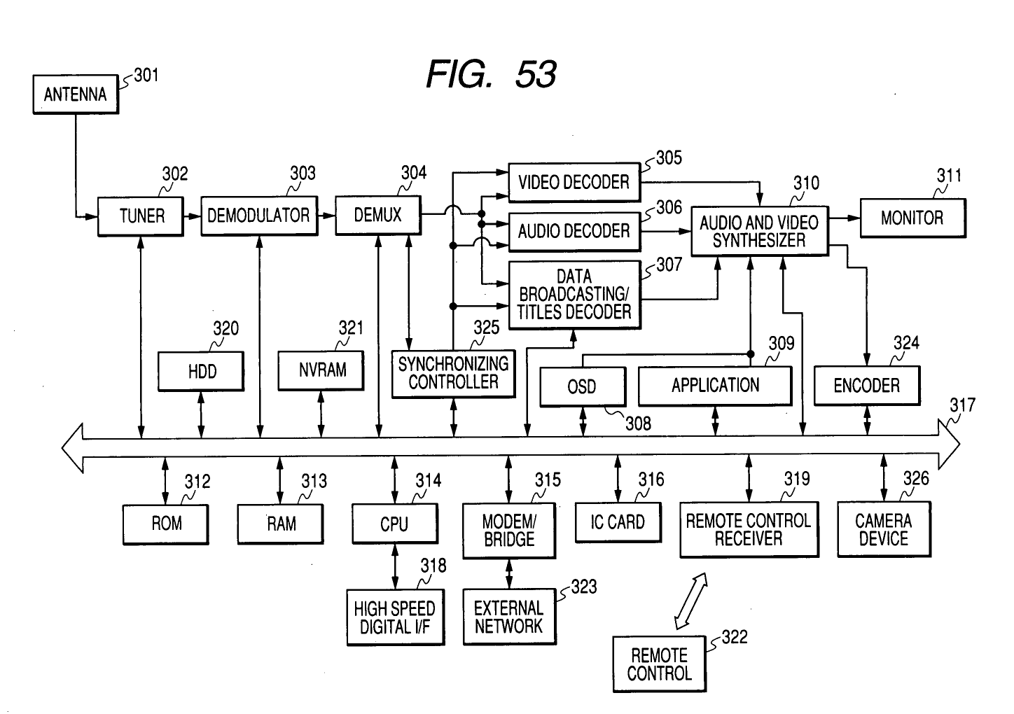

FIG. 53 is a block diagram showing a schematic constitution of the DTV apparatus 203, 207 constituting a program reproducing apparatus, in which provided are an antenna apparatus 1000301 for receiving a digital broadcasting wave, a tuner apparatus 1000302 constituting a selecting circuit for selecting broadcast waves received by the antenna 1000301, a demodulator 1000303 for demodulating the selected wave into a signal, a demultiplexer (DEMUX) 1000304 for separating a TS signal from the demodulated signal and separating it into individual signals, a video decoder 1000305 for decoding a video signal from the separated TS signal, an audio decoder 1000306 for decoding an audio signal from the TS signal, and a data broadcast/title decoder 1000307 for decoding broadcast and titles from the TS signal.

There are further provided an OSD (on screen display) circuit 1000308 for displaying information from various control apparatus in the main body of the DTV apparatus, applications 1000309 loaded in the DTV apparatus, a video synthesizer 1000310 for synthesizing various video information prepared in the DTV apparatus, and a monitor apparatus 1000311 constituting a reproducing apparatus for constructing a display image of the DTV apparatus.

There are further provided a ROM 1000312 for storing control programs, application programs and various data for the DTV apparatus, a RAM 1000313 constituting a work area for loading control programs, application programs and various data for the DTV apparatus and for the execution of applications, and a CPU 1000314 constituting a control circuit for executing various controls of the DTV apparatus and various applications.

There are further shown a modem 1000315 constituting a transmission/reception circuit for a communication between the DTV apparatus and an external equipment, an IC card 1000316 for an authenticating operation in a restricted reception of the DTV apparatus and for various information exchange with the external equipment, a bus 1000317 for information exchange among the circuit blocks of the DTV apparatus, an interface 1000318 for high-speed data exchange including video data with the external equipment connected to the DTV apparatus, a remote control reception portion 1000319 for receiving signals from the remote control apparatus, an HDD 1000320 for storing various received data, program contents and information of the DTV apparatus, and a non-volatile RAM 1000312 for retaining various data of the DTV apparatus even when the power supply is turned off.

There are also shown a remote control apparatus 1000322 to be used by a user, an external network 1000323 connected through the modem 1000315 or through a bridge, an encoder 1000316 for converting program contents data, decoded in the DTV apparatus, into stream data adapted for viewing in a portable terminal, a synchronization control circuit 1000325 for synchronizing the stream data separated in the demultiplexer 1000304, and a camera apparatus 1000326.

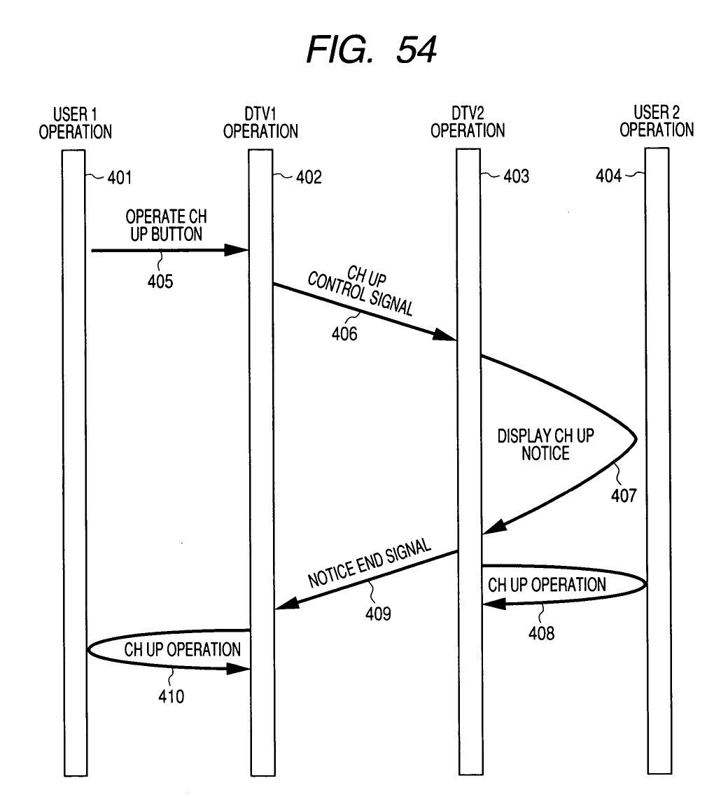

FIG. 54 is a sequence chart showing user operations and an operation flow between the DTV apparatuses 1000203 and 1000207. In FIG. 54, one of the DTV apparatuses 1000203 and 1000207 is represented as a DTV apparatus 10001, and the other as a DTV apparatus 10002. 1000401 indicates an operation by the user 10001 of the DTV apparatus 10001; 1000402 indicates a function of the DTV apparatus 10001; 1000403 indicates a function of the DTV apparatus 10002; and 1000404 indicates an operation by the user of the DTV apparatus 10002.

Also 1000405 indicates a channel up button operation by the user 10001; 1000406 a channel up control signal sent from the DTV apparatus 10001 to the DTV apparatus 10002; 1000407 an advance notice display for a channel up operation in the DTV apparatus 10002; 1000408 a channel up operation in the DTV apparatus 10002; 1000409 an advance display end signal from the DTV apparatus 10002 to the DTV apparatus 10001; and 1000410 a channel up operation in the DTV apparatus 10001.

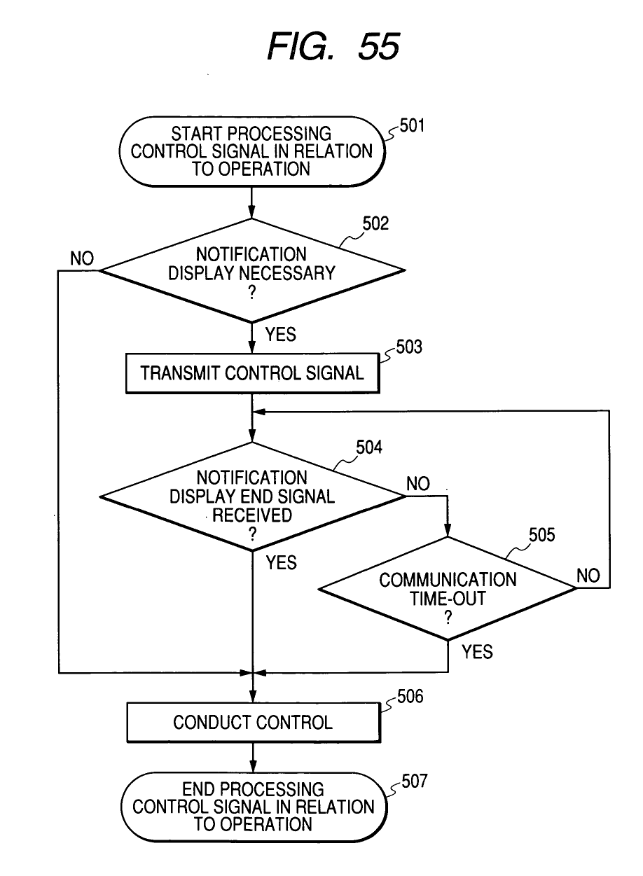

FIG. 55 is a flow chart showing functions of the DTV apparatus 10001, in which 1000501 indicates a process entry point in case an operation for a coordinated operation control is executed in the DTV apparatus 10001; 1000502 a step for discriminating whether an advance notice display is necessary for the operated coordinated control; 1000503 a step for transmitting an operated control signal to the DTV apparatus 10002 connected through the network; 1000504 a step for discriminating whether an advance notice end signal is received from the DTV apparatus 10002; 1000505 a step for discriminating whether the network connection with the DTV apparatus 10002 is cut off for example by a time out; 1000506 a step of executing the operated control signal; and 1000507 an end point.

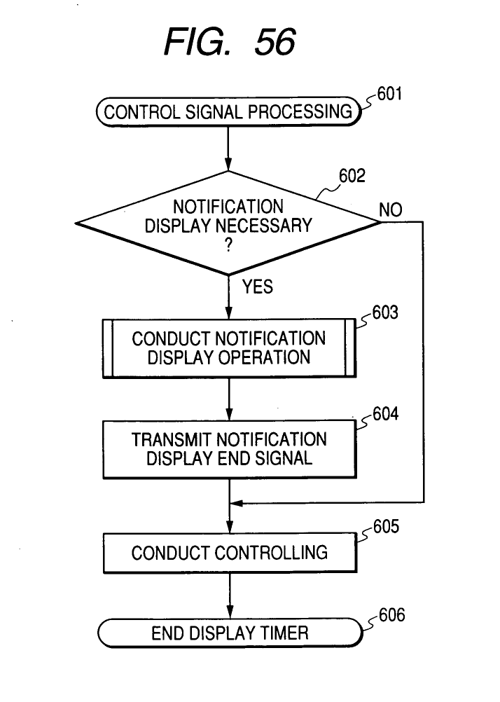

FIG. 56 is a flow chart showing functions of the DTV apparatus 10002, in which 1000601 indicates a process entry point in case a control signal for a coordinated operation is received by the DTV apparatus 10002; 1000602 a step for discriminating whether an advance notice display is necessary for the received control signal for the coordinated operation; 1000603 a step for executing an advance notice display operation in the coordinated operation control; 1000604 a step of transmitting an advance notice display end signal to the DTV apparatus 10001; 1000605 a step of executing the control signal for the coordinated operation in the DTV apparatus 10002; and 1000606 an end point.

The functions of the present embodiment will be explained in details by referring to FIGS. 51 to 56. There is assumed as a situation, as shown in FIG. 52, DTV apparatuses 1000203, 1000207 in distant locations, connected by a network, simultaneously view a same program under a communication by a TV telephone function and a coordinated operation control function. FIG. 51 principally illustrates the DTV apparatus 1000207 (10002), in which the image displays a simultaneously viewed program content, while a sub area 1000105 displays the user 10001 of the DTV apparatus 1000203 transmitted by the TV telephone function from the DTV apparatus 1000203 (10001), and a sub area 1000105 displays the user 10002 of the DTV apparatus 10002 for confirming the TV telephone function. Thus the user 10001 of the DTV apparatus 10001 and the user 10002 of the DTV apparatus 10002 execute viewing of same program contents as if on a same DTV apparatus, while observing mutual images taken by the camera apparatuses 1000204, 1000208 and displayed in sub areas and listening to mutual voices by the microphones attached to the camera apparatuses 1000204, 1000208.

Now let us consider a situation, in such state, where the user 10001 of the DTV apparatus 1000203 (10001) executes a channel up operation in the remote control apparatus 1000309 for the purpose of changing the channel of the program contents, which is simultaneously viewed by the user 10002 of the DTV apparatus 1000207 (10002). FIG. 54 shows the operations of the users 10001, 10002 and the functions of the DTV apparatuses 10001, 10002 in the order of time. The operation executed by the user 10001 of the DTV apparatus 10001, namely the channel up operation, is identified as an operation requiring a coordinated operation as it influences the program contents in the simultaneous viewing, whereby a coordinated operation control process shown in FIG. 55 is started from an entry point 10000501.

A step 1000502 discriminates whether an advance notice display to the partner of simultaneous viewing is required for the operation requiring the coordinated operation control. Since the present control operation is to unilaterally change the program contents simultaneously viewed by the partner, an advance notice display is identified necessary and the sequence proceeds to a step 1000503. A step 1000503 transmits, utilizing a part of information packet connected in the TV telephone function, a channel up control signal as an in-process control signal to the DTV apparatus 10002 executing the simultaneous viewing. Thus a control signal flow 1000406 shown in FIG. 54 is started.

Then a step 1060504 discriminates whether an advance notice display end signal from the DTV apparatus 10002 has been received. If not, the sequence proceeds to a step 1000505. A step 1000505 discriminates whether the communication by the TV telephone function has shown a time-out by any reason. If the connection is still maintained, the sequence proceeds again to the step 1000504, and a loop is executed until the advance notice display signal is received.

FIG. 56 shows a process flow executed by the DTV apparatus 10002 upon receiving the control signal 1000406 shown in FIG. 54. A process upon receiving a control signal for the coordinated operation is started from an entry point 1000601. A step 1000602 discriminates whether the transmitted control signal requires an advance notice display. In case of a control signal affecting the viewer such as a channel up signal, the sequence proceeds to a step 1000603. A step 1000603 executes an advance notice display operation utilizing a display image to the user 10002 of the DTV apparatus 10002.

Now an icon 1000106 is displayed in a flashing inverted display on the image of the DTV apparatus 10002, thereby giving an advance notice for a channel up control by the user 10001 of the DTV apparatus 10001 to the user 10002 of the DTV apparatus 10002. Through such flashing inversion display of the icon 1000106, the user 10002 of the DTV apparatus 10002 can know that the user 10001 of the DTV apparatus 10001 has sent a channel up control signal, as a control signal for a coordinated operation. In FIG. 54, 1000407 indicates such advance notice display on the DTV apparatus 10002. After such advance notice display is continued for a predetermined period, namely a period indicated by 1000407, the sequence proceeds to a step 1000604 shown in FIG. 56 and the DTV apparatus 10002 transmits an advance notice display end signal to the DTV apparatus 10001.

Then a step 1000605 executes a channel up operation in the DTV apparatus 10002 according to the control signal from the DTV apparatus 10001, and a next step 1000606 terminates the channel up operation in the DTV apparatus 10002. These functions are illustrated by 1000409 and 1000408 in FIG. 54.

Then the DTV apparatus 10001 receives the advance notice display end signal from the DTV apparatus 10002. Thus the sequence proceeds to a step 10000506 in FIG. 55, which executes a channel up operation in the DTV apparatus 10001 and a step 1000507 terminates the sequence.

As explained in the foregoing, the present embodiment allows to have a coordinated feeling by a coordinated operation, in case of viewing a same program in distant location, utilizing a TV telephone function and a coordinated operation control function. In an operation of the DTV apparatus by a partner that cannot be understood in the TV telephone function, a safe feeling can be obtained since such operation is executed after an appropriate advance notice display is given. It is thus possible to exclude a situation deteriorating the coordinated feeling, such as a sudden and unexpected operation on the DTV apparatus.

### Embodiment 7

In the embodiment 6, when a control signal for a coordinated operation is sent from the partner and an advance notice based on such control is displayed on the image of own DTV apparatus, such control signal is executed after the lapse of a predetermined time. Therefore, the control signal is only executed after the lapse of such predetermined time from the start of the advance notice display, even in case the control signal for the coordinated operation executed by the partner is already understood by an advance conversation through the TV telephone function or by an inexplicit understanding. An embodiment 7 is to avoid such useless waiting time.

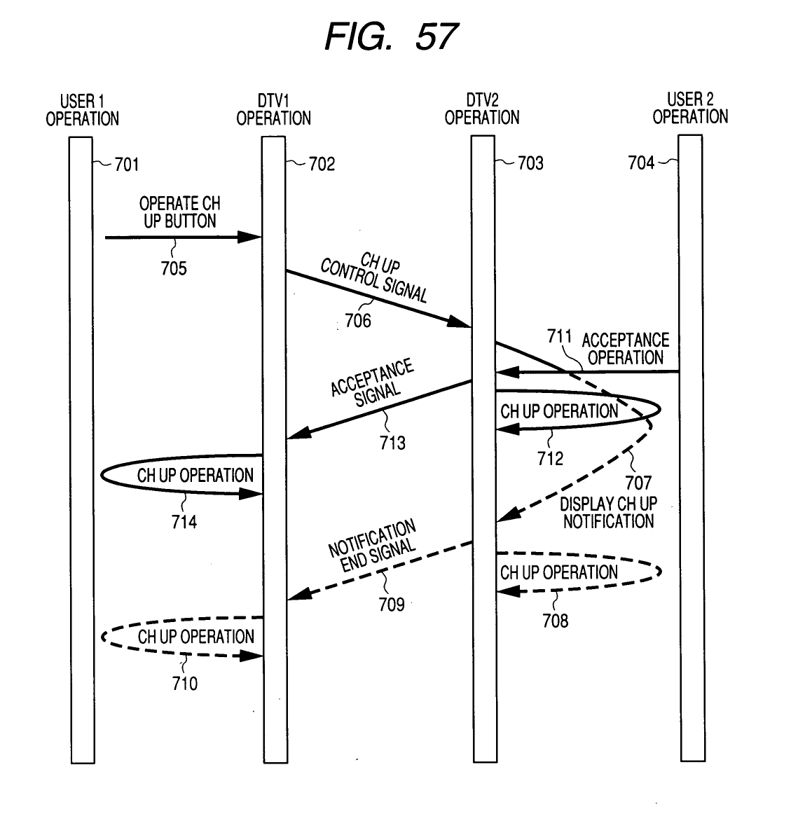

FIG. 57 is a sequence diagram of the coordinated functions between the DTV apparatuses 10001, 10002 in the embodiment 7. When the user 10001 of the DTV apparatus 10001 executes a channel up operation 1000705 involving a coordinated operation control, a channel up control signal 1000706 is transmitted from the DTV apparatus 10001 to the DTV apparatus 10002. After a channel up advance notice display 1000707 is started on the DTV apparatus 10002, the user 10002 of the DTV apparatus 10002 executes an approving operation to the control signal of the advance notice display, for example a channel up operation by the remote control apparatus of the DTV apparatus 10002. In response, the DTV apparatus 10002 immediately transmits a signal 1000713, indicating an end of the advance notice display and an approval to the control, to the DTV apparatus 10001, and also immediately executes an operation corresponding to the control signal, namely a channel up control 1000712.

Such constitution, in which the user 10002 of the DTV apparatus 10002 executes an approving operation to the control signal from the user 10001 of the DTV apparatus 10001, enables prompt execution of the control signal by the DTV apparatuses 10001, 10002 without waiting for the lapse of the predetermined time for the advance notice display.

### Embodiment 8

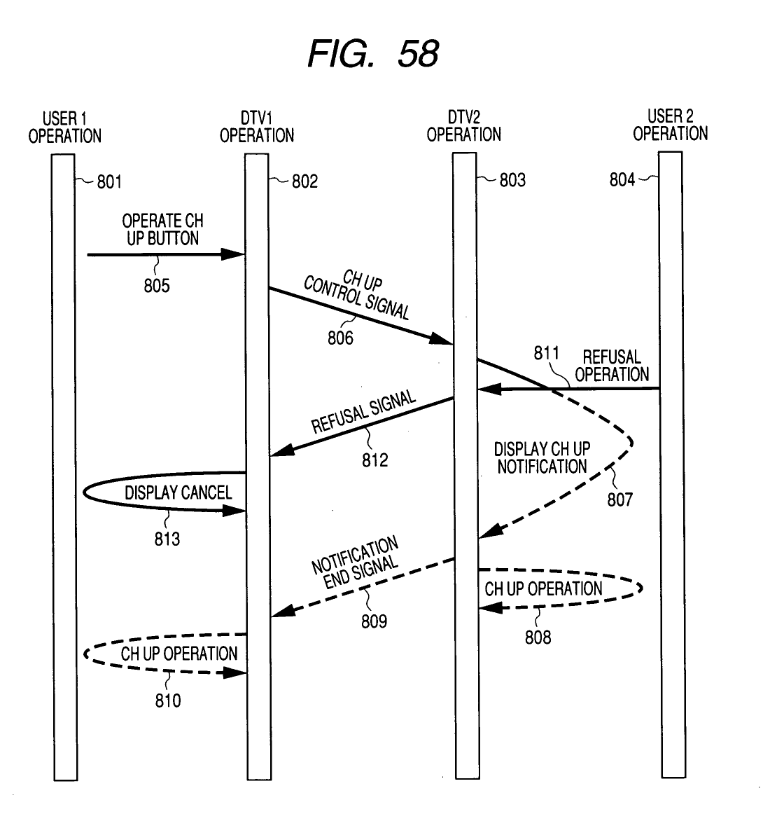

In the following, there will be explained an embodiment 8 of the present invention. FIG. 58 is a sequence diagram of the coordinated functions between the DTV apparatuses 10001, 10002 in the embodiment 8.

When the user 10001 of the DTV apparatus 10001 executes a channel up operation 1000805 involving a coordinated operation control, a channel up control signal 1000806 is transmitted from the DTV apparatus 10001 to the DTV apparatus 10002. After a channel up advance notice display 1000807 is started on the DTV apparatus 10002, the user 10002 of the DTV apparatus 10002 executes a refusing operation to the control signal of the advance notice display, for example a cancel button operation by the remote control apparatus of the DTV apparatus 10002. In response, the DTV apparatus 10002 immediately transmits a refusing signal 1000813, indicating an end of the advance notice display and a refusal to the control, to the DTV apparatus 10001, and does not executes an operation corresponding to the control signal, namely a channel up operation. The DTV apparatus 10001, upon receiving the refusal signal from the DTV apparatus 10002, display a cancellation of the user 10002 to the user 10001 of the DTV apparatus 10001, and terminates the sequence.

Such constitution, in which the user 10002 of the DTV apparatus 10002 executes a refusing operation in case of wishing to refuse the control signal from the user 10001 of the DTV apparatus 10001, enables an immediate cancellation of the control signal without an execution of such control signal at the end of the advance notice display for the predetermined period. Also a refusal signal to the advance notice signal is immediately sent to the user 10001 of the DTV apparatus 10001, thereby immediately displaying a cancellation display 1000813.

### Embodiment 9

In embodiments 6-8, as an advance notice in case of receiving a control signal for a coordinated operation, an icon corresponding to the control signal is flash displayed on the display of the DTV apparatus, but it is also possible to flash a corresponding operation button on the remote control apparatus. In such case, however, it is necessary that the DTV apparatus and the remote control apparatus have a bi-directional communicating function and the remote control apparatus is provided with light-emission means in a certain operation key.

In such constitution, in case of an advance notice of the control signal from the user 10001 of the DTV apparatus 10001 by a coordinated operation function to the user 10002 of the DTV apparatus 10002, a function button, corresponding to the operation of the user 10001, in the remote control apparatus owned by the user 10002 of the DTV apparatus 10002 flashes by the light-emission means, thereby allowing the user 10002 to know clearly and directly the kind of the control signal operated by the user 10001 of the DTV apparatus 10001. Also in case various kinds of control signals are required for the coordinated operation and for the advance notice display, it is possible, by providing the corresponding buttons of the remote control apparatus with the light-emission means, to realize securely and detailedly classified advance notice displays, without being annoyed by a disturbing layout of icons on the display of the DTV apparatus.

Also, as a combination with the eighth embodiment, it is possible to utilize, for the user who has initially executed the operation for the coordinated operation, the light-emission means of the remote control apparatus for indicating a cancellation of such operation.

Also in a situation where a sufficient advance notice display cannot be achieved by a mere flashing of a particular button having light-emission means in the remote control apparatus, it is naturally possible to utilizing various light-emitting patterns as the advance notice display, such as an alternating lighting of such particular button having the light-emitting means and all other buttons having the light-emitting means. It is also possible to securely draw the attention of the user even when the user is not paying attention to the buttons of the remote control apparatus, for example by applying vibrator means, utilized for a soundless call notice in a portable telephone, to the remote control apparatus.

### Embodiment 10

In the foregoing sixth to ninth embodiments, it is assumed that an operation for a coordinated operation on the remote control apparatus is not clearly observable in the camera apparatus, but there may be adopted a constitution in which an operation button for a coordinated operation is positioned around or in front of the camera apparatus utilized in the TV telephone function.

In such constitution, scenes of the operations for coordination by the user 10001 of the DTV apparatus 10001 are displayed in succession on the sub area in the display of the DTV apparatus 10002. Thus the user 10002 of the DTV apparatus 10002 can observe the mode of operation of the user 10001 of the DTV apparatus 10001, for example can confirm a scene that a finger of the user 10001 approaches the camera apparatus of the DTV apparatus 10001 and executes an operation on an operation button involving a coordinated operation, on the sub image area of the DTV apparatus 10002.

By positioning an icon for executing an advance notice display for a control involving a coordinated operation in a peripheral position around the sub image area, corresponding to a position of an operation button for executing such coordinated operation, with respect to the camera apparatus, the user 10002 of the DTV apparatus 10002 can estimate the operation which the user 10001 of the DTV apparatus 10001 intends to execute, before the user 10001 actually executes such control for the coordinated operation.

### Embodiment 11

In the tenth embodiment, an operation button for executing the coordinated operation is positioned in front of or around the camera apparatus employed in the TV telephone function, but it is also possible to form the button for the coordinated operation as a button prepared in a transparent touch panel provided in front of the camera apparatus, thereby displaying the position of such button on the transparent touch panel on the sub image area of the partner DTV apparatus which displays the image of such camera apparatus, and to display an icon for executing the advance notice display for the control involving the coordinated operation in superposition with the button photographed and displayed on such sub image area.

In such constitution, in case of a coordinated operation by the user 10001 of the DTV apparatus 10001, the sub image area of the display of the DTV apparatus 10002 directly displays the proceeding of such operation and an actuation on the operation button for the coordinated operation, and the user 10002 of the DTV apparatus 10002 can confirm, from a state that the user 10001 of the DTV apparatus 10001 intends to start an operation involving a coordination, that the user 10001 is going to start an operation in a particular direction around the sub image area. Also the actual operation on the operation button can be confirmed.

### Embodiment 12

The eighth embodiment may be so modified the tuner 1000302 can select two broadcast programs.

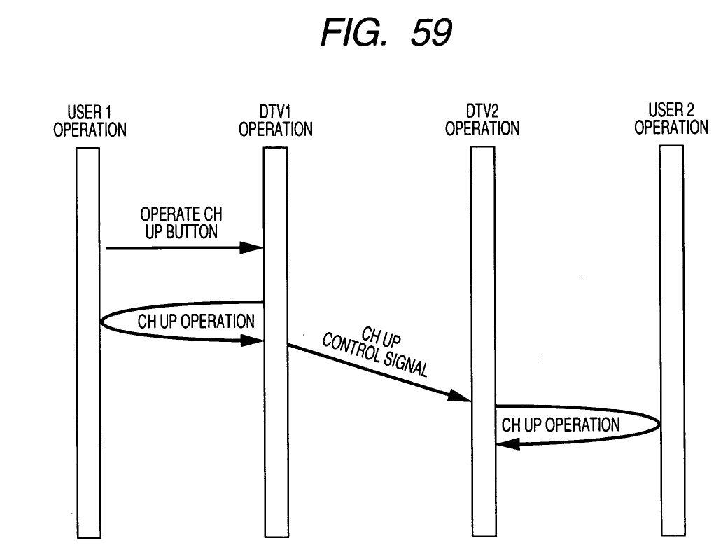

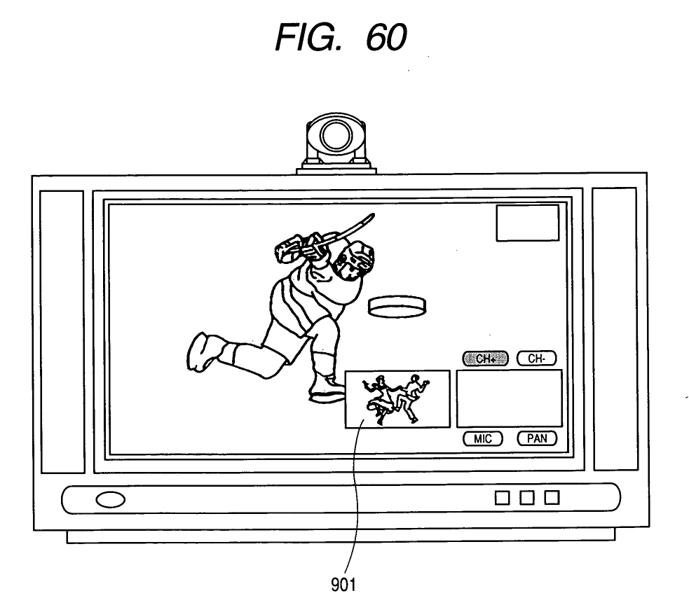

As shown in FIG. 59, the user 10001 of the DTV apparatus 10001 executes a channel up operation 1000805 involving a coordinated operation, and a channel up control signal 1000806 is transmitted from the DTV apparatus 10001 to the DTV apparatus 10002. Then an advance notice display 1000807 is executed in the DTV apparatus. During such advance notice display, the tuner 1000302 of the DTV apparatus 10002 selects a broadcast program in a channel-up state, and displays such program in an advance notice image 1000901 as shown in FIG. 60.

In such constitution, at the advance notice display of the operation by the user 10001 of the DTV apparatus 10001, the user 10002 of the DTV apparatus 10002 can confirm the broadcast program to be displayed after the channel switching and the judgment for approval or refusal for the channel switching can be facilitated.

It will be evident that, by combining the foregoing embodiments, a constitution integrally having the advantages of the individual embodiments can be realized.

This application claims priority from Japanese Patent Application Nos. 2003-412744 filed on Dec. 11, 2003, 2003-412746 filed on Dec. 11, 2003 and 2004-322376 filed on Nov. 5, 2004, which are hereby incorporated by reference herein.

1. A program selecting apparatus comprising:
a control circuit for outputting information for selecting a predetermined program;
a selection circuit for selectively outputting a signal for selecting said predetermined program based on said information; and
a transmission circuit for transmitting an information to another program selecting apparatus;
wherein the information transmitted to said another program selecting apparatus includes at least information for causing such another program selecting apparatus to select said predetermined program in order that a corresponding reproduction apparatus reproduces said predetermined program.

2. A program selecting apparatus according to claim 1, wherein said predetermined program is selectable both in said program selecting apparatus and in said another program selecting apparatus.

3. A program selecting apparatus according to claim 1, wherein said control circuit outputs, based on information of programs that can be selected respectively said another program selecting apparatus and by said program selecting apparatus including the control circuit, information for designating a program selectable commonly by said another program selecting apparatus and by said program selecting apparatus including the control circuit, as said predetermined program.

4. A program selecting apparatus according to claim 1, wherein said control circuit outputs, based on common program selection information indicating information of a program selectable commonly by said another program selecting apparatus and by said program selecting apparatus including the control circuit, information for designating a program selectable commonly by said another program selecting apparatus and by said program selecting apparatus including the control circuit, as said predetermined program.

5. A program selecting apparatus according to claim 1, wherein said selection circuit selectively outputs a signal for reproducing said predetermined program, transmitted by a predetermined channel, from a receivable broadcast signal.

6. A program selecting apparatus according to claim 1, wherein said selection circuit is a circuit for selectively outputting a signal for reproducing said predetermined program, among signals stored in a memory apparatus.

7. A program selecting apparatus comprising:
a control circuit for generating a predetermined control signal, in case a program to be selected according to a program designating signal is not a program selectable by another predetermined program selecting apparatus; and
a circuit for generating, in response to said control signal, a signal for causing a user to notice that said another predetermined program selecting apparatus is unable to select such program.

8. A program selecting apparatus comprising:
a selection circuit for receiving a broadcast signal and selecting a predetermined channel; and
a transmission circuit for transmitting information;
wherein said information is information of channels selectable by said selection circuit and/or information on programs receivable by a channel selection in said selection circuit.

9. A program selecting apparatus according to claim 8, wherein:
said transmission circuit is a circuit for transmitting said information to another program selecting apparatus.

10. A program selecting apparatus comprising:
a control circuit for outputting information for selecting a predetermined program, based on a signal from another program selecting apparatus;
a selection circuit for selectively outputting a signal for reproducing said predetermined program based on said information; and
a transmission circuit for transmitting information for informing said another program selecting apparatus of execution of a selection in said selection circuit based on the signal from said another program selecting apparatus.

11. A program selecting apparatus comprising:
a control circuit for outputting information for selecting a predetermined program, based on a signal from another program selecting apparatus;
a selection circuit for selectively outputting a signal for reproducing said predetermined program based on said information; and
a transmission circuit for transmitting information for informing said another program selecting apparatus, in case said selection circuit does not execute a selection based on the signal from said another program selecting apparatus, of such non-execution.

12. A program reproducing apparatus comprising:
a control circuit for outputting information for selecting a predetermined program;
a selection circuit for selectively outputting a signal for reproducing said predetermined program based on said information;
a reproduction apparatus for reproducing the signal outputted by said selection circuit; and
a transmission circuit for transmitting information to another program reproducing apparatus;
wherein the information transmitted to said another program reproducing apparatus at least includes information for causing said another program reproducing apparatus to select said predetermined program in order that a reproducing apparatus included in said another program reproducing apparatus reproduces the predetermined program.

13. A program reproducing apparatus comprising:
a selection circuit for receiving a broadcast signal and selecting a predetermined channel;
a reproduction apparatus for reproducing a signal outputted by said selection circuit; and
a transmission circuit for transmitting information;
wherein said information is information of channels selectable by said selection circuit and/or information of programs receivable by the channel selection in said selection circuit.

14. A program reproducing apparatus comprising:
a control circuit for outputting information for selecting a predetermined program, based on a signal from another program selecting apparatus;
a selection circuit for selectively outputting a signal for reproducing said predetermined program based on said information;
a reproduction apparatus for reproducing the signal outputted by said selection circuit; and
a transmission circuit for transmitting information for informing said another program selecting apparatus of execution of a selection in said selection circuit based on the signal from said another program selecting apparatus.

15. A program reproducing apparatus comprising:
a control circuit for outputting information for selecting a predetermined program, based on a signal from another program selecting apparatus;
a selection circuit for selectively outputting a signal for reproducing said predetermined program based on said information;
a reproduction apparatus for reproducing the signal outputted by said selection circuit; and
a transmission circuit for transmitting information for informing said another program selecting apparatus, in case said selection circuit does not execute a selection based on the signal from said another program selecting apparatus, of such non-execution.

16. A program for controlling a program selecting apparatus, the program comprising:
a step of outputting a signal for reproducing a predetermined program to a reproducing apparatus; and
a step of transmitting information for causing another program selecting apparatus to select said predetermined program in order that said another program selecting apparatus can reproduce said predetermined program by a corresponding reproducing apparatus.

17. A program for controlling a program selecting apparatus, the program comprising:
a step of generating a predetermined control signal, in case a program to be selected according to a program designating signal is not a program selectable by another predetermined program selecting apparatus; and
a step of generating, based on said control signal, a signal for causing a user to notice that said another predetermined program selecting apparatus is unable to receive such program.

18. A program for controlling a program selecting apparatus, the program comprising:
a step of receiving a broadcast signal and selecting a predetermined channel; and
a step of transmitting information;
wherein said information is information of channels selectable by said selecting step and/or information on programs receivable by a channel selection in said selection step.

19. A program for controlling a program selecting apparatus, the program comprising:
a step of outputting information for selecting a predetermined program, based on a signal from another program selecting apparatus;
a step of selectively outputting a signal for reproducing said predetermined program based on said information; and
a step of transmitting information for informing said another program selecting apparatus of execution of a selection based on the signal from said another program selecting apparatus.

20. A program for controlling a program selecting apparatus, the program comprising:
a step of outputting information for selecting a predetermined program, based on a signal from another program selecting apparatus;
a step of selectively outputting a signal for reproducing said predetermined program based on said information; and
a step of transmitting information for informing said another program selecting apparatus, in case a selection based on the signal from said another program selecting apparatus is not executed, of such non-execution.
